(19) United States
(12) Patent Application Publication
(10) Pub. No.: US 2002/0129004 A1
(43) Pub. Date: Sep. 12, 2002

(54) Software enabled wizards

(76) Inventors: Jimmy G. Bassett, Fall Branch, TN (US); William Joseph Burgess, Jonesborough, TN (US); James Palmer Dickerson, Kingsport, TN (US); Michael Eugene Donelson, Gray, TN (US); Dennis Joseph Golob, Kingsport, TN (US); Samuel LeRoy Gott, Kingsport, TN (US); William Carl Jackson, Rock Hill, SC (US); Steven L. Lyons, Kernersville, NC (US); Stacey James Marsh, Church Hill, TN (US); Rick Miller, Kingsport, TN (US); David P. Fischer, Kingsport, TN (US); Henry Gonzalez JR., Blountville, TN (US); James W. Mercer JR., Kingsport, TN (US); Bobby J. Quillen, Kingsport, TN (US); Srihari Sitarama Dantuluri, Kingsport, TN (US); Mark E. Stewart, Kingsport, TN (US)

Correspondence Address: Charles W. Calkins, Kilpatrick Stockton LLP, 1001 W. Fourth St., Winston-Salem, NC, 27101, US

(21) Appl. No.: 10/039,482

(22) Filed: Nov. 9, 2001

Related U.S. Application Data
(60) Provisional application No. 60/247,537, filed on Nov. 9, 2000.
(60) Provisional application No. 60/300,510, filed on Jun. 22, 2001.

(51) Int. Cl. G06F 7/00

(52) U.S. Cl. 707/1

(57) ABSTRACT

The present invention relates to software enabled wizards that receive input from a user and use the input to generate a customized response. Embodiments of the present invention include design wizards, selection wizards and troubleshooting wizards advantageous for use in commerce, particularly within the chemical industry.

### CROSS-REFERENCE TO RELATED APPLICATIONS

This application claims priority to under 35 USC 119, and incorporates by reference in full, the following co-pending applications: U.S. Provisional Patent Application Serial No. 60/247,537, filed Nov. 9, 2000, entitled “Web Enabled Wizards” and U.S. Provisional Patent Application Serial No. 60/300,510, filed Jun. 22, 2001.

### FIELD OF THE INVENTION

The present invention relates to software wizards that receive input from a user and use the input to generate a customized response. Embodiments of the present invention include design wizards, selection wizards and troubleshooting wizards. Use of the wizards facilitates commerce between and among members of an industry. The wizards of the present invention are particularly advantageous for use in the chemical industry, for example as part of a chemical manufacturer's extranet or internet site(s).

### BACKGROUND

In recent years, the role of the world wide web in commerce has become increasingly important. Businesses have moved their sales and customer support functions to the web to provide customers with 24/7/365 (twenty four hours a day, seven days a week, three hundred and sixty five days a year) access to goods and services. These web sites, which may include corporate extranet sites, permit customers and potential customers to view product information; select and purchase products; trouble-shoot existing products.

A problem with current web sites for selling and marketing products, however is that it can be difficult for a potential customer to locate and choose the best product for their needs. A typical chemical industry website, for example, may include descriptions of hundreds of products, each with a varying level of suitability for a customer's specific needs. Typically, in order to determine the most desirable product for their needs, a customer may contact a representative of the selling company for further information. This need for personal contact minimizes the other potential advantages achieved by having a web based sales strategy. It would be advantageous to have a web based system that assisted potential and existing customers with product selection that did not utilize human intervention.

An additional service often provided by companies to potential customers is assistance in the area of product design. Traditionally, these product design services have been used by companies to successfully market their products and services to potential customers by providing the potential customers with designs that utilize the companies' products. It also would be advantageous to have a web based system that assisted potential and existing customers with product design.

Customer service and customer assistance remains a critical piece of building a long term relationship with customers in the e-commerce arena. Companies can distinguish themselves from their competitors by providing a higher level of customer service and customer assistance to their customers. Often customers have having real or perceived problems with a product or service and need assistance troubleshooting to enable the product or service to perform at its intended level. Traditionally, troubleshooting a particular problem has utilized a telephone call to a technical support person. It would be advantageous to be able to offer customers and potential customers a web based system for troubleshooting real and perceived problems with goods and services.

The present invention provides systems and methods that achieve the aforementioned advantages and other advantages. In particular, the systems of the present invention may be advantageously utilized to provide a web based system for assisting potential and existing customers with: product selection; product design; and/or troubleshooting.

### SUMMARY OF THE INVENTION

The present invention provides systems and methods using software wizards that are advantageous for assisting visitors to a web site.

The term “wizard” is often utilized in the computer programming field to refer to a utility or program module that receives input from a user and then uses the input to generate a customized response. Often, a wizard leads a user through a series of steps to generate the input to enable the wizard to perform a particular task. For example, a “letter wizard” in a word processing program may lead a user through a series of steps to create different types of correspondence.

In an embodiment of the present invention, a wizard may comprise a process model application or an interactive support tool that receives input from a user to generate a customized response. These tools may assist, for example, with product selection, product design and other technical support for a group of products. The software utilized in the wizard may utilize scientific and technical modeling to produce the customized result.

As used herein, “web-enabled” refers to designed to operate on or over the internet or an intranet. The web enabled wizards described herein may be produced/coded by techniques known to those of ordinary skill in the art, for example utilizing HTML or XML.

The general concept of the present invention is to web enable and automate to the extent possible duties that might otherwise be handled by a technical service representative in interaction with a customer. In other words, providing a “self-serve” environment for a customer.

According to embodiments of the present invention, a companies web site comprises a wizard to assist a visitor to the web site. Embodiments of the present invention include, but are not limited to, product selection wizards, product design wizards and troubleshooting wizards.

Specific embodiments of the present invention are advantageous for use in the chemical industry. The product supply chain in the chemical industry includes feedstock producers who supply basic chemicals to raw material producers who supply commodity and specialty chemicals such as monomers, resins, pigments, solvents, cross-linkers, additives, extenders, fillers and catalysts to paint and/or coating manufacturers who then sell finished products through direct sales, distributors and application specific channels to end-users and original equipment manufacturers. An example of a leading chemical industry web site is http://www.Eastman.com. The www.Eastman.com website is maintained by Eastman Chemical Company, the assignee of the present invention and includes a customer center where existing and potential customers can access product information, place and track orders and conduct other e-business activities with Eastman.

Companies in the chemical industry produce and sell chemical products to their customers, including, for example, resins, coatings, pigments, fillers, bulk chemical intermediates and the like. Often the best product for a customer will depend on the customer's intended end use. For example, there are many different grades/types of polyethylene terephthalate (PET) resins and particular grades/types are more desirable for producing soft drink bottles. A web enabled wizard of the present invention may be utilized to assist a customer in selecting the best PET resin for their particular bottle.

Intrinsic or inherent viscosity (“IV”) is an important polymer or resin property in many applications. It is often useful for a customer to know the predicted degradation of a resin's intrinsic or inherent viscosity with use (“IV degradation”) to assist them in choosing the most advantageous resin for their particular application. An embodiment of the present invention comprises a web enabled IV degradation wizard that provides customers with information on the IV degradation of particular products.

The chemical products known as “plasticizers” are often customized or designed for particular purposes. A further embodiment of the present invention comprises a web based plasticizer optimization wizard that allows a customer to optimize their selection of a plasticizer.

Often, customers have trouble utilizing products, including chemical products. A further embodiment of the present invention comprises a web based troubleshooting wizard that assists a customer in overcoming problems incurred in using, or trying to use, particular products.

As mentioned above, to distinguish themselves from their competitors it is advantageous for a company to provide potential and existing customers with value added services. For example, a chemical company may utilize a system of the present invention to provide product design services to market their products and illustrate their product's use to existing and potential customers. An additional embodiment of the present invention comprises a web enabled design wizard that provides design services for existing and potential customers.

PET resins are often utilized to produce performs such as bottles. An example of a possible embodiment of a design wizard according to the present invention is a preform design wizard that can be utilized by existing or potential PET resin customers to design preforms.

These and other embodiments of the present invention are described in detail below with reference to the appended figures.

It will apparent to those of ordinary skill in the art from the foregoing description that the present invention offers many advantages to companies and consumers participating in e-commerce. For example, the use of the wizards of the present invention can provide real time assistance to customers on a 24/7/365 basis. The use of the wizards of the present invention may also assist in generating and maintaining customers by providing value added services to the customers.

Further details and advantages of the present invention are described below.

### BRIEF DESCRIPTION OF THE FIGURES

These and other features, aspects, and advantages of the present invention are better understood when the following Detailed Description is read with reference to the accompanying drawings, wherein:

FIG. 1 is a prior art block diagram illustrating an exemplary environment for an embodiment of this invention.

FIG. 2 is a prior art block diagram illustrating an exemplary environment for an embodiment of this invention.

FIG. 3A is a block diagram illustrating the inputs and outputs of the Polyester Resin Calculation Wizard.

FIG. 3B is a flowchart illustrating the process carried out by one embodiment of the Polyester Resin Calculation Wizard.

FIGS. 3C-3H are screen shots of a Polyester Resin Calculation Wizard in an embodiment of this invention.

FIG. 4 is a flowchart illustrating an exemplary troubleshooting wizard in an embodiment of this invention

FIG. 5A is a block diagram illustrating the inputs and outputs of an inhibitor recommendation wizard in an embodiment of this invention.

FIG. 5B is a flowchart detailing the process an inhibitor recommendation wizard implements in an embodiment of this invention.

FIGS. 5C and 5D are screen shots of the performance characteristic-entry and output display HTML pages for an inhibitor recommendation wizard.

FIG. 6A is a block diagram illustrating the inputs and outputs of a plasticizer formulator wizard in an embodiment of this invention.

FIG. 6B is a flowchart illustrating the process implemented by a plasticizer formulator wizard in an embodiment of this invention.

FIGS. 6C and 6D are screen shots of the analyzer and optimizer data input forms, respectively.

FIG. 6E is a flowchart illustrating the process of analyzing and/or optimizing a formulation in an embodiment of this invention.

FIGS. 6F and 6G are screenshots of the analyzer and optimizer output displays, respectively.

FIG. 7A is a block diagram illustrating the inputs and outputs of the Pressure Sensitive Adhesive Formulator Wizard.

FIG. 7B is a flowchart illustrating the process carried out by one embodiment of the Pressure Sensitive Adhesive Formulator Wizard.

FIGS. 7C-7G are screen shots of a Pressure-Sensitive Adhesive Formulator Wizard in an embodiment of this invention.

FIG. 8 is a block diagram illustrating the link between a user computer 40 and a database 35.

FIG. 9A is a block diagram illustrating the inputs and outputs of the Intrinsic Viscosity Degradation Wizard.

FIG. 9B is a flowchart illustrating the process carried out by one embodiment of the Intrinsic Viscosity Degradation Wizard.

FIGS. 9C-9E are screen shots of an Intrinsic Viscosity Degradation Wizard in an embodiment of this invention.

FIG. 10A is a block diagram illustrating the inputs and outputs of the Injection Molding Part Cost Estimation Wizard.

FIG. 10B is a flowchart illustrating the process carried out by one embodiment of the Injection Molding Part Cost Estimation Wizard.

FIGS. 10C-10F are screen shots of an Injection Molding Part Cost Estimation Wizard in an embodiment of this invention.

FIG. 11A is a block diagram illustrating the inputs and outputs of the Rheology Curves Tech Wizard.

FIG. 11B is a flowchart illustrating the process carried out by one embodiment of the Rheology Curves Tech Wizard.

FIGS. 11C-11F are screen shots of a Rheology Curves Tech Wizard in an embodiment of this invention.

FIG. 12A is a block diagram illustrating the inputs and outputs of the Cantilever Snap-Fit Design Analysis Wizard.

FIG. 12B is a flowchart illustrating the process carried out by one embodiment of the Cantilever Snap-Fit Design Analysis Wizard.

FIGS. 12C-12E are screen shots of a Cantilever Snap-Fit Design Analysis Wizard in an embodiment of this invention.

FIG. 13A is a block diagram illustrating the inputs and outputs of an oxygen ingress wizard in an embodiment of this invention.

FIG. 13B is a flowchart illustrating the process implemented by an oxygen ingress wizard in an embodiment of this invention.

FIGS. 13C and 13D are screen shots of the parameter-entry and output display HTML pages for an oxygen ingress wizard.

FIG. 14A is a block diagram illustrating the inputs and outputs of an anti-oxidant wizard in an embodiment of this invention.

FIG. 14B is a flowchart illustrating the process carried out by an anti-oxidant wizard in an embodiment of this invention to accept input parameters and provide output.

FIG. 14C is a screen shot of the input/output form for an anti-oxidant wizard in an embodiment of this invention

FIG. 15A is a block diagram illustrating the inputs and outputs of the SAIB wizard. A customer supplies a calculation type 1501.

FIG. 15B is a flowchart illustrating the process of a SAIB wizard in an embodiment of this invention.

FIG. 15C is a screen shot of an SAIB wizard in an embodiment of this invention.

FIG. 16 is a flow chart illustrating the process of an email version of a wizard in an embodiment of this invention.

FIG. 17A is a block diagram illustrating the inputs and outputs of a solvent reformulation wizard in an embodiment of this invention.

FIG. 17B is a flowchart illustrating a process in a solvent reformulation wizard in an embodiment of this invention.

FIGS. 17C-F are screen shots of the input and output forms in a solvent reformulation wizard.

FIG. 18 is a block diagram illustrating a coextrusion wizard in an embodiment of this invention.

FIGS. 19A and 19B are screenshots of an e-Solvents Chart® in an embodiment of this invention.

FIG. 20A is a block diagram illustrating the inputs and outputs of the Coolant Flow-Rate Calculator Wizard.

FIG. 20B is a flow diagram illustrating the process carried out by one embodiment of the Coolant Flow-Rate Calculator Wizard.

FIGS. 20C-20E are screenshots of a Coolant Flow-Rate Calculator Wizard in an embodiment of this invention.

### DETAILED DESCRIPTION OF THE INVENTION

As described above, the present invention provides software enabled wizards. The software wizards may be utilized in computer programs and/or as part of an internet, intranet and/or extranet site. The wizards are particularly advantageous as web enabled wizards for use in a corporate intranet, extranet, or internet setting.

Specific possible embodiments of the present invention are set forth below and include, but are not limited to, wizards relating to one or more of the following technical areas: Electronic mail; Trouble-shooting; Inhibitor Recommendation; Plasticizer Formulation; Pressure Sensitive Adhesive Formulation; Database Updates and Reports; Intrinsic Viscosity Degradation; Part Cost Estimator; Rheology Curves; Resin Calculation; Oxygen Ingress Calculation; Anti-Oxidants; SAIB Beverage Formulation; Solvent Reformulation; Coextrusion; solvents; Coolant Flow-rate Calculation and/or Cantilever Snap-fitting.

The present invention includes a wizard system comprising:

an input;

an algorithm acting on the input; and

an output generated by the algorithm;

wherein the input comprises at least one data item relating to a product or service offered by the chemical industry. The wizard system is advantageously implemented in computer software. Embodiments of the present invention include web enabled wizards.

The products and services offered by a chemical industry are set forth in detail herein with reference to goods and services sold or offered for sale within the chemical industry, and in particular with reference to particular embodiments of a wizard system set forth herein.

The present invention further includes a computer system comprising:

a memory arrangement;

at least one processing unit coupled to the memory arrangement;

a user interface;

an input apparatus;

a display apparatus; and

a set of instructions for processing input and generating output,

wherein the set of instructions comprises a wizard of the present invention.

The present invention further includes computer-readable medium comprising a wizard of the present invention.

In another aspect, the present invention includes a method for providing a desired output based on an input comprising:

inputting data and

acting on the inputted data utilizing an algorithm to generate the desired output.

The wizards of the present invention may be implemented utilizing software coding techniques and processes known to those of ordinary skill in the art. In general terms, a wizard of the present invention may comprise a series of questions, steps or menus to receive input from a user. The invention includes a computer-readable medium, having computer-readable instructions for generating and analyzing the input and implementing the wizard. In general, the input may be compared to database fields including relevant criteria for the wizard. A formula or other approach may be utilized to assign proportional weight to one input criterion over another input criterion.

For a product selection wizard, the series of questions may be designed to generate input relating to: the intended use, the environment for the intended use, the desired longevity of the product, desired properties and the like. The output will comprise a product or series of products that best achieve the desired characteristics. Similarly, a troubleshooting wizard may comprise a series of questions or steps designed to generate input relating to the problem occurring, including, time, environment, implementation and the like. The output will comprise a suggested procedure for remedying the problem. For a product design wizard the series of questions may be designed to generate input relating to: the intended use, the environment for the intended use, the desired longevity of the product, desired properties, aesthetic considerations and the like. The output may comprise a depiction of a product design and may further comprise suggested materials, for example a resin, for use in the design.

For example, in an embodiment of the present invention, a customer may visit a web site desiring a resin for a particular application. The product selection wizard would take the customer through a series of questions, or through different categories that show up on the screen to generate input. For example, the customer may desire certain physical properties and certain attributes in terms of performance. This input is considered by the wizard in the wizard's calculation of a suggested product list. The list may be refined by further input etc.

As will be understood by those of ordinary skill in the art, the type and number of potential wizard input criteria is unlimited and will depend on the particular wizard application. In embodiments of the present invention, the input process, or a portion of the input process may be automated, for example by utilizing the customer's purchase history, or the like to generate a set of input criteria for the wizard.

System

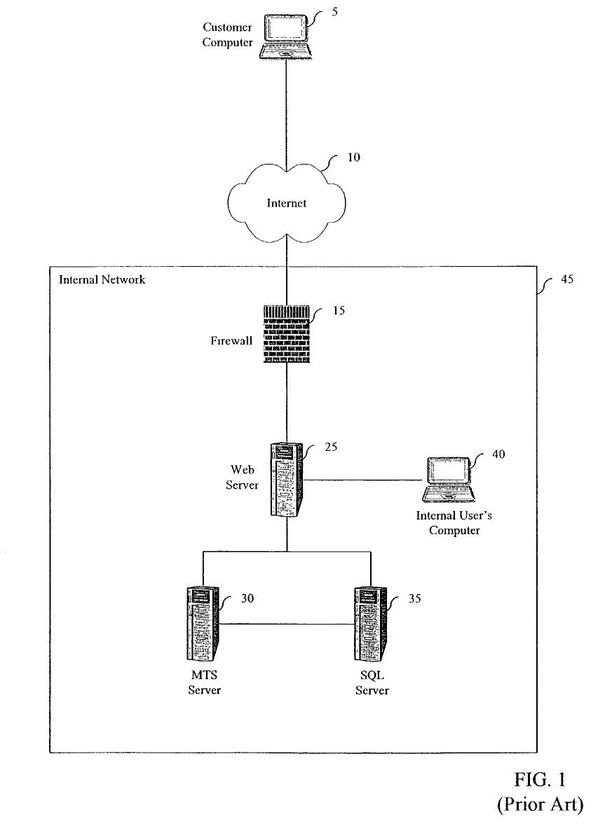

Embodiments of this invention include applications executing on both client and server computers. In one embodiment of this invention, a compact disk or other storage media stores an application so that a customer or other wizard user can install and execute the application on a personal computer, personal digital assistant (PDA), or other device. In another embodiment, the customer accesses an application executing on a server computer in a private or public network. FIG. 1 illustrates such an embodiment as a web application executing on a web server 25, accessible via the Internet 10. Infrastructures such as that illustrated in FIG. 1 are common in the prior art.

In the embodiment shown in FIG. 1, the customer accesses a wizard by specifying a uniform resource locator (URL) in a web browser application on the customer's computer 5. In response, the browser sends a hypertext transfer protocol (HTTP) request to the Internet 10. The request is routed to the physical Internet protocol (IP) address associated with the URL specified by the customer.

In the embodiment shown in FIG. 1, the URL is bound to the IP address of web server 25 in internal network 45, and therefore, requests directed to the URL are routed to web server 25. Web server 25 exists within an internal network, such as a corporate, governmental, or university network. For security reasons, the request passes through firewall 15 before arriving at web server 25. If the request is valid and properly authenticated and/or authorized, firewall 15 forwards the request to web server 25. For example, the provider of the wizards may determine that a wizard should only be accessible by authorized customers or users To access a secure wizard, the customer utilizes a secure method of accessing the web server, such as secure sockets layer (SSL). The customer may specify a username and password to log in to the application on web server 25 or firewall 15 may only authorize requests directed to web server 25 from specified IP addresses, such as the IP address associated with customer computer 5.

Web server 25 responds to HTTP requests by providing hypertext markup language (HTML) pages corresponding to the URL specified in the request. In embodiments of this invention, web server 25 also includes a web application environment. For example, web server 25 includes Microsoft Internet Information Server™ (IIS), which includes the Active Server Pages (ASP) web application environment. In other embodiments, web server 25 includes java server pages and/or other web application environments. When web server 25 receives a request for an ASP page, the web server 25 performs any processing of code within the ASP page before sending the resultant HTML page to the requesting customer's computer 5.

In order to perform processing in response to the customer's request, web server 25 may utilize additional components as well. For example, in the embodiment shown in FIG. 1, ASP pages executing on web server 25 may instantiate and utilize business objects executing under an object request broker, such as Microsoft Transaction Server (MTS) on MTS Server 30. In the embodiment shown, the object that the ASP page instantiates conforms to the Common Object Modeling (COM) standard, but one skilled in the art could also utilize objects conforming to Object Management Group's (OMG) Common Object Request Broker Architecture (CORBA) or other ORB and remote procedure call (RPC) architectures.

The business object includes processing rules and algorithms necessary to respond to customer requests. A business object receives a request from a program, such as an ASP executing on web server 25, and uses processing rules to formulate a response. By utilizing business objects, redundant code is eliminated from ASP pages and overall processing efficiency is enhanced. For example, if two separate ASP pages calculate the volume of a container, a business object is created which accepts the dimensions of a container, performs the volume calculation, and provides the volume. By utilizing a business object to perform the calculation, the developer of the application avoids duplicating the formula for calculating volume in the two ASP pages.

In an embodiment of this invention, ASP pages, executing on web server 25, and business objects, executing on MTS Server 30, also access a database management system, such as the Microsoft SQL Server 35. Various other database management systems may be utilized as well, such as the Oracle relational database management system. The SQL Server database 35 stores information, such as product catalogs and chemical properties. The information in the database 35 is utilized by the application to perform calculations and to provide information in response to customer requests.

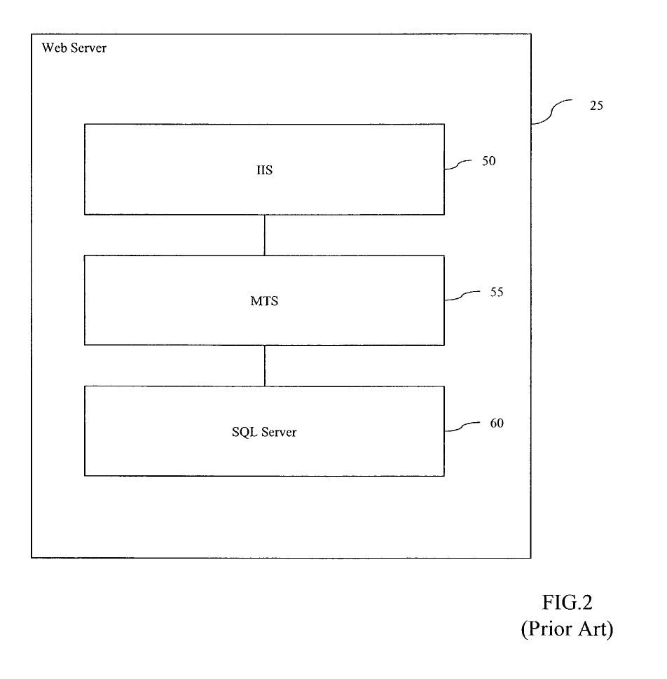

In other embodiment of this invention, the operating, object and database software may execute on a single machine. For example, FIG. 2 illustrates another embodiment of the environment of this invention. In FIG. 2, IIS 50, MTS 55, and SQL Server 60 all reside on the web server 25.

Polyester Resin Calculation Wizard

The Polyester Resin Calculation Wizard is a user-friendly web-based computer program designed to automatically calculate condensation (step growth) type resins for coatings, inks and adhesives applications. The wizard receives input from a user in the form of raw material selection and certain resin parameters, and then uses these parameters in several linear algebraic operations to generate a customized response. Once calculations are performed, a reactor charge for the given set of raw materials and resin parameters is output. The reactor charge, when processed, will ideally yield a product having properties that match the desired parameters. In addition to the reactor charge, the user can also generate processing logs and graphical representations of the calculated reactor charge's polymerization. These results can then easily be printed or downloaded to a spreadsheet format.

The principle equations used by this wizard were developed and published by Carothers, Patton, Stockmayer, Flory and others well know by resin chemists. Extensions of these equations are used so that resin intermediates with averaged (fractional) functionalities can be included as raw materials. Resin intermediates with mixed acid-base functionalities (e.g., dimethylolpropionic acid) can be included in the calculations as well.

Resin chemists are well aware that many factors will alter these ideal results. These factors include raw material purity, resin equilibration (such as glycolysis, acidolysis, esterolysis, etc.) during processing, as well as oxidative and other forms of degradation. This wizard does not consider these factors in the calculations, so the results obtained by this wizard merely provide a starting-point formulation based on ideal processing conditions.

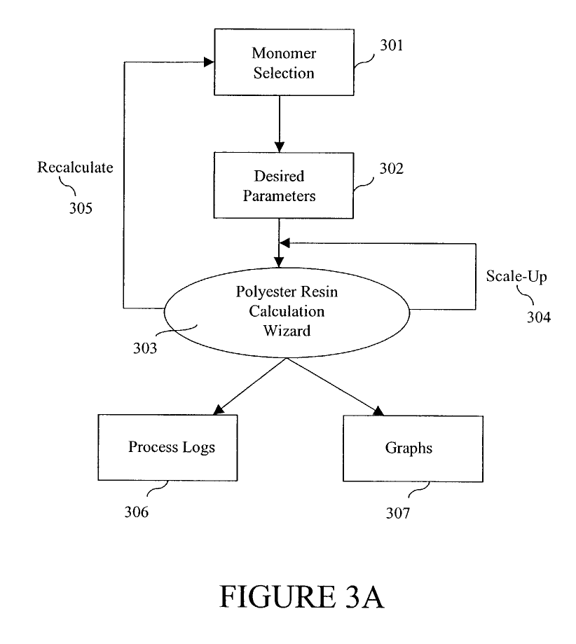

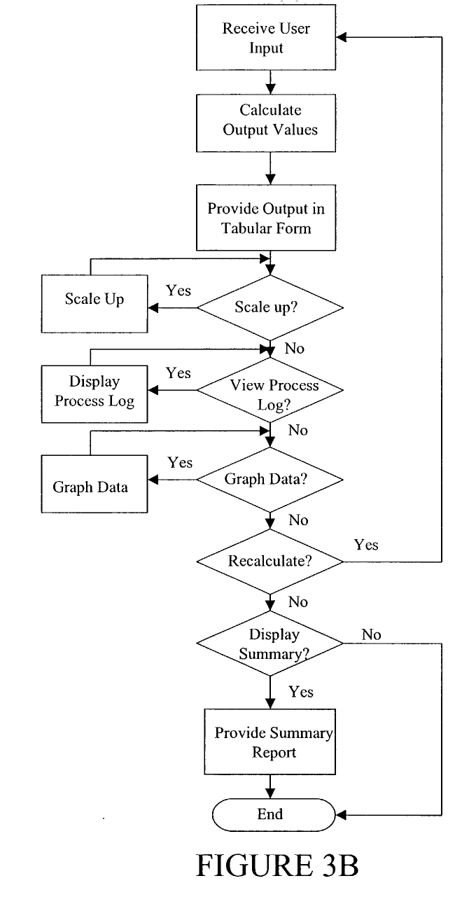

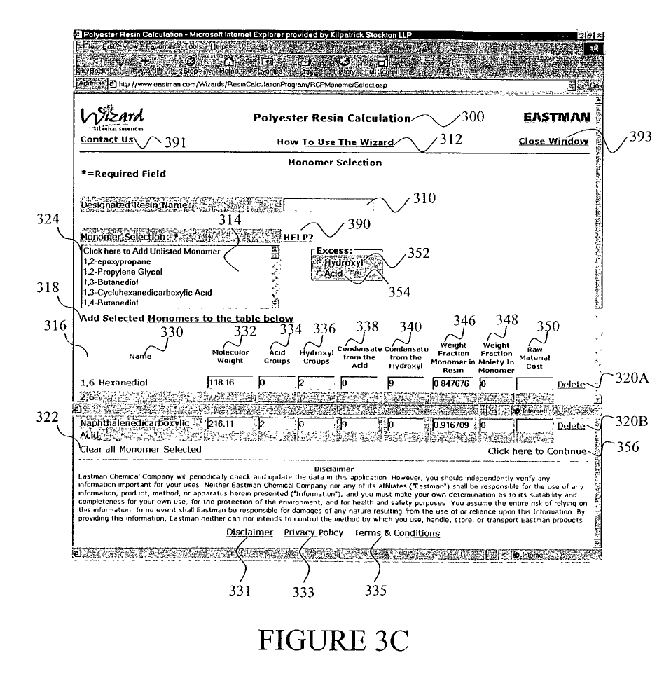

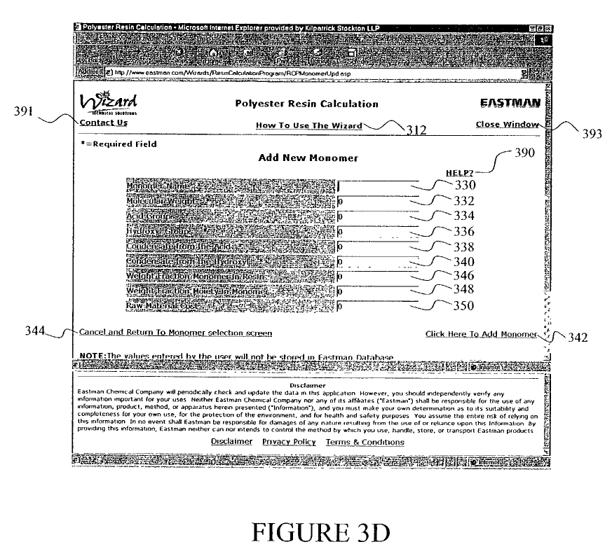

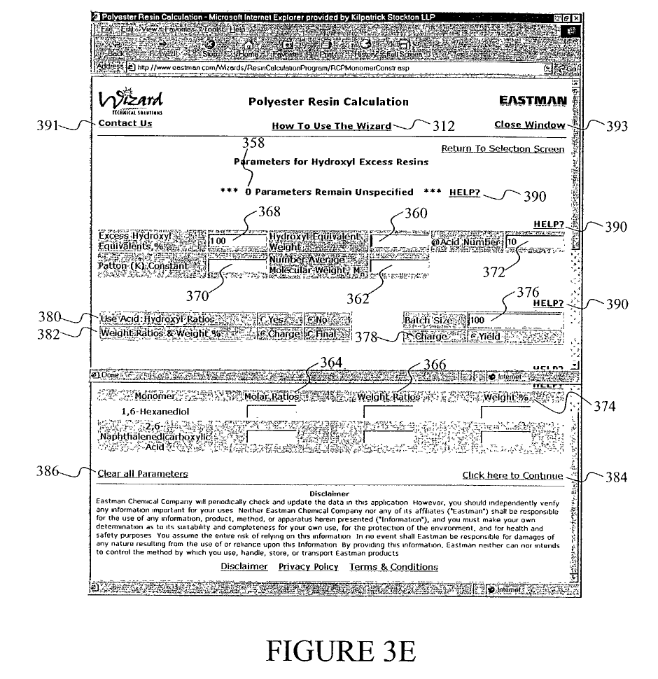

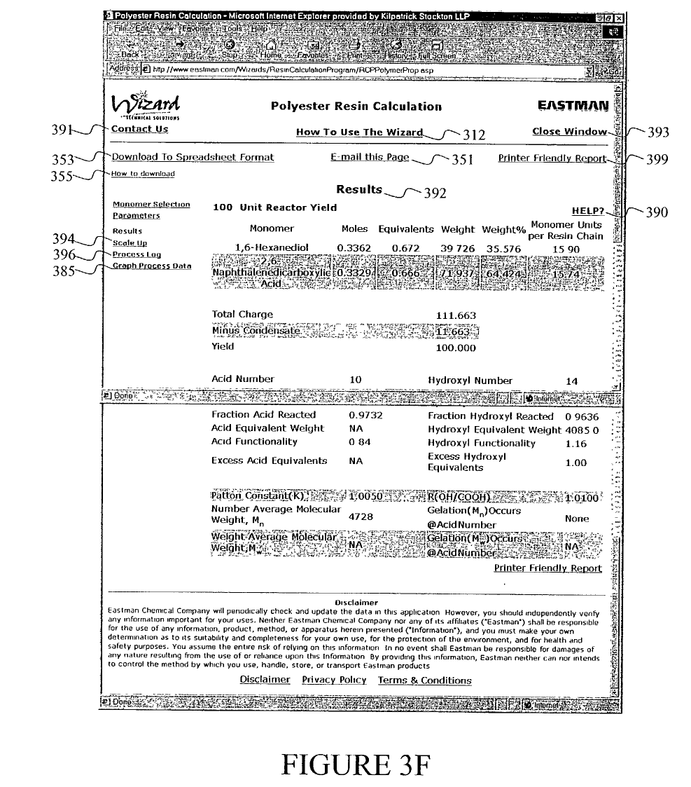

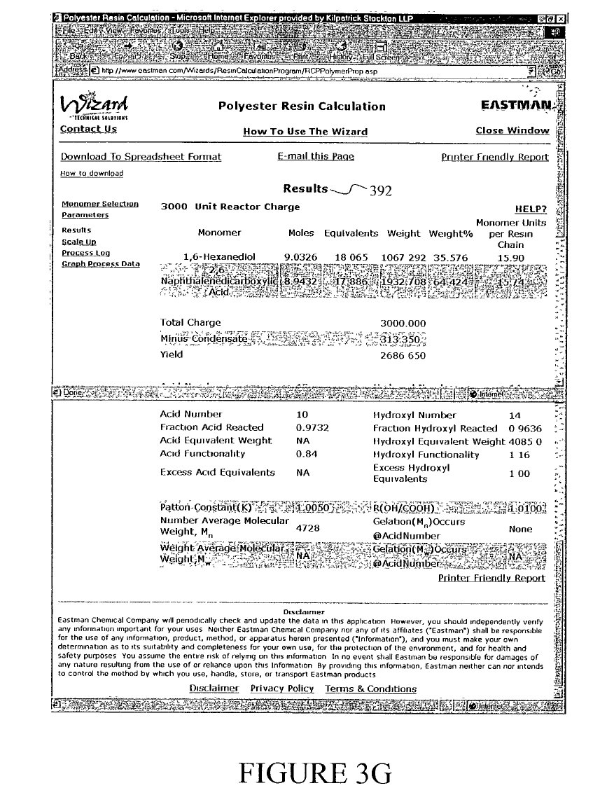

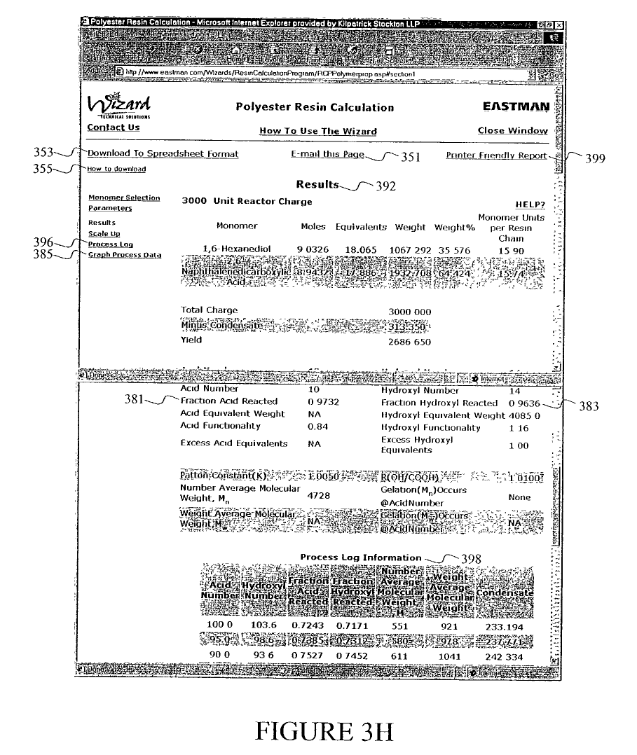

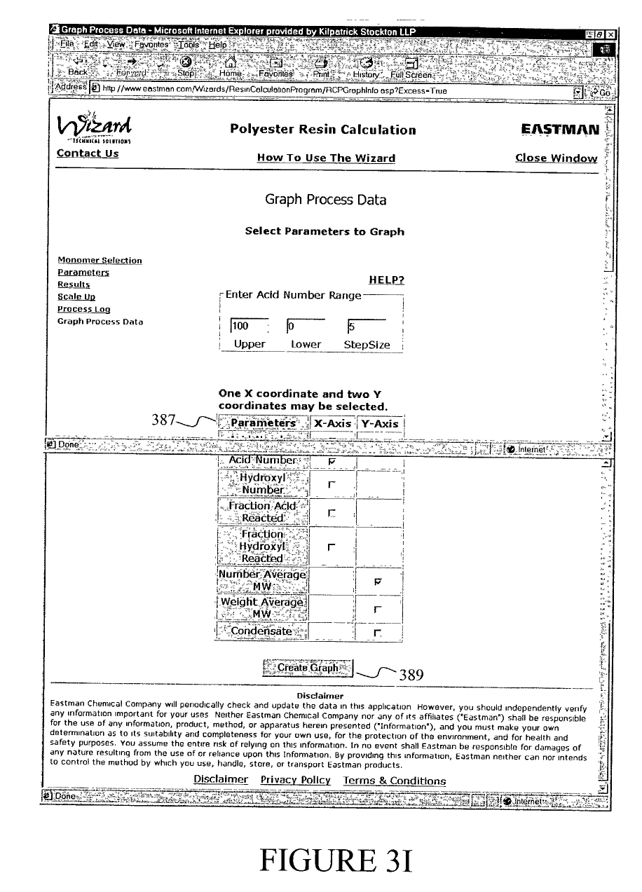

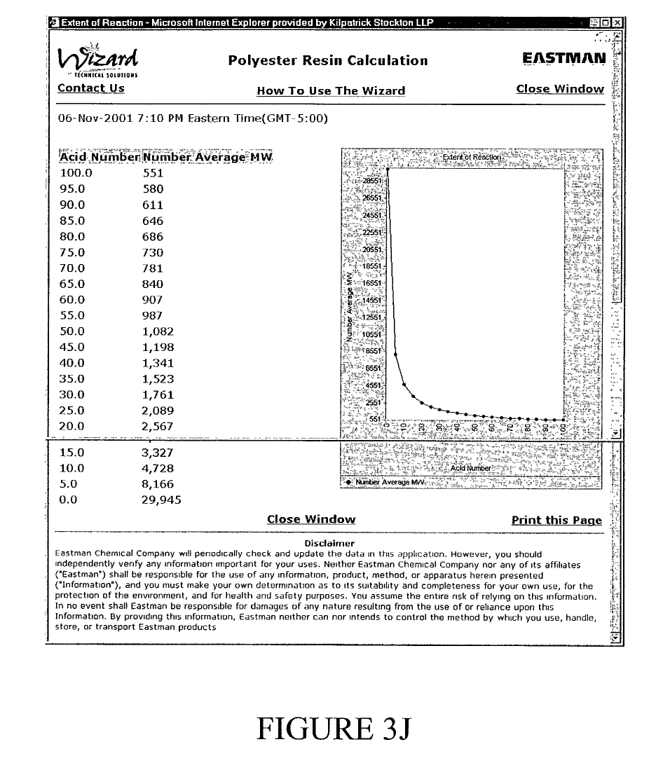

FIG. 3A is a block diagram illustrating the inputs and outputs of the Polyester Resin Calculation Wizard. In one embodiment of this wizard, a user selects monomers 301 and then supplies information about the parameters they seek to achieve 302. The wizard then calculates a reactor charge 303 and displays the properties of that charge. The user is then given the opportunity to scale-up that charge 304 or recalculate a new reactor charge 305, if they so desire. The wizard then outputs the calculated reactor charge in the form of tabular process logs 306 and graphs 307. FIG. 3B is a flowchart illustrating the process carried out by one embodiment of the Polyester Resin Calculation Wizard.

With reference to FIG. 3C, to begin the polyester resin calculation, the wizard prompts a user to enter a personally-created name for each resin formulation by entering text into the “Designated Resin Name” field 310 on the Polyester Resin Calculation Monomer Selection page 300. This name designation will follow throughout the current calculation. If a user is visiting this wizard for the first time, they may click on the “How To Use The Wizard” button 312 and the system will display detailed instructions about this wizard. Also, at any time, a user can access help instructions by clicking on any “Help” button 390, contact the website host by clicking on the “Contact Us” button 391, or close the current window by clicking on the “Close Window” button 393.

The monomer selection window 314 of this wizard accepts up to 10 monomers, in any order, and the same monomer may be selected more than once. The final order of the monomers shown in the selection table 316 will be the same as that shown in screen outputs, printouts, or document files used for the current calculation. The wizard utilizes that a user select at least one hydroxyl functional monomer and at least one acid functional monomer before the resin calculation will be performed.

This wizard allows monomers to be selected by a user via a pull-down list in monomer selection window 314. Users select the monomers they desire from this pull-down list and click on the “Add Selected Monomers to the table below” button 318. Monomers are added to the table 316 in the order in which they are selected. To cancel a monomer selection, a user may click on the “Delete” button 320A and 320B next to the desired monomer, or all selected monomers may be deleted by clicking on the “Clear all Monomer Selected” button 322.

The wizard also allows unlisted monomers to be entered by a user by clicking on the “Click here to Add Unlisted Monomer” item 324 in the monomer selection window 314. When this selection is chosen by a user, a new window will appear as seen in FIG. 3D. The wizard will then utilize the user to input the information that is utilized to process a calculation. Such utilized information includes: monomer name 330, molecular weight of the monomer 332, number of acid functional groups on the monomer 334, number of hydroxyl functional groups on the monomer 336, condensate from the acid 338, and condensate from the hydroxyl 340. Condensate from the acid 338 and condensate from the hydroxyl 340 are used for accurate condensate loss, yield, and number average molecular weight calculations. Additional information may also be entered, such as weight fraction monomer in the resin 346, weight fraction moiety in the monomer 348, and raw material cost 350. Once information is entered, the user may click on the “Click Here to Add Monomer” button 342. A user may also click on the “Cancel and Return to Monomer selection screen” button 344 to return to the monomer selection window 314. Any values entered by a user when they are adding an unlisted monomer will not be stored in the Eastman Database; they will only be used during that particular calculation.

On Monomer Selection page 300 shown in FIG. 3C, the wizard prompts a user to select either excess hydroxyl 352 or excess acid 354 to indicate whether the resin is to be formulated with an excess of hydroxyl or an excess of acid functional groups. Once all information is entered on this page, a user then clicks on the “Click Here to Continue” button 356.

Now with reference to FIG. 3E, to calculate a resin, a user reduces the “Parameters Remain Unspecified” value 358 to 0. The number of parameters that may be satisfied depends upon the number of monomers selected. Entering equivalent weight parameters 360 and molecular weight parameters 362, then molar ratios 364 or weight ratios 366 will drive the value to 0. The user may select any desired combination of these parameters. However, if the parameters are too tight (e.g., selecting a molecular weight constant and a desired molecular weight), the computer values will be useless. Selections that are redundant (e.g., specifying equivalent weight 360 as well as excess equivalent of hydroxyl 368) will yield a meaningless calculation.

The parameters that a user may input include: for a hydroxyl excess resin, the percent of excess hydroxyl equivalents over acid equivalents 368; for an acid excess resin, the percent of excess acid equivalents over hydroxyl equivalents 368; the total number of moles in the reactor charge divided by the number of equivalents of the excess type—either acid or hydroxyl 370; the weight per resin functional group 360 calculated by dividing 56109 by the hydroxyl or acid value; the desired number average molecular weight for the resin 362; the desired acid or hydroxyl number at which the resin parameters will be calculated 372; whether the wizard should allow monomer ratios (molar or weight) to take precedence over any other parameters entered 380; whether the weight ratios and weight percent should be calculated for the charge or the amount remaining in the final product 382; weight percent 374; batch size 376; and the desired reactor charge or product yield 378. At any time, a user can clear all parameters by clicking on the “Clear all Parameters” button 386. Once the “Parameters Remain Unspecified” 358 equals 0, as shown in FIG. 3E, then a user can proceed to the Results screen 392 by clicking on the “Click Here to Continue” button 384. The wizard will then perform the necessary calculations and display the results thereof on Results screen 392 as shown in FIG. 3F.

Now with reference to FIG. 3F, it can be seen that this wizard allows a user to impose any combination of parameters on the desired resin. For example, once the calculation is complete, the user may click on the “Scale Up” button 394 to have the wizard automatically recalculate the desired charge or yield and update results screen 392 as shown in FIG. 3G. The wizard calculates all properties for the acid number or hydroxyl number specified by the user in 372, but also allows a user to view a listing of properties at different acid or hydroxyl numbers by clicking on the “Process Log” button 396. The process log information 398, which shows the computed data for a resin as a function of the extent of reaction, will appear at the bottom of the results screen 392 as shown in FIG. 3H. A printer friendly version of many screens can be displayed by clicking on the “Printer Friendly Report” button 399. Results may be e-mailed by clicking on the “E-mail this Page” button 351, and results may also be downloaded to a spreadsheet by clicking on the “Download To Spreadsheet Format” button 353. Instructions for downloading to a spreadsheet can be displayed by clicking on the “How to download” button 355.

The Fraction Acid Reacted 381 and Fraction Hydroxyl Reacted 383 shown in FIG. 3H represents the extent of acid and hydroxyl reaction, respectively. The wizard will display data at different extents of reaction when the user selects either the “Process Log” option 396 or “Graph Process Data” option 385. If “Graph Process Data” 385 is selected, the user will be presented with a new screen where they will be prompted to enter various plotting parameters 387 as shown in FIG. 31 for plotting. The wizard allows a user to select one X coordinate and up to two Y coordinates. Once the user selects the appropriate plotting parameters, “Create Graph” 389 should be clicked. The wizard will then display a graph similar to the one shown in FIG. 3J.

As with the other wizards of the present invention, users can access additional information about the owner's policies by clicking on “Disclaimer” button 331, “Privacy Policy” button 333, and “Terms & Conditions” button 335. When a users clicks on any of these buttons, a new window will appear to display the relevant information.

Troubleshooting Wizard

An embodiment of this invention includes a troubleshooting wizard. A wizard is an interactive application interface that assists a user to complete a potentially complex task. Often a wizard is implemented as a sequence of dialog boxes,http://www.dictionary.com/cgi-bin/dict.pl?term=dialog%20boxes which the user can move forwards and backwards through, filling in any necessary information.

A troubleshooting wizard may comprise a series of questions or steps designed to generate input relating to the issue or problem encountered by a customer. The inputs may include information such as the time, environment, implementation and the like. The output comprises a suggested procedure for remedying the problem.

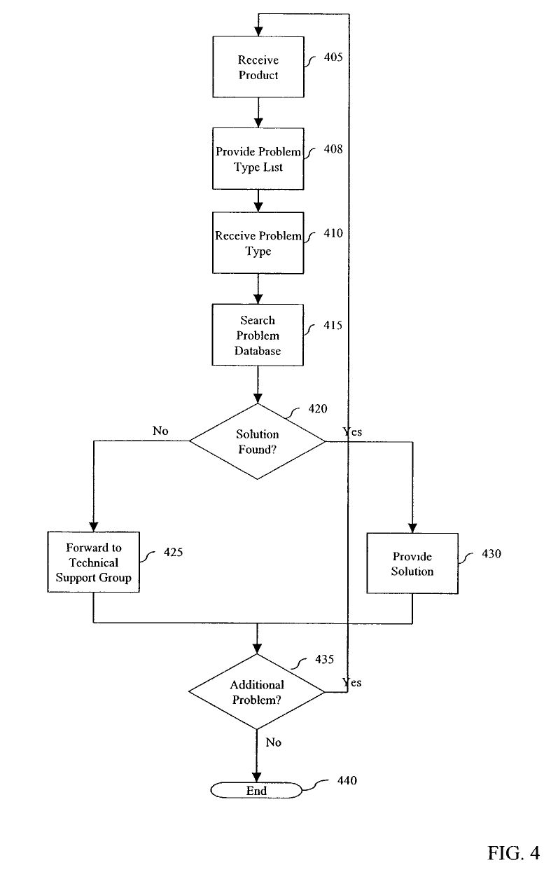

FIG. 4 is a flowchart illustrating an exemplary troubleshooting wizard in an embodiment of this invention. The customer first enters the product for which a problem has occurred. Web server 25 receives the product 405 and provides a list of applicable problem types 408. The customer selects a problem type and submits the information to web server 25. Web server 25 receives the problem type 410 and searches a database of previously encountered problems 415. If a solution is found 420, the web server 25 provides the solution 430. If not, the problem is forwarded to a technical support group 425 for manual resolution of the problem.

The customer may then choose to seek assistance for additional problems 435. If no additional problems exist, the process ends 440. Other embodiments of this invention include various types of troubleshooting wizards, including expert systems.

Inhibitor Recommendation Wizard

An embodiment of this invention includes an Inhibitor Recommendation Wizard. The inhibitor recommendation wizard is an interactive tool to assist in selecting the proper inhibitor for a specific purpose. It is based on the data, expertise and industry experience with these products and their applications. Much of the information in the wizard is based on research in the area of unsaturated polyester resins, but an inhibitor recommendation wizard has utility for other applications as well.

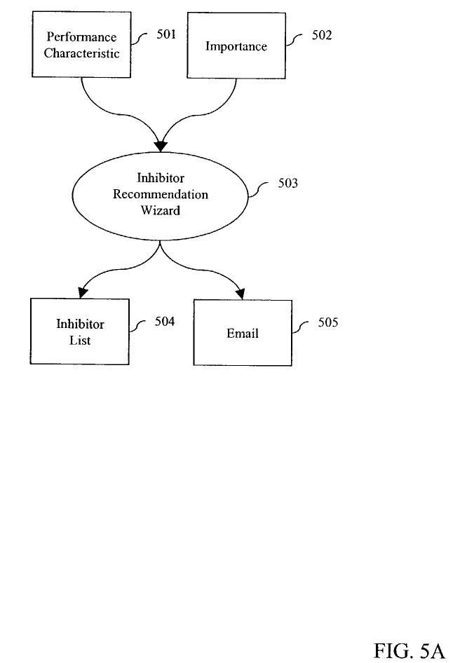

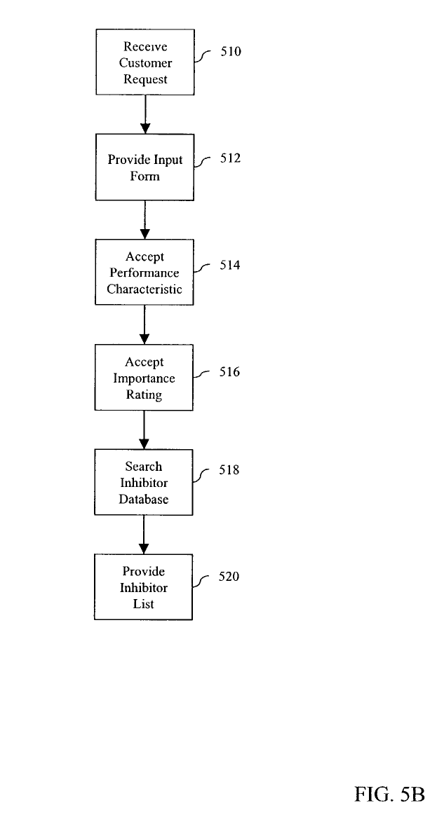

FIG. 5A is a block diagram illustrating the inputs and outputs of an inhibitor recommendation wizard 503 in an embodiment of this invention. To utilize the inhibitor recommendation wizard 503, a customer selects performance characteristics from a list 501. The customer then assigns an importance measure to each of these characteristics 502. The wizard 503 uses these inputs to generate a list of recommended inhibitors 504 based on the performance characteristics and levels of importance. In addition, the wizard 503 may produce an email message 505 containing the recommendations.

FIG. 5B is a flowchart detailing the process an inhibitor recommendation wizard implements in an embodiment of this invention. The purpose of the inhibitor recommendation wizard is to recommend products to a customer based on the customer's selection of performance characteristics 514 and their importance 516. FIG. 5C and 5D are screen shots of the performance characteristic-entry and output display HTML pages for an inhibitor recommendation wizard. In the embodiment shown, the customer accesses a web browser on the customer's computer 5. The customer clicks on an inhibitor recommendation wizard hyperlink to access the inhibitor recommendation wizard. Clicking on a hyperlink results in web server 25 receiving an HTTP request 510. In response, web server 25 provides the performance characteristic input form as shown in FIG. 5C 512.

The performance characteristic input form in FIG. 5C includes a performance characteristic list 550. The performance characteristic list 550 includes various performance characteristics and, for each characteristic, a series of radio buttons corresponding to the importance the customer places on each performance characteristic 551. In the embodiment of this invention shown in FIG. 5C, the customer chooses from four importance rating levels: “High”, “Medium”, “Low”, or “None.” By default, the importance for each performance characteristic is “None.” Once the customer has entered an importance for each performance characteristic, the customer clicks the “View Recommended Inhibitors” button 552. Clicking the button causes the form to be submitted to web server 25. Web server 25 receives the performance characteristic(s) 514 as well as the corresponding importance rating(s) 516. Web server 25 searches SQL Server database 35 for appropriate inhibitors.

Web server 25 creates an HTML page, such as the page shown in FIG. 5D, which lists the recommended inhibitors based on the customer's importance ratings 520. The resultant page includes the performance characteristics and importance ratings assigned by the customer 554 as well as a list of inhibitors and an associated rating 556. To simplify the algorithm and to make the resultant page easier to read, the number of inhibitors may be limited. For example, in the list shown in FIG. 5D, the list of inhibitors 556 is limited to three. The inhibitors are displayed in descending order of overall rating.

In an embodiment of this invention, the recommended inhibitor wizard may include additional features as well. For example, in the list of recommended inhibitors 554, each product name may include a hyperlink to a page that describes properties and features of the product. Also, the wizard may include the ability to email the list of recommended inhibitors 554 to a specified email address. Embodiments of this invention may also include help screens and options to display links for disclaimer, Policies, terms, and conditions.

Plasticizer Formulator Wizard

A plasticizer formulator wizard collects information utilized to analyze and optimize a customer's selection of a plasticizer. In one embodiment of this invention, the information entered by a customer is sent via email to a technical support group that executes software for the analysis and optimization of the plasticizer selection. In another embodiment, the wizard performs the analysis and optimization without manual intervention.

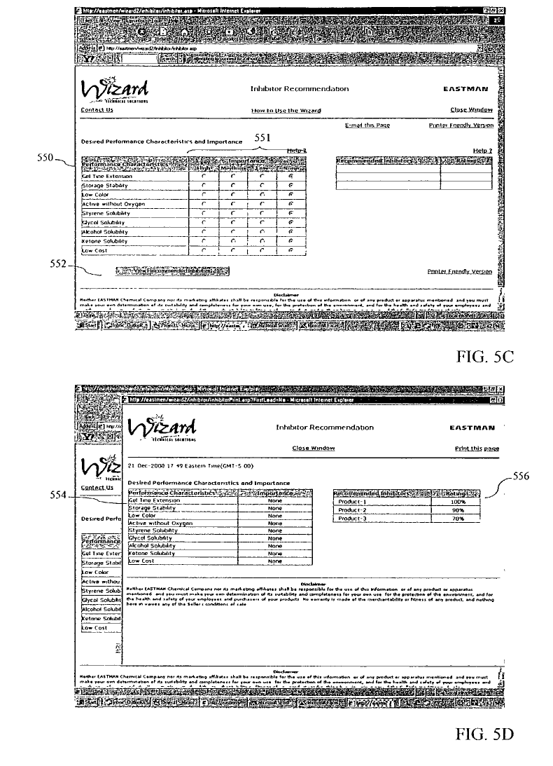

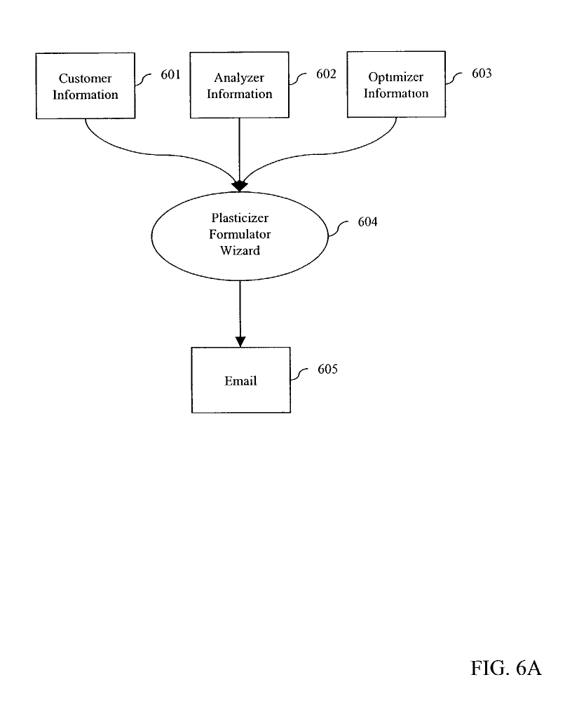

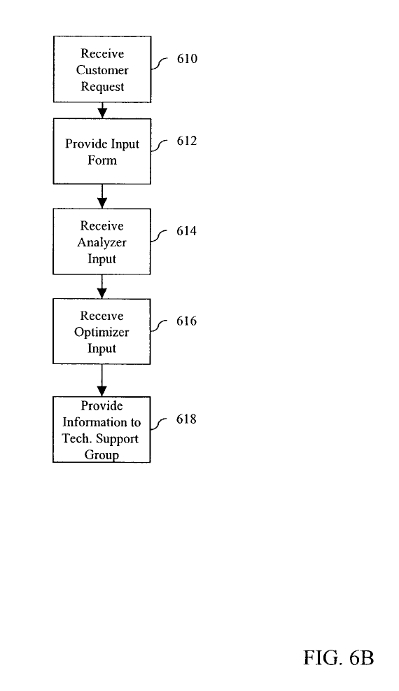

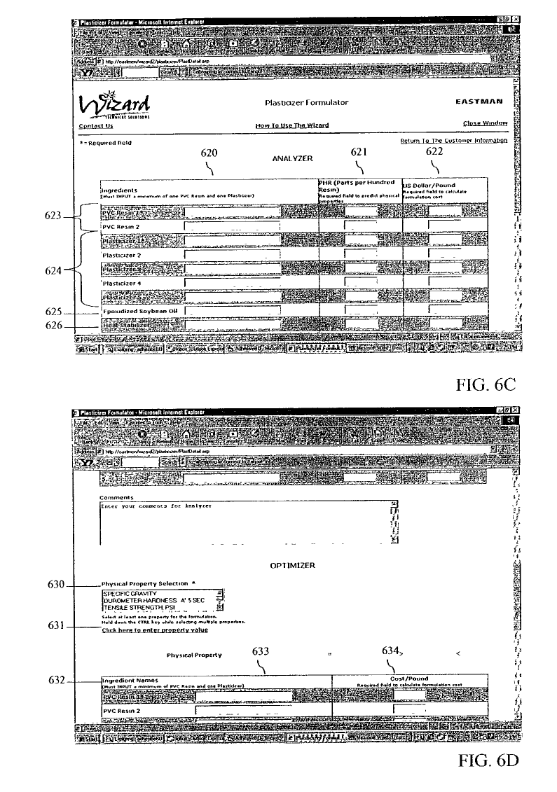

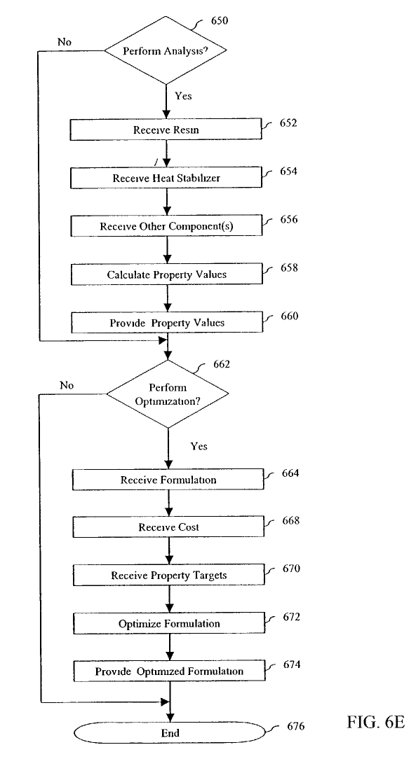

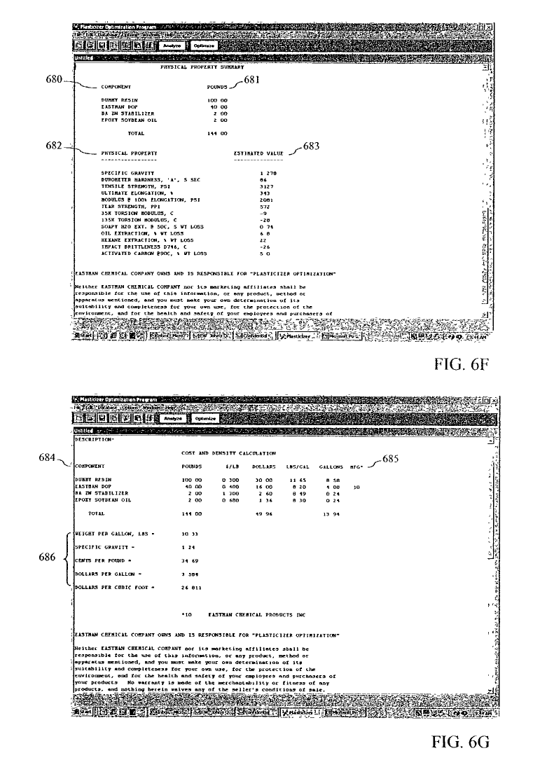

FIG. 6A is a block diagram illustrating the inputs and outputs of a plasticizer formulator wizard in an embodiment of this invention. In the embodiment shown in FIG. 6A, the customer provides customer information 602 as well as analyzer 603 and optimizer 604 information. The technical support group uses the customer information to contact the customer with the plasticizer information and analysis and optimization via email 605.

FIG. 6B is a flowchart illustrating the process implemented by a plasticizer formulator wizard in an embodiment of this invention. FIGS. 6C and 6D are screen shots of the analyzer and optimizer data input forms, respectively. In the embodiment shown, the customer accesses a web browser on the customer's computer 5. The customer clicks on a plasticizer formulator wizard hyperlink to access the plasticizer formulator wizard. Clicking on a hyperlink results in web server 25 receiving an HTTP request 610. In response, web server 25 provides the customer input form as shown in FIGS. 6C and 6D 612.

In order to perform an analysis, the customer enters information in the analyzer section of the form shown in FIG. 6C. The customer enters three different attributes for each component in a formulation: the ingredient name 620, the parts per hundred resin 621, and the cost in dollars per pound 622. A formulation in the embodiment shown may include one or more PVC resins 623, one or more plasticizers 624, an epoxidized soybean oil 625, a heat stabilizer 626, and various other components (not shown). To perform analysis, the formulation may include at least a PVC resin and a plasticizer.

In an embodiment of this invention, in order to perform an optimization, the customer enters information in the optimizer section of the form shown in FIG. 6D. To perform an optimization, the customer selects physical properties from the physical property selection drop down 630 and assigns targets to those properties by clicking link 631. As in the analyzer section of the form shown in FIG. 6C, the customer enters the constituent elements of the formulation 632. In the embodiment shown, to perform optimization, the customer enters the ingredient name 633 and the cost per pound 634 of each ingredient. As with the analyzer, in an embodiment of this invention, the formulation may include at least one PVC resin and at least one plasticizer to perform optimization.

When the customer has completed entering the analyzer and/or optimizer information, the customer clicks a submit button (not shown). The submit button causes the information contained in the customer input form to be transmitted to web server 25. Web server 25 receives the analyzer input 614 and the optimizer input 616. Web server 25 creates an email message including the analyzer and/or optimizer information and sends the email containing the information to the technical support group 618.

In an embodiment of this invention, several types of materials may be analyzed and optimized with respect to plasticizers, including compounds and plastisols. A compound is a dry blend, created by absorbing PVC into the plasticizer. The finished compound is a free-flowing powder. Plastisol is a dispersion of PVC resin in a plasticizer combined with a heat stabilizer and other components. The finished plastisol forms a liquid suspension.

In an embodiment of this invention, physical properties as well as cost may be available for analysis and optimization of a material. In another embodiment, only raw material costs may be available. For example, if an organization performs optimization analysis for a single type of material, analysis may be available for multiple compounds while optimization is available for only one.

FIG. 6E is a flowchart illustrating the process of analyzing and/or optimizing a formulation in an embodiment of this invention. FIGS. 6F and 6G are screenshots of the analyzer and optimizer output displays, respectively. In the process shown in FIG. 6E, the plasticizer formulation application provides the customer with the option of performing an analysis on the formulation 650. If the customer chooses not to perform analysis, the application presents the customer with the option of performing optimization 662. If the customer chooses to perform analysis, the system receives the components of the formulation, including the resin 652, the heat stabilizer 654, and any other components, which may be added to the formulation 656. Once the system has received the components of the formulation, the system calculates the basic properties of the formulation 660.

FIG. 6F is a screen shot of the output display of the basic properties for a formulation In the embodiment shown, the ingredients in the customer's formulation are listed in the COMPONENT column 680 of the analyzer output screen shown in FIG. 6F. The weight in pounds of each component in the formulation is listed in the POUNDS column 681.

Below the formulation listing are the basic physical properties of the customer's formulation. In the embodiment shown, the physical properties listed in the PHYSICAL PROPERTY column 682 are specific gravity; durometer hardness; tensile strength; ultimate elongation; modulus at 100% elongation; tear strength; 35K torsion modulus; 135K torsion modulus; soapy water ext. at 50C, 5 WT lost; oil extraction % loss; hexane extraction, % wt loss; impact brittleness D746, C; and activated carbon, % wt loss. For each physical property, the output form for the analyzer includes the estimated value in the ESTIMATED VALUE column 683.

Referring again to FIG. 6E, the application next presents the customer with the option of optimizing a formulation 662. If the customer chooses not to optimize a formulation, the process ends 676. Otherwise, the system receives the formulation from the customer 664 as well as the cost of the various components 668. In addition, the system receives targets for one or more physical properties 670. For example, a customer may specify a minimum, maximum, or exact tensile strength value for a formulation. The optimization application utilizes the physical property targets to optimize the formulation 672 and provide the information to the customer 674.

The optimizer may be unable to arrive at a formulation corresponding to the customer's targets for various physical properties. For example, a customer may specify a high tensile strength and a low tear strength. If these properties are related such that a high tensile strength is only present in formulations with high tear strength, the optimizer will be unable to arrive at a suitable formulation. If the physical property targets are compatible with one another, the optimizer will provide an optimized formulation 674. The optimized formulation output includes the list of components 684. The output also includes various properties of each component of the formulation 685, including the weight in pounds, the cost per pound, the total cost, density in pounds per gallon, the number of gallons and the manufacturer. Also included in the output of various basic physical properties of the formulation 686, including the weight per gallon of the formulation, the specific gravity, the cost in cents per pound, dollars per gallon, and dollars per cubic foot. In embodiments of this invention, the plasticizer formulator wizard may include help screens and options to display links for a disclaimer, policies, terms, and conditions.

Pressure-sensitive Adhesive Formulator Wizard

The Pressure Sensitive Adhesive Formulator Wizard provides a model to predict standard adhesive properties for a given component blend consisting of Eastotac H-100R resin, natural rubber, and paraffin oil along with a hindered phenol antioxidant, all dispersed in Toluene and containing 0.5% of an antioxidant. Standard adhesive properties predicted include 180-Peel Strength, PolyKen Tack, Rolling Ball Tack, Quick Stick, Room Temperature Hold Power, and Shear Adhesive Failure Temperature (SAFT). The user is permitted to input various component values and view the results on these six adhesive properties. The wizard calculations are based on the results of a modeling experiment in which 13 different blends of the component ingredients were analyzed and tested. The model results are provided for display and reference purposes only and can be viewed in either tabular or graphical formats.

Natural rubber is a major raw material in pressure sensitive adhesives (PSAs), and tackifying resins are essential for promoting their tack. These adhesives are often dissolved in organic solvents and applied as coatings. Previous technical reports provide testing data on natural rubber blends containing a small amount of oil. The purpose of this model was to evaluate the effect of increased amounts of paraffinic oils in natural rubber adhesive blends through using a trilinear optimization experiment. The adhesive raw material components consisted of Eastotac H-100R resin, natural rubber, and paraffin oil, along with a hindered phenol antioxidant, all dispersed in toluene. Testing responses included peel adhesion, quick stick, rolling ball and probe tack, holding power, and elevated temperature shear adhesions. Results of the testing responses indicate that the resin content had the strongest effect on 180-degree peel strength, with some interaction between oil and resin where increased resin increases the peel strength value. Oil had a strong effect on Polyken probe tack with increased oil lowering the test value. In rolling ball tack, there is a strong interaction between resin and oil where increased oil and decreased resin enhanced rolling ball tack. Oil has interaction with resin and rubber with the quick stick values, with increasing resin benefiting this response. Oil has a strong effect on both room temperature and SAFT properties. Increasing oil decreased the values in both responses.

All formulations for this model were prepared from a single batch of natural rubber (1000 g), which was milled at temperatures between 150-200° F. for 30 minutes. The adhesive blends were dissolved in toluene and tumbled approximately 72 hours until completely dissolved. Formulations were then coated to approximately 2-ml dry film thickness on a Mylar polyester film. The following tests were then performed on each formulation:

a) 180 Degree Peels (PSTC-1)

Five specimens (1″×12″) from each coated film were placed onto stainless steel panels and a 10-lb roller was passed over each specimen five times. Immediately after being prepared. the specimens were pulled at a 180 degree angle using an Instron instrument at a rate of 12 in/min. The reported values in the model are an average of the five tests.

b) Polyken Probe Tack from TMI's Polyken Test Manual)

Polyken probe tack was measured on 1-ml coated samples using a TMI (Testing Machine Inc.) Probe Tack Tester model 80-02-01 with a dwell time of 1 second and a speed of 0.1 cm/sec. The reported values are an average of 12 tests.

c) Rolling Ball Tack (PSTC-6)

Specimens were cut into 1″×18″ lengths. Each specimen was placed onto the rolling ball apparatus with the adhesive side up. A steel ball (7/16″ in diameter) was rolled at a 45 degree angle onto the adhesive side up specimen. The distance from the point where the ball initially contacts the adhesive to where it stops was measured in inches. The reported values are an average of 12 tests.

d ) Hold Power (PSTC-7)

Using the 1-ml coated Mylar film, specimens were cut into 1″×4″ lengths. A 1″×1″ square of the adhesive specimen was centered onto a stainless steel panel and two passes were done using a 10-lb roller. A clamp was placed on the free end of the specimen, ensuring that the clamp extended completely across the width and was properly aligned to distribute the load uniformly. The specimen was then placed in the test stand, and a 1000 g mass was applied to the clamp. The time that elapsed in which the specimen completely separated from the test panel was recorded. Holding power was determined at room temperatures. The reported values are an average of 12 tests.

e) Shear Adhesive Failure Temperature—SAFT(modified from ASTM D4498-95)

Using the 1-ml coated Mylar film, specimens were cut into 1″×3″ lengths. Two specimens were overlapped 1 inch (adhesive to adhesive). A clamp was placed on one free end of the specimen, ensuring that the clamp extended completely across the width and was properly aligned to distribute the load uniformly. The specimen was placed in the test stand, and a 500 g mass was applied to the clamp. The oven was conditioned to 40° C. for 10 minutes, and then programmed to ramp at a rate of 5° C./10 minutes. The time that elapsed in which the two-tape specimen completely separated was recorded and converted to degrees C. The reported values are an average of 12 tests.

i) Quick Stick (PSTC-5)

Using the 1-ml coated Mylar film, specimens were cut into 1″×12″ lengths. A specimen end was touched to the end of a test panel. Tension was relaxed and the specimen was allowed to drape smoothly onto the panel without any foreign pressure. The panel was immediately placed into the quick stick fixture and pulled at a 90° angle on an Instron instrument at a rate of 12 in/min. The reported values are an average of 12 tests.

The unique and unexpected results achieved here stem from incorporating this model to achieve excellent pressure sensitive adhesive results using only a three-component mixture of adhesive raw materials. Most pressure sensitive adhesives utilize additional components, such as low melt tackifiers, in addition to the 100C tackifier used in our experiment. Using this model introduces a novel method for solvent base pressure sensitive adhesive formulators to achieve optimal adhesive performance, thus reducing technical time, effort and resources.

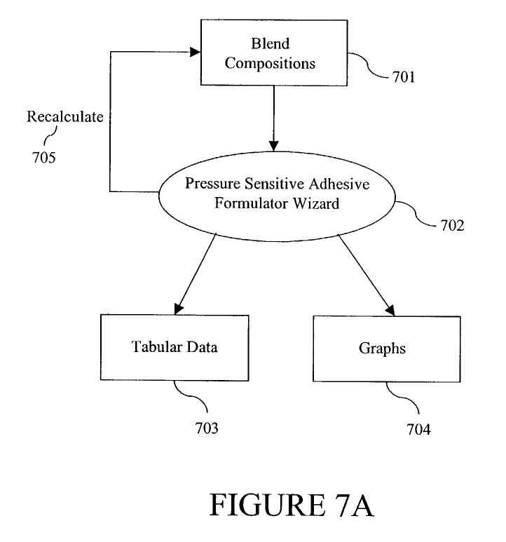

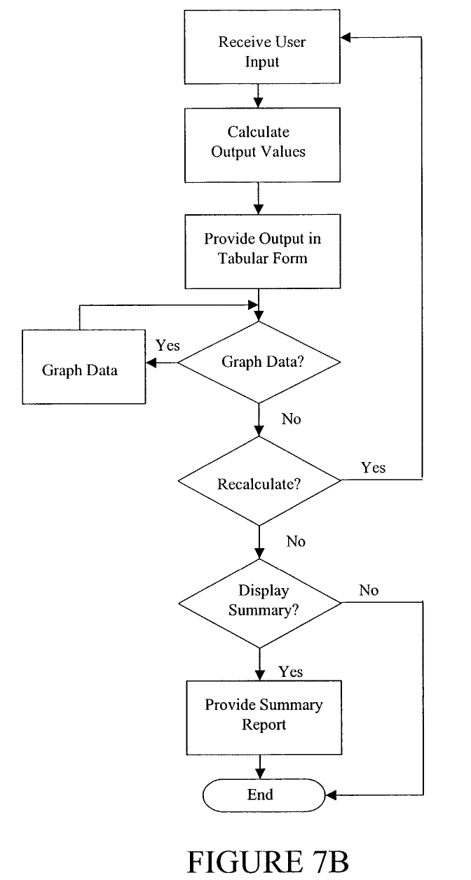

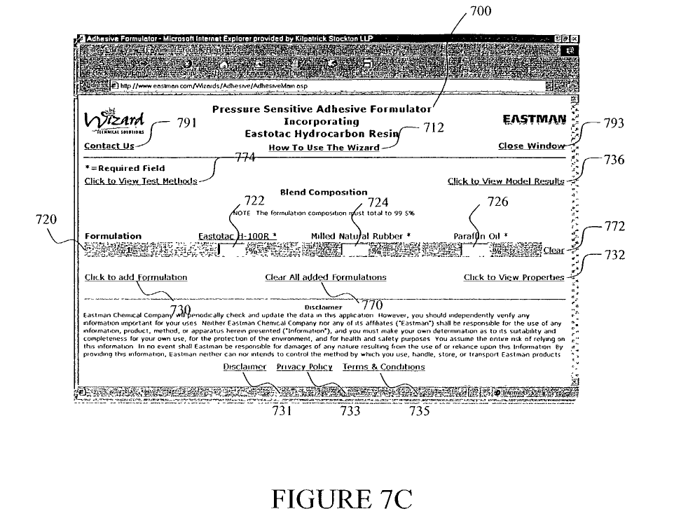

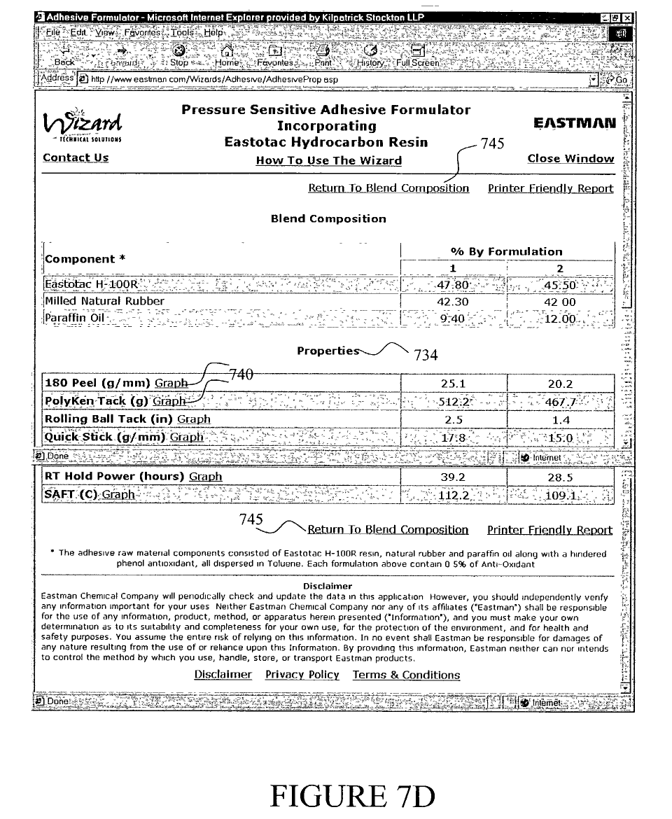

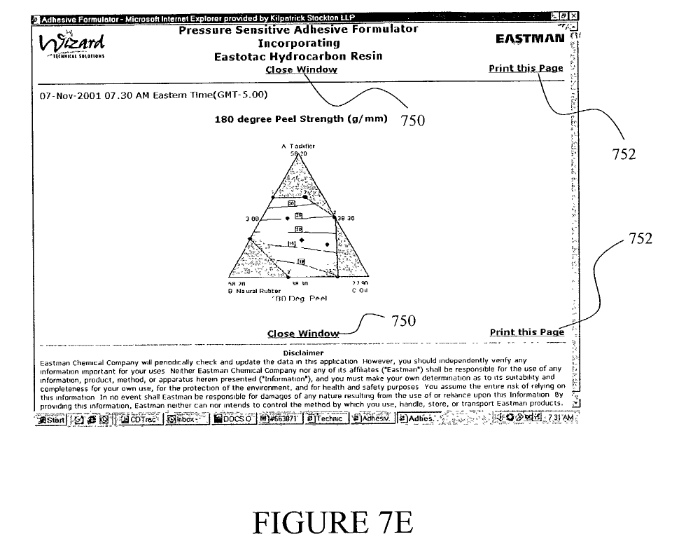

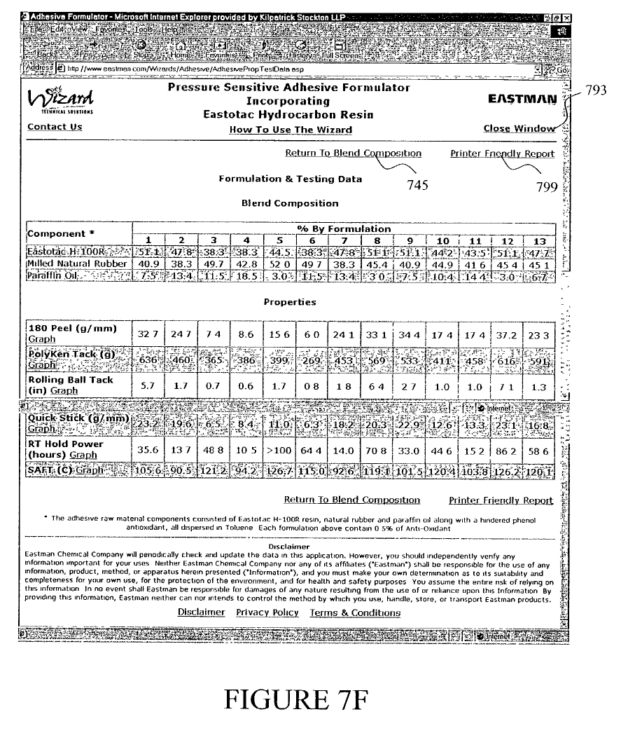

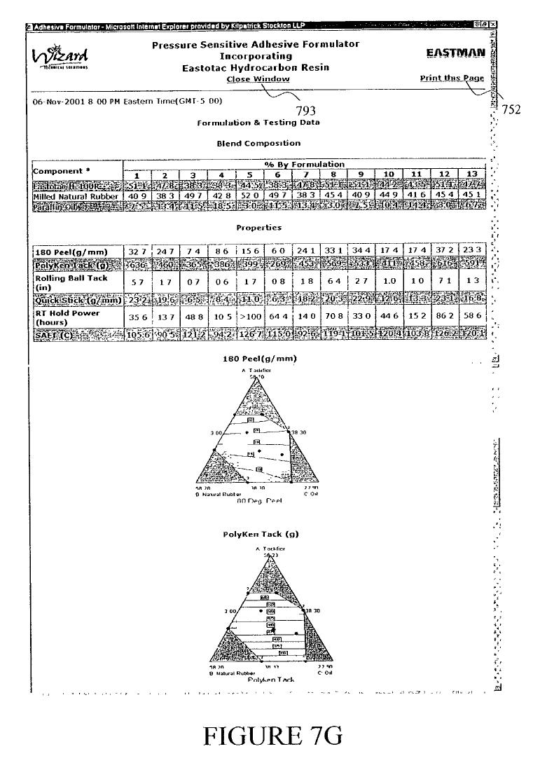

FIG. 7A is a block diagram illustrating the inputs and outputs of the Pressure Sensitive Adhesive Formulator Wizard. In one embodiment of this wizard, a user inputs one or more blend compositions 701. The wizard then calculates the standard adhesive properties of that blend 702 and outputs these properties in the form of tabular data 703 and graphs 704. The user is given the opportunity to change any input and have the wizard recalculate 705 the standard adhesive properties for the new blend(s). FIG. 7B is a flowchart illustrating the process carried out by one embodiment of the Pressure Sensitive Adhesive Formulator Wizard.

Now with reference to FIGS. 7C-7G, if a user is visiting this wizard for the first time, they may click on the “How To Use The Wizard” button 712 and the system will display detailed instructions about this wizard. Also, at any time, a user can contact the website host by clicking on the “Contact Us” button 791, or close the current window by clicking on the “Close Window” button 793.

To begin the pressure sensitive adhesive formulator calculation, at the Pressure Sensitive Adhesive Formulator page 700 shown in FIG. 7C, the wizard accepts input from a user about at least one blend composition 720. A user inputs the formulation of each blend they wish to investigate by inputting data for percent Eastotac H-100R 722, percent milled natural rubber 724, and percent paraffin oil 726. The total of the formulation composition will add to 99.5% because the wizard assumes that each blend contains 0.5% of an antioxidant. Once a user inputs one blend composition, additional blend compositions can also be added by clicking on the “Click to add Formulation” button 730. All formulations can be cleared by clicking on the “Clear All added Formulation” button 770, or each individual formulation can be cleared by clicking on the “Clear” button 772 next to the desired formulation.

Once a user enters the blend compositions, they can click on the “Click to View Properties” button 732. When this button is clicked, the wizard will automatically perform its calculations and proceed to the next window where the predicted properties of each blend will be displayed in tabular form 734 as shown in FIG. 7D. A user may also view a graphical representation of each of the predicted properties by clicking on the “Graph” button 740 next to the desired property. When a “Graph” button 740 is clicked, the wizard will automatically open a new window and display the relevant graph for the user, as shown in FIG. 7E. A user may print a given page by clicking on the “Print this Page” button 752. A user may close the current window by clicking on a “Close Window” button 750, and may return to the Pressure Sensitive Adhesive Formulator page 700 shown in FIG. 7C by clicking on a “Return to Blend Composition” button 745.

A user may view the test methods by clicking on the “Click to View Test Methods” button 774. When clicked, the wizard will automatically open a new window and display the test methods information. For information purposes, a user may also view the results of the modeling experiment upon which this wizard is based by clicking on the “Click to View Model Results” button 736. The wizard will automatically open a new window and display the formulation and testing data of the 13 different blends of the component ingredients that were analyzed and tested, as shown in FIG. 7F. Users may also click on any “Printer Friendly Report” button 799 and a new window will open and display the tabular and graphical results of the 13 different test blends in one printable window, as partially shown in FIG. 7G. A user may then print this consolidated report by clicking on the “Print the Page” button 752.

Once finished, the user may click on the “Close Window” button 793, and then click on the “Return to Blend Composition” button 745, to be returned to the Pressure Sensitive Adhesive Formulator page 700. If the user wishes to change any parameters and recalculate the properties for different blend compositions, this is easily accomplished by merely changing the desired values and then clicking on the “Click to View Properties” button 732 again.

As with the other wizards of the present invention, users can access additional information about the owner's policies by clicking on “Disclaimer” button 731, “Privacy Policy” button 733, and “Terms & Conditions” button 735. When a user clicks on any of these buttons, a new window will appear and display the relevant information.

Database Updates

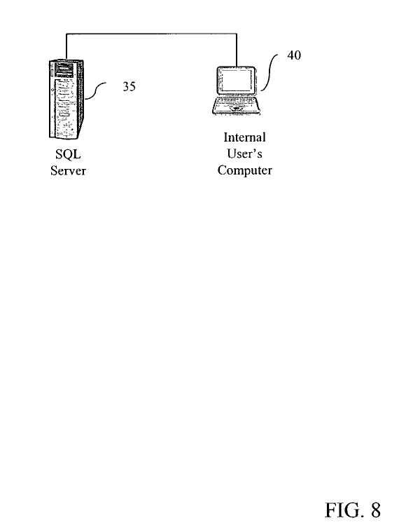

In an embodiment of this invention, a database update application allows a user using a computer 40 inside the internal network to add, modify, delete, and create reports containing data related to the various wizards. FIG. 8 is a block diagram illustrating the link between a user computer 40 and a database 35. The database update application is a common application for all wizards requiring database updates. In an embodiment of this invention, the architecture, data flow, and component diagrams for the database application is similar for all wizards. The actual code used to perform updates may vary because the individual tables related to the wizards vary.

In an embodiment of this invention, the database update application includes two sections, a selection screen and an update screen. Using a selection screen, a customer responsible for updating the data relating to the wizards can select an existing record from a drop-down list box and modify or delete the record. The customer can also click on an “add record” link in order to add a new record to the database table. Once the user has selected an action on the selection screen, the user is presented with an update screen.

The update screen displays the properties relevant to the specified wizard. If the user choses to modify or delete a record, the corresponding record details are displayed in the fields on the update screen. If the user chooses to add a new record, the input controls are blank, and the user may fill in appropriate values. Once the user has completed any necessary entry or modification, the user clicks an “Add,” “Modify,” or “Delete” button to execute the appropriate action in the database. The application performs the corresponding action within the database, such as the SQL Server database 35.

An embodiment of this invention may also include database reports. For example, a database report may include all of the properties for a specified record related to a wizard. The user may utilize the report for various purposes, such as creating a paper record of the state of a record at a point in time.

Intrinsic Viscosity Degradation Wizard

In an attempt to obtain the optimum intrinsic viscosity values for the resin or plastic in consideration, the Intrinsic Viscosity Degradation Wizard predicts the intrinsic viscosity of Eastapak PET (PolyEsTer) after eight passes through an extruder. This wizard utilizes a unique technique to derive the intrinsic viscosity degradation values based on the given inputs. The predicted intrinsic viscosities for the eight passes are calculated and then presented to the user in tabular form. The following parameters are used to calculate the predicted intrinsic viscosities: virgin resin intrinsic (or inherent) viscosity, pellet-drying feed temperature, melt temperature, virgin resin moisture content, regrind ratio, and regrind moisture. After the calculation is performed, the effects that these parameters have on intrinsic viscosity are presented to the user in graphical form.

Many assumptions may oversimplify the actual extrusion process such as assuming: a linear temperature profile; complete hydrolysis; and no interchange of moisture between virgin and regrind. It is suggested that this wizard be used for troubleshooting an extrusion process, training operations on critical components of the extrusion process or understanding the effects that each variable in the extrusion process has on the final product. This wizard should not be used for PETG products (copolyesters).

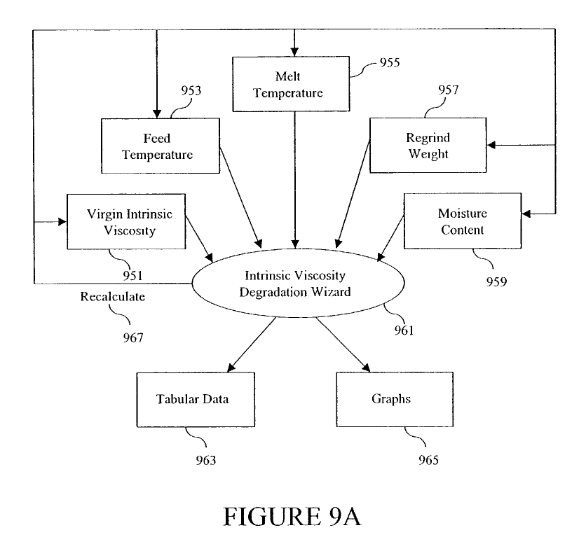

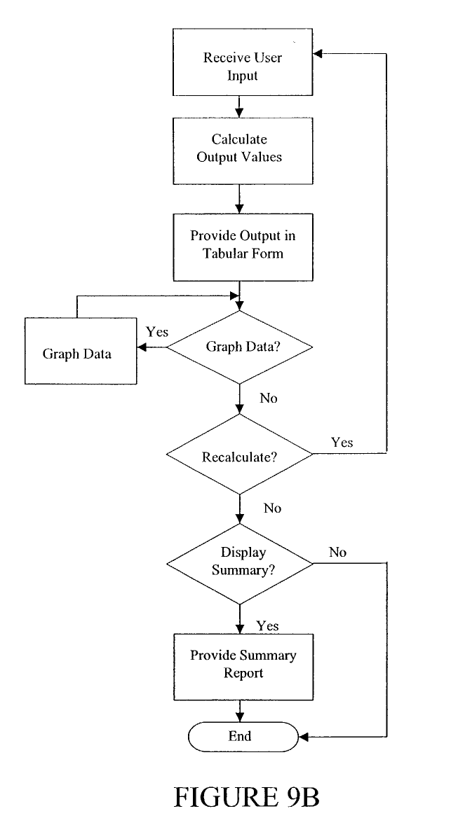

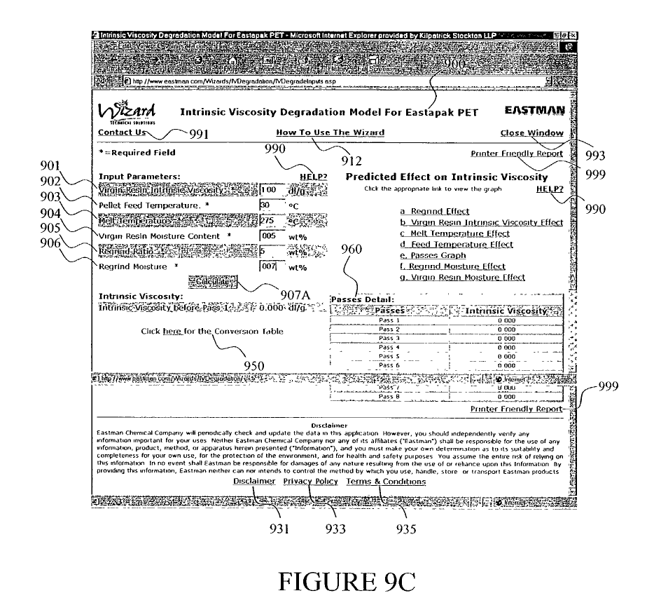

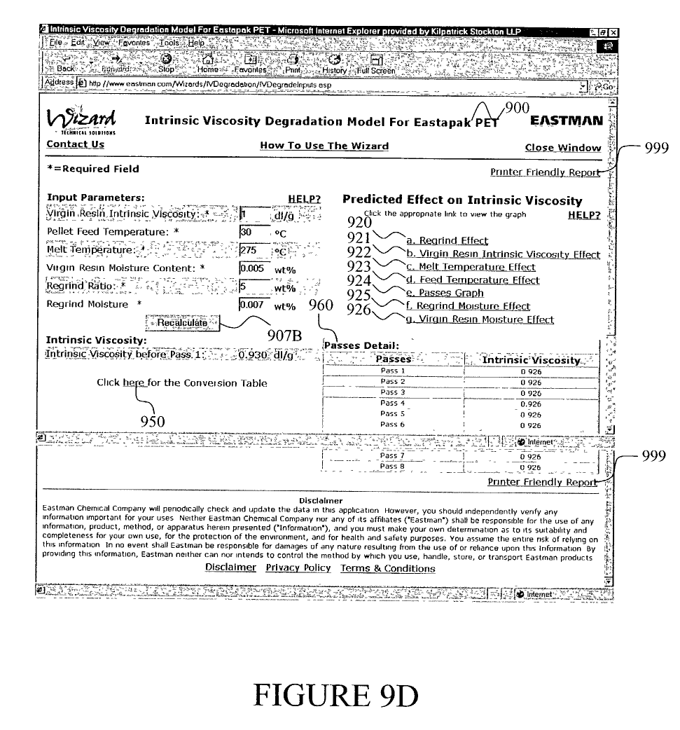

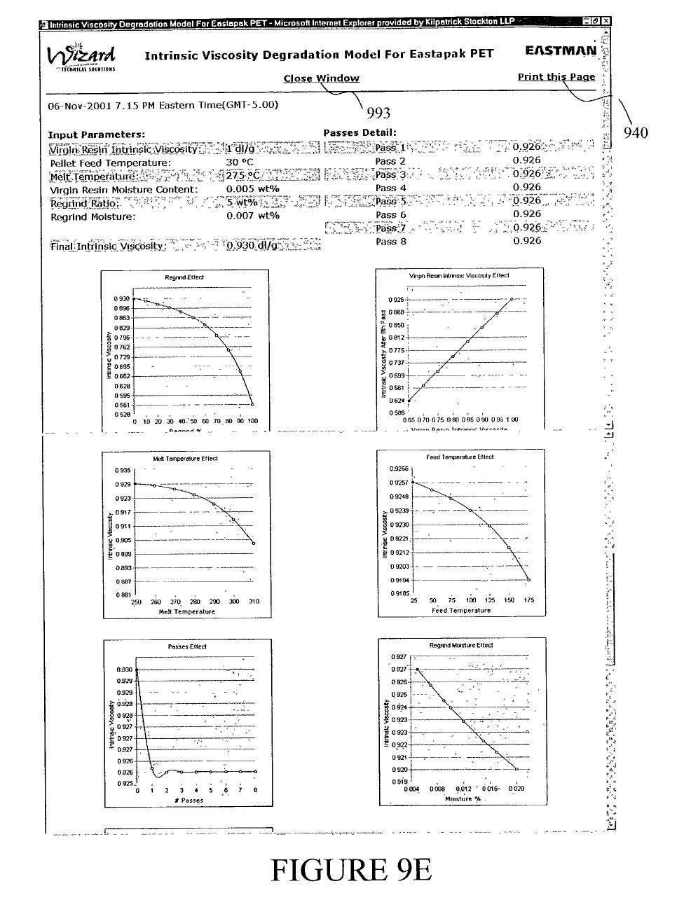

FIG. 9A is a block diagram illustrating the inputs and outputs of the Intrinsic Viscosity Degradation Wizard. In one embodiment of this wizard, a user inputs virgin intrinsic viscosity 951, feed temperature 953, melt temperature 955, regrind weight 957, and moisture content 959. The wizard then calculates the intrinsic viscosity of the material after each pass through an extruder 961 and displays this information in the form of tabular data 963 and graphs 965. The user is given the opportunity to change any input and have the wizard recalculate 967 the intrinsic viscosity based on the new input. FIG. 9B is a flowchart illustrating the process carried out by one embodiment of the Intrinsic Viscosity Degradation Wizard.

With reference to FIGS. 9C-9E, if a user is visiting this wizard for the first time, they may click on the “How To Use The Wizard” button 912 and the system will display detailed instructions about this wizard. Also, at any time, a user can access help instructions by clicking on any “Help” button 990, contact the website host by clicking on the “Contact Us” button 991, or close the current window by clicking on the “Close Window” button 993.

To begin the intrinsic viscosity degradation calculation, at the Intrinsic Viscosity Degradation Model Calculation page 900 as shown in FIG. 9C, the wizard accepts input from a user regarding the following parameters: initial virgin resin intrinsic viscosity 901, pellet feed temperature (e.g., temperature of the pellets as they reach the extruder throat) 902, melt temperature (e.g., temperature of the plastic as is exits the die) 903, virgin resin moisture content 904, regrind ratio (e.g., amount of regrind scrap from the extrusion process) 905, and regrind moisture (e.g., moisture content of the pellets after feed or as they enter the feed throat) 906. Once these parameters are input by a user, the user may click on the “Calculate” button 907A, and the wizard will calculate the intrinsic viscosity before the first pass and after each pass through the extruder.

The wizard will display the predicted intrinsic viscosities for each pass in tabular form 960 as shown in FIG. 9D. The wizard will also generate seven different graphs for different kinds of analysis which a user can access by clicking on the relevant button: regrind effect 920; virgin resin intrinsic viscosity effect 921; melt temperature effect 922; feed temperature effect 923; passes graph 924; regrind moisture effect 925; and virgin resin moisture effect 926. When a user clicks on any one of these buttons, a new window will open and the one selected graph will be displayed. If a user wishes to view all seven graphs at once, without having to individually open each graph, the user may click the “Printer Friendly Report” button 999 and a new window will open and display all the output detail and all seven graphs in one printable window as partially shown in FIG. 9E. A user may then print this consolidated report by clicking on the “Print the Page” button 940.

Once finished, the user may click on the “Close Window” button 993 to be returned to the Intrinsic Viscosity Degradation Model Calculation page 900 shown in FIG. 9D. If the user wishes to change any parameters and recalculate the intrinsic viscosity degradation, this is easily accomplished by merely changing the desired values and then clicking on the “Recalculate” button 907B as shown in FIG. 9D. For additional convenience, if the user needs to convert any values between Celsius and Fahrenheit, or convert inherent viscosity to intrinsic viscosity, they can click on the “Click here for the Conversion Table” button 950 and the wizard will open a new window where the user can perform the necessary conversions.

As with the other wizards of the present invention, users can access additional information about the owner's policies by clicking on “Disclaimer” button 931, “Privacy Policy” button 933, and “Terms & Conditions” button 935. When a users clicks on any of these buttons, a new window will appear and display the relevant information.

Injection Molding Part-cost Estimation Wizard

The Injection Molding Part Cost Estimation Wizard estimates the cost of a plastic injection molded part based on the cost of the resin, the machine time, and any secondary fabrication. The predicted values of costs are divided into three sections: Material Cost Estimations, Process Cost Estimations, and Cost Breakdown (per 1000 parts basis). To calculate the estimated projected part costs, a user inputs information about the material that is being molded, the process involved in the molding, and the user's amortized costs, shop costs, and any additional costs. Based on this information, the wizard calculates the predicted part costs and presents them to the user in tabular and graphical form. This wizard allows injection molders to run “what if” scenarios, giving them the ability to examine many facets of the process as an aid to designing a new process or optimizing an existing one.

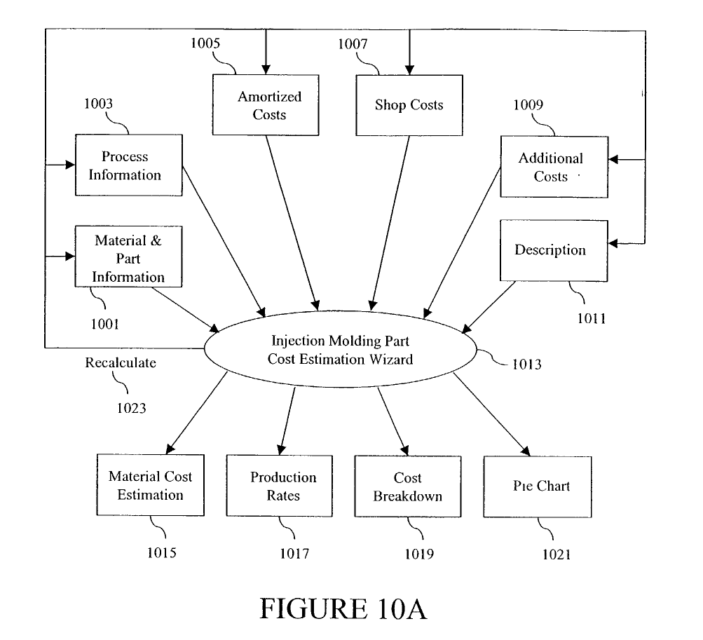

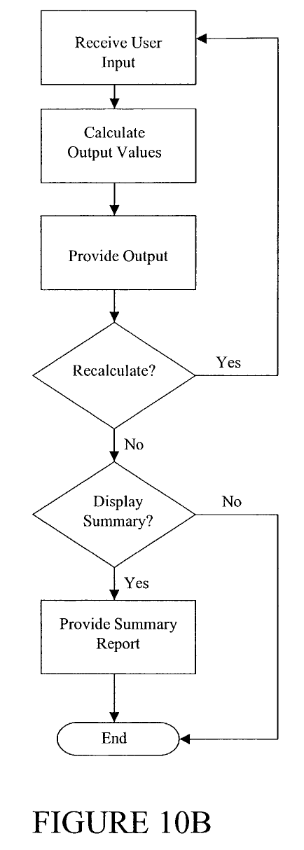

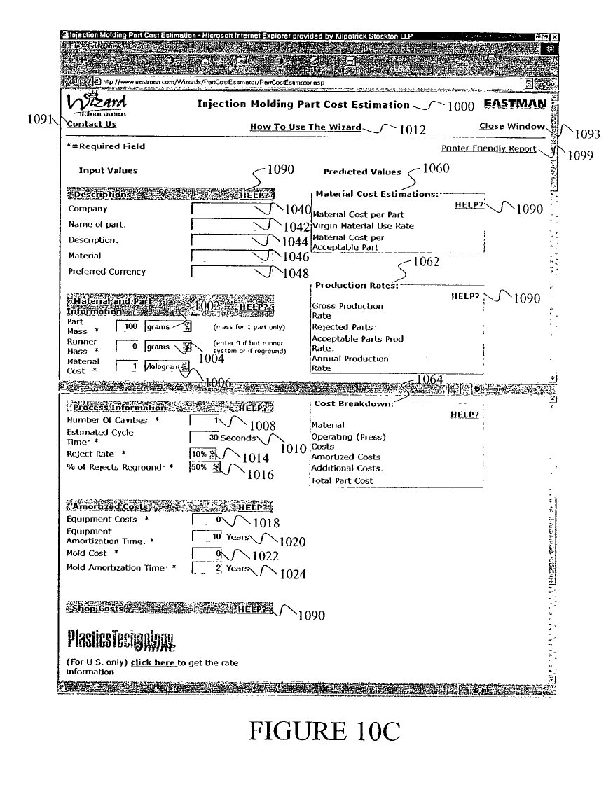

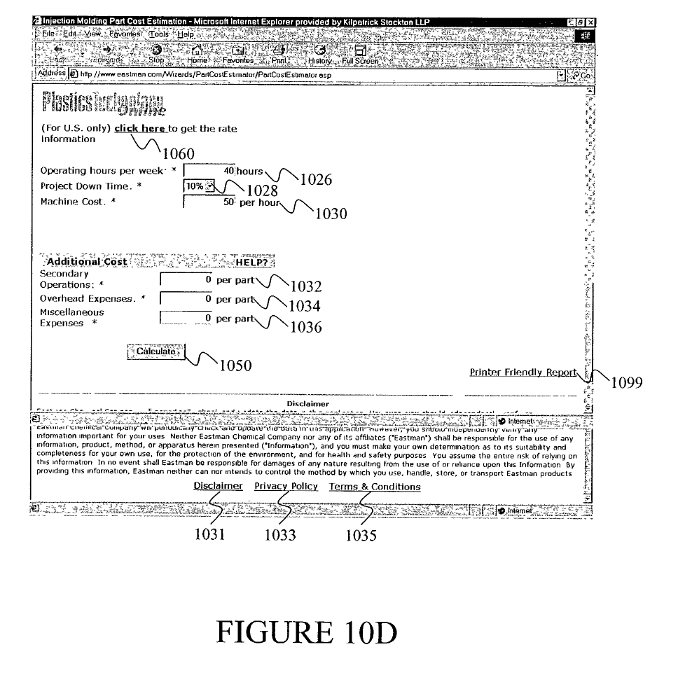

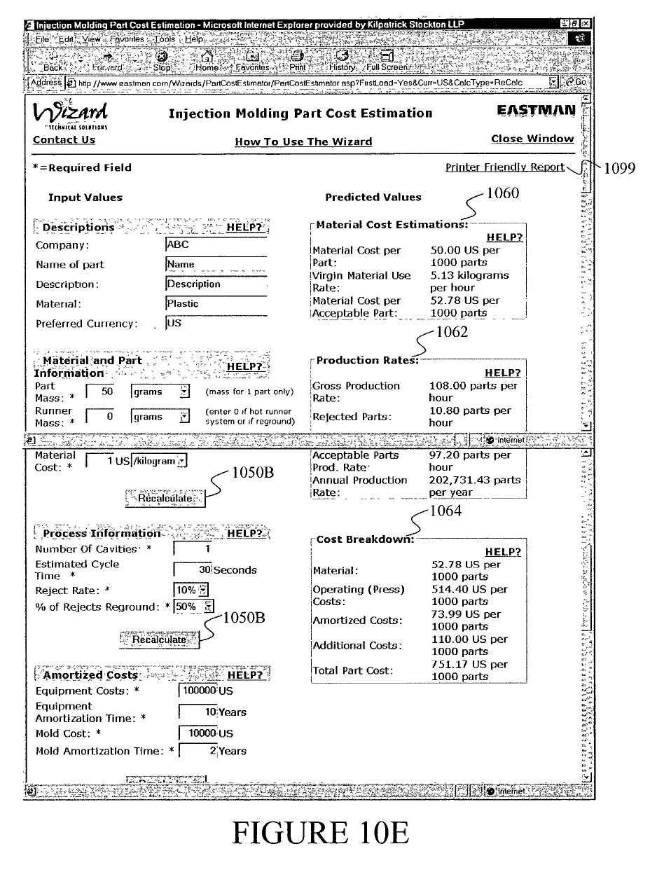

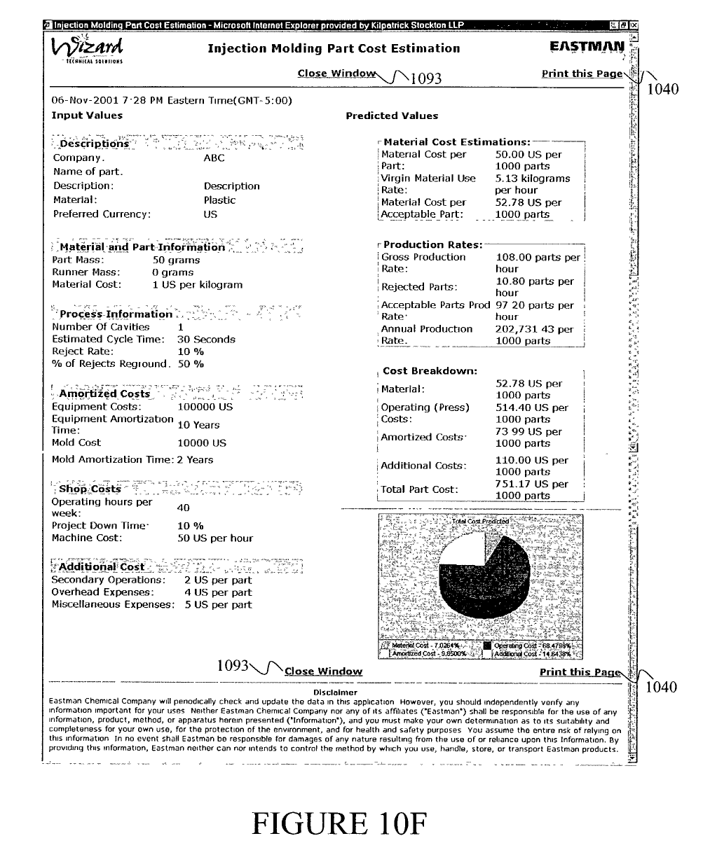

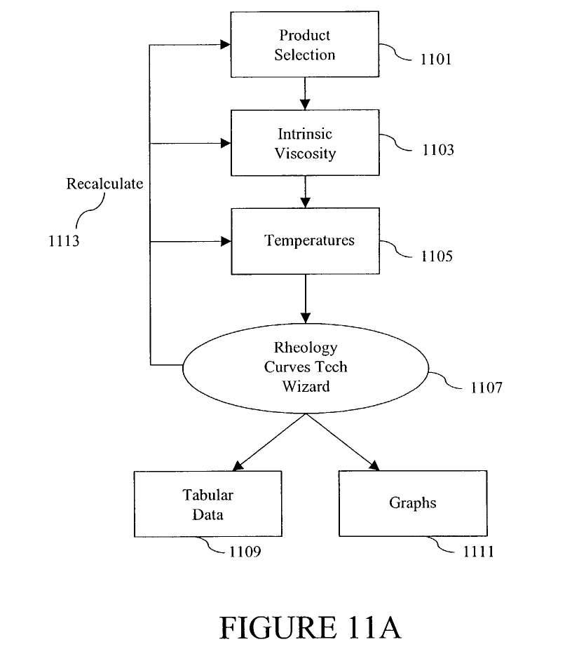

FIG. 10A is a block diagram illustrating the inputs and outputs of the Injection Molding Part Cost Estimation Wizard. In one embodiment of this wizard, a user inputs material and part information 1001, process information 1003, amortized costs 1005, shop costs 1007, and additional costs 1009. A description 1011 may also be input, if desired. The wizard then calculates the estimated part costs 1013 and displays the information in material cost estimation table 1015, production rates table 1017, cost breakdown table 1019, and pie chart 1021. The user is then given the opportunity to change any inputs and have the wizard recalculate 1023 the part costs based on the new inputs. FIG. 10B is a flowchart illustrating the process carried out by one embodiment of the Injection Molding Part Cost Estimation Wizard.

With reference to FIGS. 10C-10D, if a user is visiting this wizard for the first time, they may click on the “How To Use The Wizard” button 1012 and the system will display detailed instructions about this wizard. Also, at any time, a user can access help instructions by clicking on any “Help” button 1090, contact the website host by clicking on the “Contact Us” button 1091, or close the current window by clicking on the “Close Window” button 1093.

To begin the injection molding part cost estimation calculation, at the Injection Molding Part Cost Estimation page 1000 shown in FIG. 10C, the wizard accepts input from a user regarding the following utilized parameters: part mass 1002, runner mass 1004, material cost 1006, number of cavities 1008, estimated or measured cycle time (mold open to mold open) 1010, reject rate (including all the parts rejected, even if they are reground) 1014, percent of rejects reground and re-used 1016, equipment costs 1018, equipment amortization time 1020. mold cost 1022, mold amortization time 1024, operating hours per week 1026, estimated project down time 1028, machine cost (on a per hour basis) 1030, secondary operations (on a per part basis) 1032, overhead expenses (on a per part basis) 1034, and miscellaneous expenses (on a per part basis) 1036.

When entering information about the material and part, the mass of an individual molded part should be entered in part mass 1002. However, if multi-cavity molds are being used, the mass of all parts should be entered for part mass 1002, and the number of cavities 1008 should be one. For runner mass 1004, a user should input the mass of the entire runner system. However, if a hot runner system is used, or if the runner system is reground, then a user should enter zero for runner mass 1004.

When entering information about machine cost 1030, a user should include the costs of operating the molding machine on a per hour basis, including power, water, operator time and overhead expenses associated with the operation. For additional user convenience, a user may click on the “click here” button 1060 to access hourly rate information for the U.S. When this “click here” button 1060 is clicked, the wizard automatically opens a new window and displays information that is available through a public internet sites such as www.plastictechnology.com.

Other optional information may also be input, including: company name 1040, name of part 1042, description 1044, material 1046, and the preferred currency 1048. This optional information is not used in any calculation, but it is useful in describing the process, especially when multiple scenarios are run by a user. Once all the utilized information is entered by the user, the user should click on the “Calculate” button 1050 and the wizard will perform its calculations. The wizard will then display its predicted values in tabular form in the material cost estimations window 1060, the production rates window 1062 and the cost breakdown window 1064 as shown in FIG. 10E. Users may also click on the “Printer Friendly Report” button 1099 and a new window will open and display the input and results in one printable window, along with a pie graph of the predicted costs, as shown in FIG. 10F. A user may then print this consolidated report by clicking on the “Print the Page” button 1040.

Once finished, the user may click on the “Close Window” button 1093 to be returned to the Injection Molding Part Cost Estimation page 1000 as shown in FIG. 10E. If the user wishes to change any parameters and recalculate the part cost estimation, this is easily accomplished by merely changing the desired values and then clicking on any “Recalculate” button 1050B.

As with the other wizards of the present invention, users can access additional information about the owner's policies by clicking on “Disclaimer” button 1031, “Privacy Policy” button 1033, and “Terms & Conditions” button 1035. When a users clicks on any of these buttons, a new window will appear and display the relevant information.

Rheology Curves Tech Wizard

The Rheology Curves Tech Wizard calculates the melt viscosity of any Eastar and Eastapak polymers listed as a function of shear rate at up to three different temperatures. The intrinsic viscosity of each polymer is supplied by the user as an input parameter. The wizard then calculates melt viscosity data and displays it in tabular and logarithmic graphical forms to a user. Based on the resin type selected by a user (e.g., the PET or PETG kind of resins) the formulation and constants for obtaining various viscosity values will change.

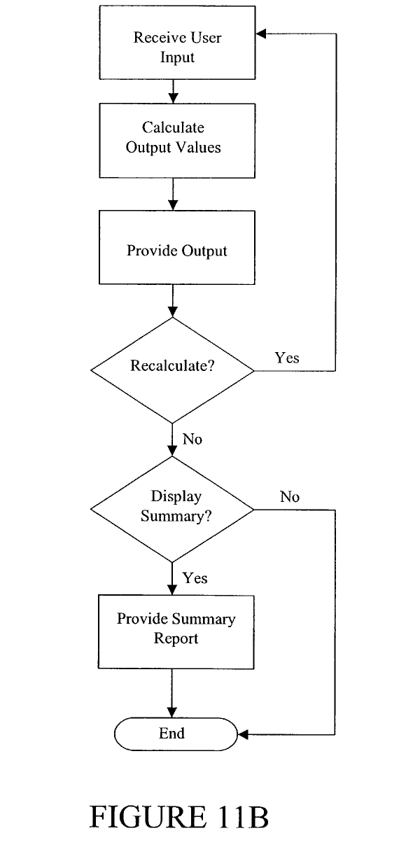

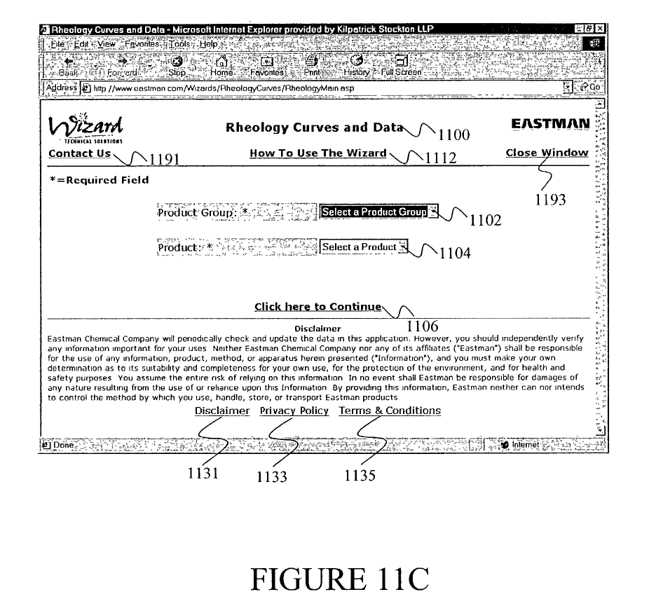

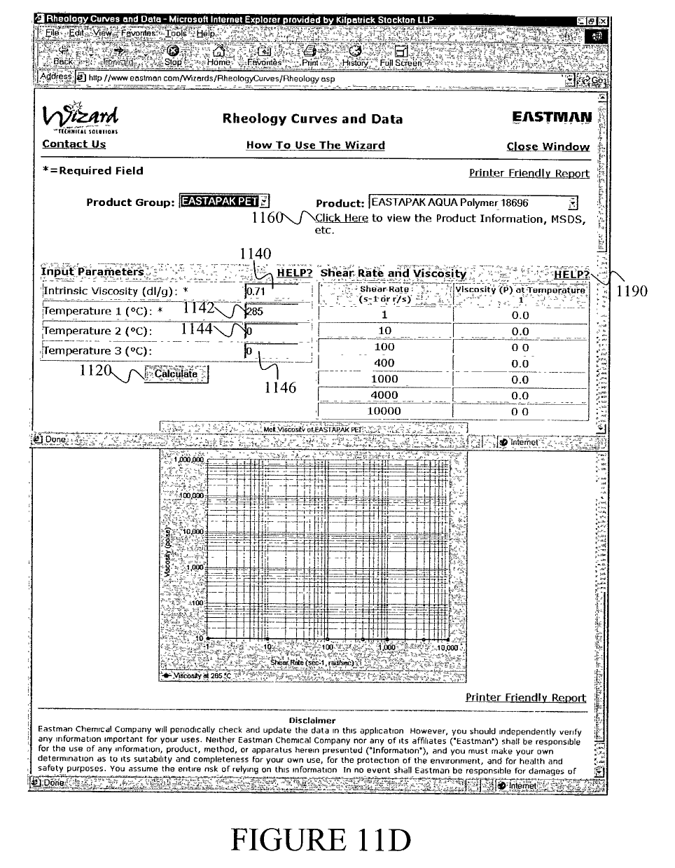

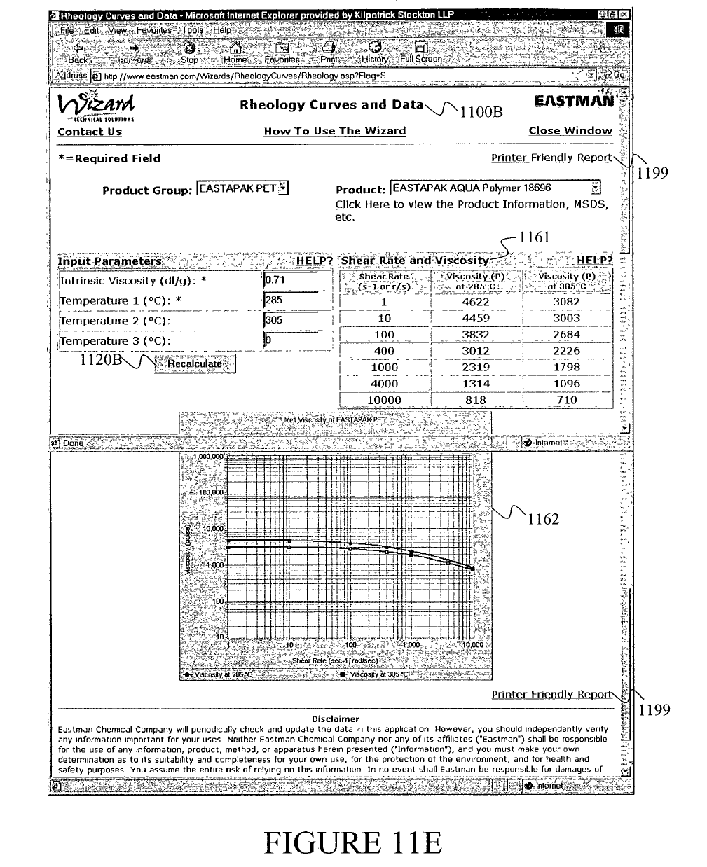

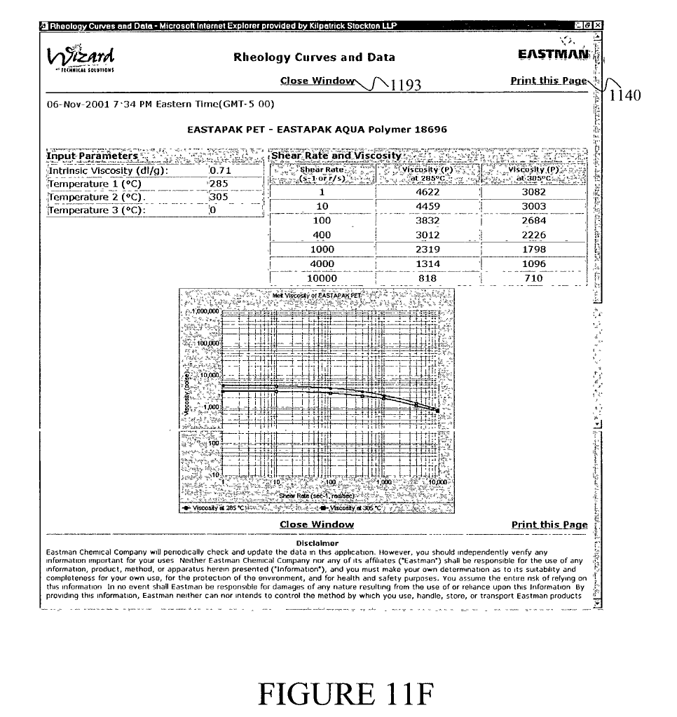

FIG. 11A is a block diagram illustrating the inputs and outputs of the Rheology Curves Tech Wizard. In one embodiment of this wizard, a user selects a product group and a product 1101, and then inputs the intrinsic viscosity of the product 1103 and up to three temperatures 1105 at which they would like to know the melt viscosity of the product. The wizard then calculates the melt viscosity of the product at the selected temperatures 1107, and outputs the information to the user as tabular data 1109 and graphs 1111. The user is then given the opportunity to change their input and have the wizard recalculate the melt viscosity 1113. FIG. 11B is a flowchart illustrating the process carried out by one embodiment of the Rheology Curves Tech Wizard.

With reference to FIG. 11C, if a user is visiting this wizard for the first time, they may click on the “How To Use The Wizard” button 1112 and the system will display detailed instructions about this wizard. Also, at any time, a user can contact the website host by clicking on the “Contact Us” button 1191, or close the current window by clicking on the “Close Window” button 1193.

To begin the rheology curves calculation, at the Rheology Curves and Data page 1100 shown in FIG. 11C, the wizard accepts input from a user, via pull-down lists, regarding the product group 1102 and product 1104. Once a user selects both a product group and a product, they should click on the “Click here to Continue” button 1106.

The wizard will automatically proceed to the next window, as shown in FIG. 11D, where the user will be expected to input the intrinsic viscosity of their product 1140, as well as up to three temperatures 1142, 1144, and 1146 at which they would like the wizard to calculate the melt viscosity. The intrinsic viscosity of the selected product will automatically appear in the input field 1140 by default. Although it is recommended that the default value be used, the user may change this intrinsic viscosity value 1140 to any value. For additional user convenience, users may click on the “Click Here” button 1160 to view product information, MSDS, etc. of their selected product. The wizard will automatically open a new window and display any such requested information.

Once the intrinsic viscosity 1140 and temperature data 1142, 1144, and 1146 is input, the user should click on the “Calculate” button 1120 and the wizard will perform its calculations. The wizard will then display its calculated values in tabular form in the shear rate and viscosity window 1161, and in graphical form 1162, as shown in FIG. 11E. Users may also click on either “Printer Friendly Report” button 1199 and a new window will open and display the input and results in one printable window, as shown in FIG. 11F. A user may then print this consolidated report by clicking on the “Print the Page” button 1140.

Once finished, the user may click on the “Close Window” button 1193 to be returned to the Rheology Curves and Data page 1100B as shown in FIG. 11E. If the user wishes to change any parameters and recalculate the rheology curves, this is easily accomplished by merely changing the desired values and then clicking on the “Recalculate” button 1120B.

As with the other wizards of the present invention, users can access additional information about the owner's policies by clicking on “Disclaimer” button 1131, “Privacy Policy” button 1133, and “Terms & Conditions” button 1135. When a user clicks on any of these buttons, a new window will appear and display the relevant information.

Cantilever Snap-fit Design Analysis Wizard

The Cantilever Snap-Fit Design Analysis Wizard calculates the theoretical strain that occurs when a snap-fit latch is deflected. The maximum strain occurs on the outer layer of the thickness, usually at the base of the latch. Strains can also be calculated for a latch that varies linearly in both thickness and width from the base of the tip to the latch. This wizard allows a user to input data about the measurements, brand and material of a snap-fit latch, and then calculates the theoretical strain that occurs when that snap-fit latch is deflected. This information is then displayed in tabular format for the user.

When solving the strain equations for cantilever snap-fit latches, several assumptions are made, including: that the cantilever is not strained beyond its elastic limit, and therefore, no permanent set or deflection occurs; that the beam material is not strained beyond the proportional limit; that stress concentration effects are ignored; that the cantilever is rigidly fixed to its supporting wall and the supporting wall does not flex when the cantilever is deflected; and that the beam length-to-thickness ratio is reasonably large (on the order of ten-to-one). When the cantilever length is not more than 10 times the thickness of the latch, the theoretical equations begin to lose some accuracy, and the calculated strain will be higher than the actual strain.

If the snap length to base thickness ratio is small (e.g., less than 10) the accuracy of the formulas in this wizard begins to deteriorate, and the calculated strains will be larger than the actual strains. Many facts may be considered when arriving at an allowable strain number. One such fact is the beam length-to-thickness effects mentioned above, wherein the inaccuracy develops primarily because shear effects are ignored. Another fact is that in most cases, the supporting wall that the snap is attached to will deflect somewhat. This deflection also makes the cantilever strain predictions conservative. Another fact is that orientation in the skin of the molded part generally makes the outer layer stronger than the bulk properties would suggest. This effect increases as the arm becomes thinner. Another fact is that a small amount of yield in the outer skin of the arm, resulting in some permanent damage or deflection, may not impair the functioning of the snap-fit if allowed for in the design. Most such damage occurs during the first deflection, and repeated deflections may be possible. Finally, less damage is sustained in the rapid deflection and return of snap arms than is sustained in the slow deflection of mechanical testing.

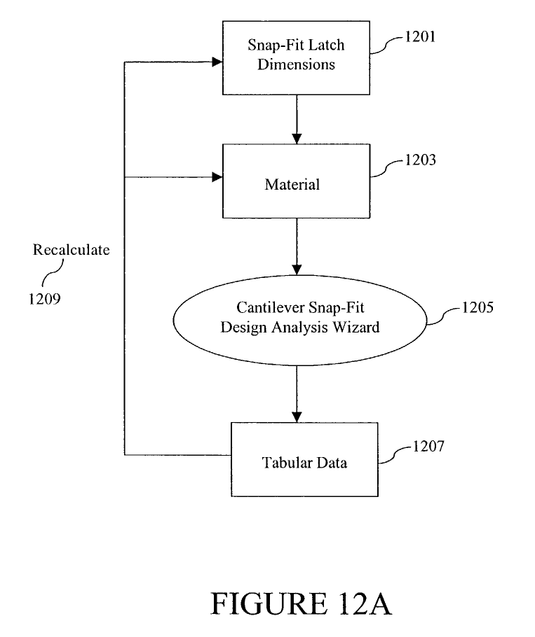

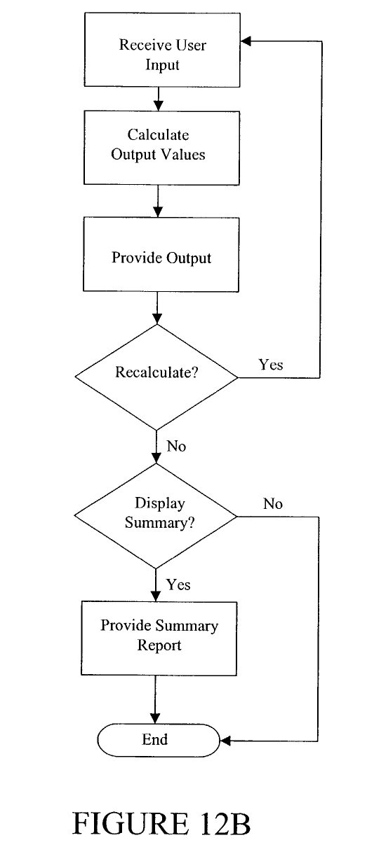

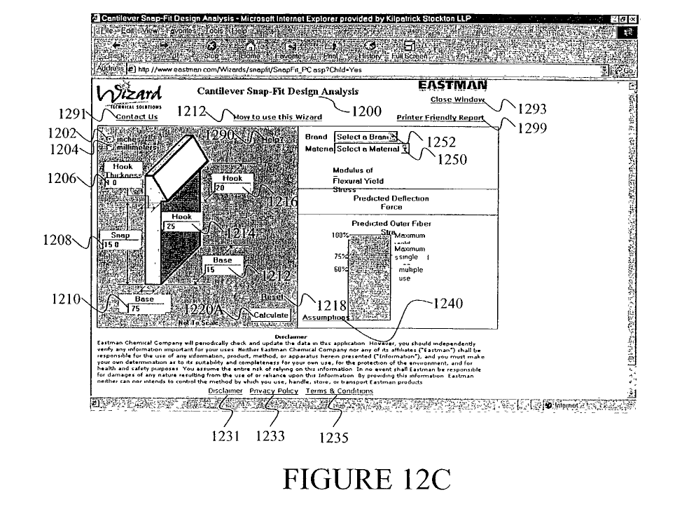

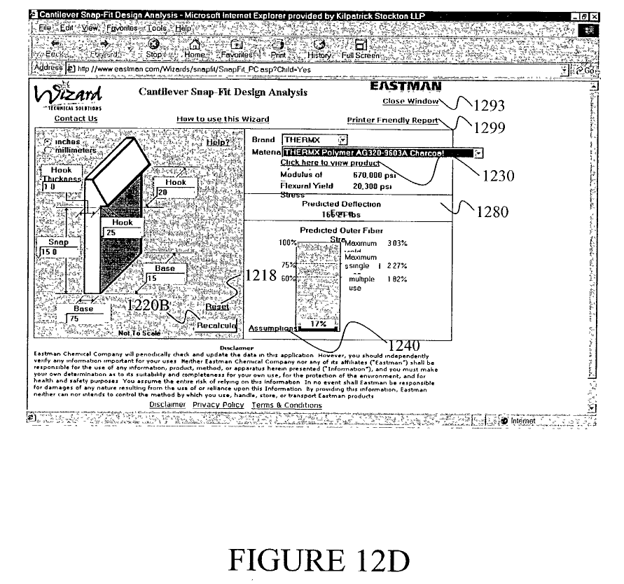

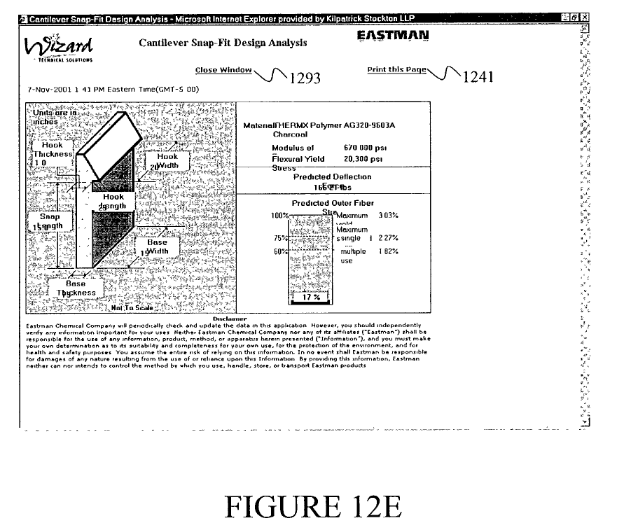

FIG. 12A is a block diagram illustrating the inputs and outputs of the Cantilever Snap-Fit Design Analysis Wizard. In one embodiment of this wizard, a user provides the dimensions of a snap-fit latch 1201, as well as the material type and brand 1203. The wizard then calculates the theoretical strain that occurs when that snap-fit latch is deflected 1205, and outputs the information to a user in tabular form 1207. The user is then given the opportunity to modify any parameters and have the wizard recalculate the theoretical strain that occurs when the new snap-fit latch is deflected 1209. FIG. 12B is a flowchart illustrating the process carried out by one embodiment of the Cantilever Snap-Fit Design Analysis Wizard.

With reference to FIGS. 12C-12E, if a user is visiting this wizard for the first time, they may click on the “How To Use The Wizard” button 1212 and the system will display detailed instructions about this wizard. Also, at any time, a user can access help instructions by clicking on a “Help” button 1290, contact the website host by clicking on the “Contact Us” button 1291, or close the current window by clicking on the “Close Window” button 1293.

To begin the cantilever snap-fit design analysis, at the Cantilever Snap-Fit Design Analysis page 1200 shown in FIG. 12C, the wizard accepts input from a user regarding the dimensions of their snap-fit latch. Users should input dimensions in either inches 1202 or millimeters 1204. Dimensions may be input for: the thickness of the latch at the hook 1206, snap length (measured from base to bottom of hook) 1208, thickness of latch at base 1210, width of latch at base 1212, hook length (maximum deflection of latch during engagement) 1214, and width of latch at hook 1216. The user may also select a material from material pull-down list 1250 and a brand from brand pull-down list 1252. Once all selections are made, a user should click on the “Calculate” button 1220A. The wizard will then display its calculated values in tabular form 1280, as shown in FIG. 12D. A user can clear all dimensions by clicking on the “Reset” button 1218. Additionally, a user can change one or more dimensions and click on “Recalculate” button 1220B.

For additional user convenience, a user may click on the “Click here to view product” button 1230 and the wizard will open a new window and display the requested information. Users may also click on the “Assumptions” button 1240 and the wizard will open a new window and display the requested information. Users may also click on the “Printer Friendly Report” button 1299 and a new window will open and display the input and results in one printable window, as shown in FIG. 12E. A user may then print this consolidated report by clicking on the “Print the Page” button 1241. Once finished, the user may click on the “Close Window” button 1293 to be returned to the Cantilever Snap-Fit Design Analysis page 1200 as shown in FIG. 12D.

As with the other wizards of the present invention, users can access additional information about the owner's policies by clicking on “Disclaimer” button 1231, “Privacy Policy” button 1233, and “Terms & Conditions” button 1235. When a users clicks on any of these buttons, a new window will appear and display the relevant information.

Oxygen (O2) Ingress Wizard

In an embodiment of this invention, an Oxygen (O2) Ingress Wizard draws a Polyethylene Terephthalate (PET) bottle based on customer inputs and calculates the time to reach an oxygen exposure limit and/or predicts the oxygen ingress over the shelf life of a product packaged in the PET bottle. The wizard estimates ingress based on container geometry, material distribution and the permeability of packaging materials. The wizard uses a combination of historical data, theoretical models and empirical correlations to estimate oxygen transmission into a hypothetical package in parts per million (PPM).

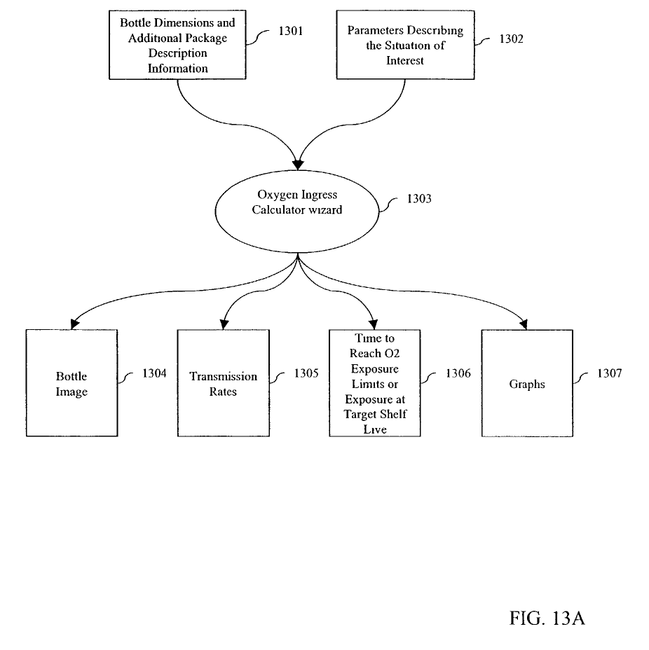

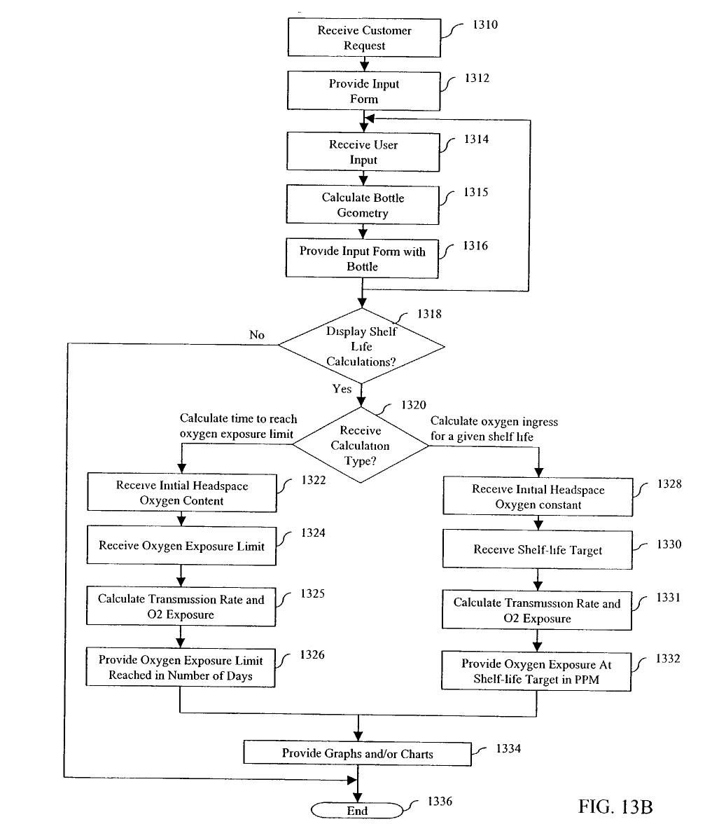

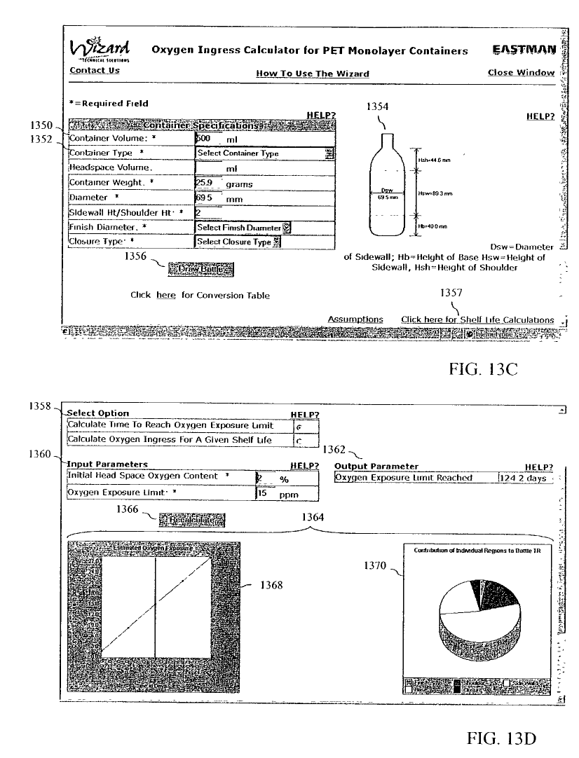

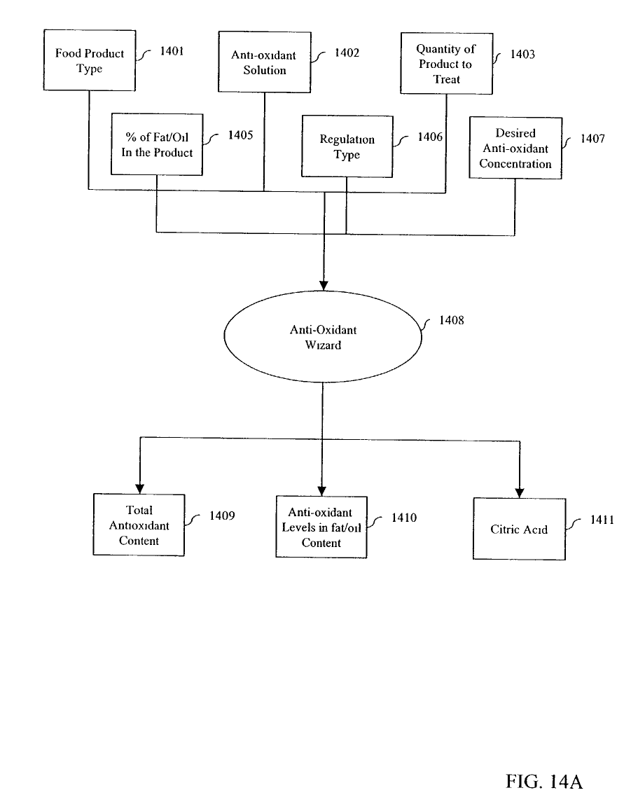

FIG. 13A is a block diagram illustrating the inputs and outputs of an oxygen ingress wizard in an embodiment of this invention. The oxygen ingress wizard 1303 accepts the bottle dimensions and additional information describing the package 1301 and the parameters describing the situation of interest (headspace oxygen content, target shelf life or product oxygen exposure limit) 1302. The wizard 1303 processes this information and provides a bottle image 1304 that satisfies the constraints provided by the customer inputs. The wizard 1303 also calculates and provides transmission rates 1305 and O2 exposure for a given shelf life and/or calculates and provides the time to reach an oxygen exposure limit 1306. The wizard presents this information in numeric format and/or graphical format 1307.

FIG. 13B is a flowchart illustrating the process implemented by an oxygen ingress wizard in an embodiment of this invention. FIGS. 13C and 13D are screen shots of the parameter-entry and output display HTML pages for an oxygen ingress wizard. In the embodiment shown, the customer accesses a web browser on the customer's computer 5. The customer clicks on an oxygen ingress wizard hyperlink to access the oxygen ingress wizard. Clicking on a hyperlink results in web server 25 receiving an HTTP request 1310. In response, web server 25 provides the customer input form as shown in FIG. 13C 1312. The customer enters various dimensions in this form, which are used to draw a bottle that meets the constraints imposed by the customer inputs. A default bottle may be displayed on the form, such as the 500-ml bottle 1354 illustrated in FIG. 13C.

The customer may enter criteria, such as the container volume 1350, and/or select from drop-down controls, such as container type 1352. Once the customer has entered all of the criteria, the customer clicks a button, such as a “Draw Bottle” button 1356. Web server 25 receives the customer input 1314, performs the calculations utilized to determine the remaining bottle dimensions 1315 and recreates the input form, including a drawing of a bottle 1354 matching the customer's specifications 1316. The captions on controls on the resultant form may change to indicate that the drawing reflects the customer's specification. For example, web server 25 may generate the page so that the caption on the “Draw Bottle” button 1356 changes to “Redraw Bottle.” As shown in FIG. 13B, the web server 25 the customer may cause steps 1314, 1315, and 1316 to repeat in order to change the input parameters and redraw the bottle 1354.

In one embodiment of this invention, the customer can convert the input values from one unit of measure to another using a separate unit conversion HTML page (not shown). The unit conversion page may, for example, allow the customer to convert values from inches to millimeters, from millimeters to mils, and/or from ounces to milliliters.

Once the customer has finalized the bottle image, the customer navigates to the shelf-life calculation HTML page as illustrated in FIG. 13D 1318 by clicking the “Click Here for Shelf Life Calculations” link 1357. If the customer chooses not to view the shelf-life calculations, the process illustrated in FIG. 13B ends 1336. In the embodiment shown in FIG. 13D, the shelf-life calculation page includes four sections: option selection 1358, input parameter 1360, output parameter 1362, and graph(s) 1364.

Using the option selection section 1358 of the page, the customer chooses the type of calculation to perform, either time to reach an oxygen exposure limit or oxygen exposure predicted at shelf life target 1320. If the customer chooses to calculate the time to reach an oxygen exposure limit, the customer enters information in the input parameter section 1360 and clicks the “Recalculate” button 1366. As a result, the web server 25 receives a request, including the initial headspace oxygen content 1322 and oxygen exposure limit 1324. Web server 25 calculates the transmission rate of the sections of the bottle 1354 and the entire package and the number of days to reach the oxygen exposure limit 1325. The estimated time to reach the oxygen exposure limit is provided to the customer in the output parameter section 1362, 1326.

If the customer instead chooses to calculate oxygen ingress for a given shelf life, the web server 25 receives initial headspace oxygen content 1328 and the shelf-life target 1330. In response, the web server 25 calculates the transmission rate of the package and estimates the oxygen exposure at the shelf-life target in parts per million (PPM) 1331. Web server 25 then provides the information in an HTML page 1332.

For either calculation, the oxygen ingress wizard may provide a graphical representation of the data in the graph section 1364, 1334. For example, in the embodiment shown in FIG. 13D, the web server 25 generates a line graph 1368 and a pie chart 1370. In line graph 1368, the oxygen exposure is shown as a function of time in days with oxygen exposure in PPM 1on the y-axis and time in days on the x-axis. In the embodiment shown, the range of the x-axis values is based either on the entered “Time in days” or the calculated time to reach the oxygen ingress limit. Also, in the embodiment shown in FIG. 13D, pie chart 1370 illustrates the percentage of oxygen transmission through various parts of bottle 1354. To display pie chart 1370, web server 25 calculates the oxygen transmission rate (TR) for each section of bottle 1354 based on the input received from the customer.

In another embodiment of this invention, the graph section 1364 includes two line graphs, one illustrating the effects of varying the Closure TR and the other illustrating the effects of varying the Base TR. In each graph, the oxygen exposure as a function of time in days using the parameters and bottle description input by the customer is displayed on both graphs with oxygen exposure in PPM on the y-axis and the time in days on the x-axis. On the first graph, two additional lines are (1) ingress results when the closure TR equals is zero and all other parameters remain unchanged from the customer-supplied input parameters; and (2) ingress results when the closure TR equals two times the closure TR corresponding to the closure type selected by the customer and all other parameters remain unchanged from the customer-supplied parameters. These additional two lines are only plotted when the closure TR corresponding to the closure type selected by the customer is not equal to zero, since all three lines are identical when the closure TR corresponding to the closure type selected by the customer is zero. The second graph also includes two additional lines: (1) ingress results when the base TR equals 0.75 times the base TR corresponding to the original bottle description and all other parameters remain unchanged from the customer-supplied parameters; and (2) ingress results when the base TR equals 1.25 time the base TR corresponding to the original bottle description and all other parameters remain unchanged from the customer-supplied parameters. The range of the x-axis values is based either on the entered “Time in days” or the calculated time to reach the oxygen ingress limit. In another embodiment of this invention, the graph section 1364 includes a table with transmission rate (TR) values for the individual bottle sections along with the % of the total transmission rate that the TR values for the sections represent. In the table, the oxygen transmission rate is calculated based on the customer-input values and selections. As part of its calculation procedures, the wizard performs consistency checks. For example, it will not continue if a customer attempts to specify a bottle with unrealistically low weight for its size.

The oxygen ingress wizard HTML page provided by web server 25 may include additional features as well. For example, the HTML page may include links to help pages, contact pages, disclaimer, policies, terms, and conditions pages. In addition, the HTML page may include standard navigational or other elements.

Anti-oxidant Wizard

Anti-oxidants are an effective means to prevent rancidity and improve shelf life in the fats and oils that are contained in many food products. In an embodiment of this invention, an anti-oxidant wizard helps a customer determine the amount of anti-oxidant necessary to achieve a desired level of anti-oxidant in a product.

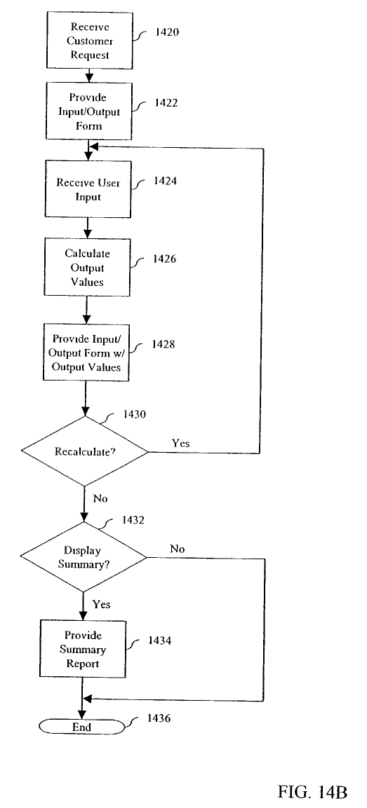

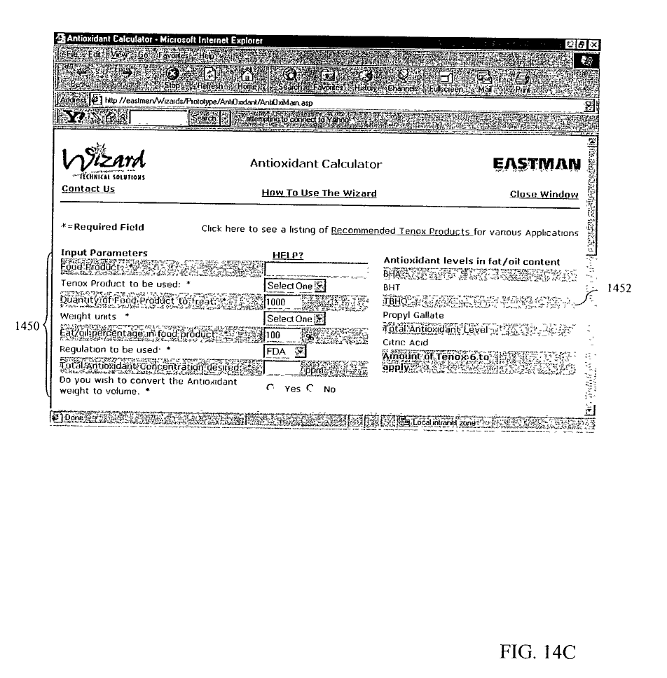

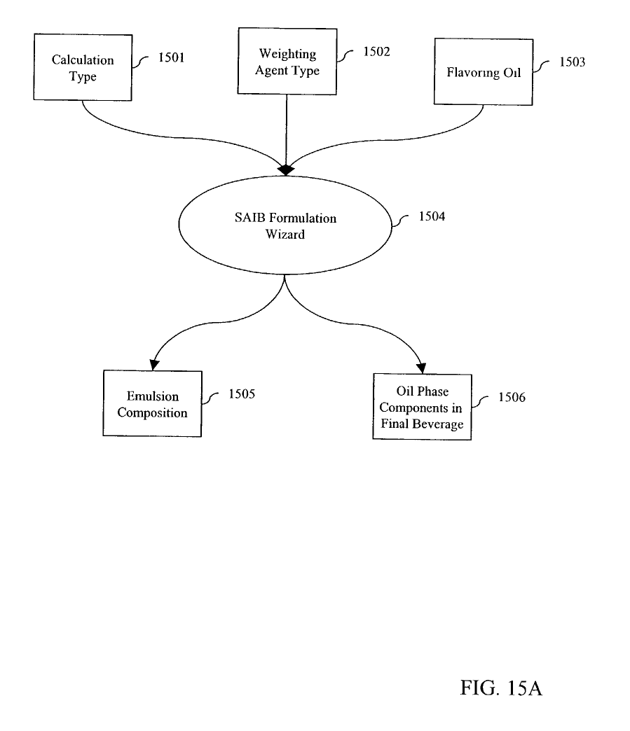

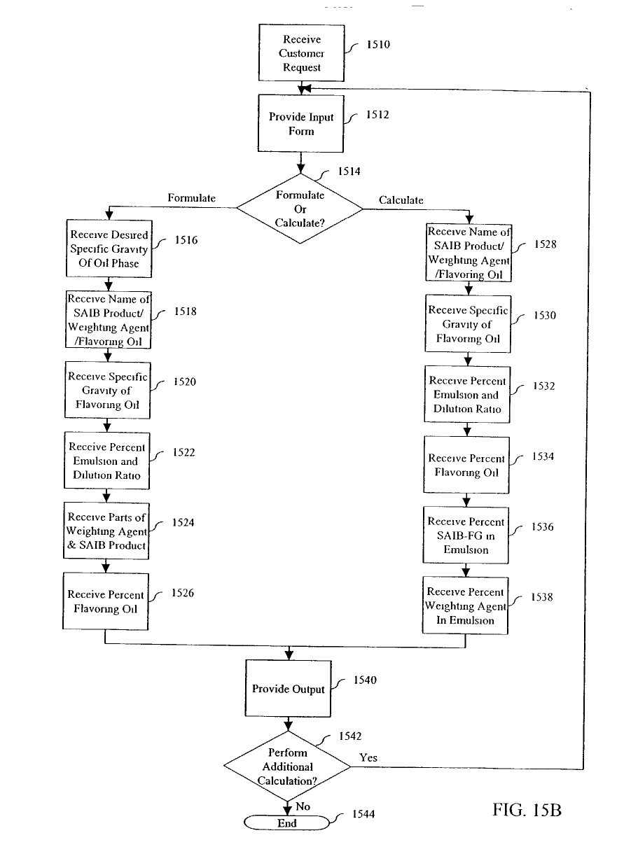

Referring to FIG. 14A, the anti-oxidant wizard receives various input parameters, including: food product type 1401, anti-oxidant solution 1402, quantity of food to treat 1403, and the weight unit, such as pounds or kilograms, percentage of fat/oil in the product 1405, regulation type 1406, such as FDA or USDA, and desired anti-oxidant concentration 1407. The anti-oxidant wizard includes a calculation algorithm 1408 that accepts these parameters and performs various calculations. The calculation algorithm 1408 provides as output the total anti-oxidant content 1409, the anti-oxidant level in fat/oil content 1410, and a citric acid measure 1411. The anti-oxidant level may reflect the level of various anti-oxidants, including, for example, tertiary butylhydroquinone (TBHQ), propyl gallate (PG), butylated hydroxyanisole (BHA), and butylated hydroxytoluene (BHT). These anti-oxidants may constitute a single product line from a chemical manufactures, such as the anti-oxidant product line marketed under the trade name Tenox®.

FIG. 14B is a flowchart illustrating the process carried out by an anti-oxidant wizard in an embodiment of this invention to accept input parameters and provide output. FIG. 14C is a screen shot of the input/output form. In an embodiment of this invention, the customer clicks on a link corresponding to the anti-oxidant wizard. Clicking on the link results in the generation of a HTTP request directed to the anti-oxidant wizard on the web server 25. Web server 25 receives the request 1420. In response, web server 25 provides the input/output form illustrated in FIG. 14C 1422.

Once the form is displayed, the customer has various options. In one embodiment of the present invention, the customer can (1) view suggested Tenox(t solutions, (2) view Tenox® anti-oxidants, (3) view cereals, confections and snack foods, (4) view vegetable oils, (5) view meat and poultry products, (6) view regulations applicable inside the United States, such as Food and Drug Administration (FDA) Title 21 regulations and United States Department of Agriculture (USDA) Title 9 regulations, (9) view regulations applicable outside the United States, and (10) view Tenox® product information.

Referring again to FIG. 14B, the customer enters a series of input parameters 1450, which are described above in relation to FIG. 14A, and clicks a calculate button (not shown) on the form shown in FIG. 14C. In the embodiment shown in FIG. 14C, all the input parameters are utilized in order to perform the calculation. Clicking the calculate button results in submitting the input parameters to the web server 25. The web server 25 receives the input parameters 1424 and calculates output values 1426, utilizing an anti-oxidant business object executing on MTS server 30. Web server 25 recreates the input/output form of FIG. 14C, including output parameters 1452, and provides the form to the customer 1428.

The customer may choose to recalculate the values 1430 one or more times. The customer may also choose to vary the process by, for example, requesting web server 25 to convert the weight displayed for the anti-oxidant to a volume. Once the customer has completed the iterative process of entering input values and receiving the results, the customer can optionally view a summary report. If web server 25 receives a request for a summary report 1432, web server 25 provides the summary report 1434. If no request is received, the process ends 1436.

If the customer has chosen to view the summary report, the customer can further download the results to a spreadsheet. Also, the wizard includes help screens, contact us links, and options to display disclaimer, policies, terms, and conditions.

SAIB Beverage Formulation Wizard

Beverage weighting agents are used to increase stability in beverages, such as citrus drinks and sports beverages. Without weighting agents, the beverages would tend to separate. Sucrose acetate isobutyrate (SAIB) is one such weighting agent used in both carbonated and non-carbonated citrus-flavored beverages. Examples of SAIB products or weighting agents include BVO, Damar Gum, Ester Gum, SAIB-FG, SAIB-FG CO and SAIB-FG ET-10. An embodiment of the present invention includes an SAIB beverage formulation wizard, which helps a customer formulate a beverage emulsion using SAIB.

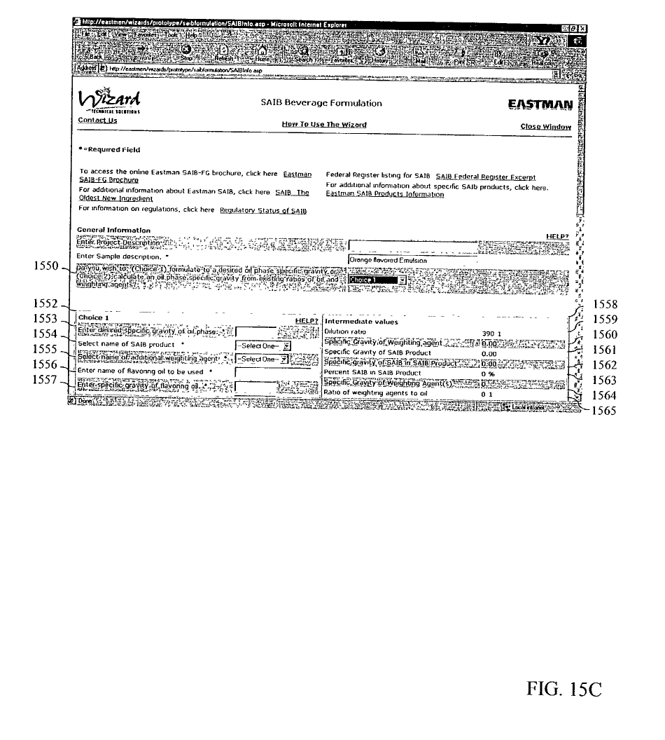

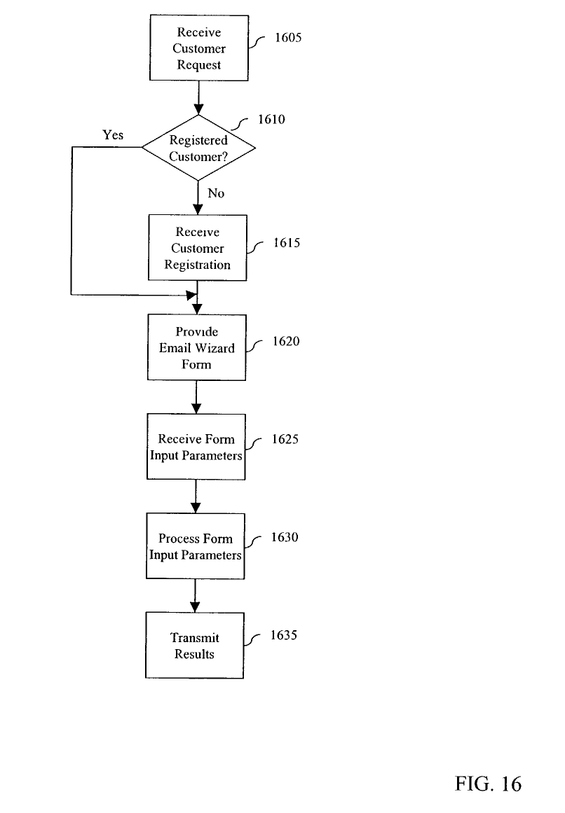

FIG. 15A is a block diagram illustrating the inputs and outputs of the SAIB wizard. A customer supplies a calculation type 1501. In one embodiment of this invention, the customer may choose from two calculation types: (1) formulate to a desired oil phase specific gravity; or (2) calculate an oil phase specific gravity from existing ratios of oil and weighting agents. The customer also supplies the weighting agent type 1502 and the flavoring oil to be used 1503. These input parameters are supplied to the SAIB formulation wizard algorithm 1504. The formulation wizard produces various outputs, which depend in part on the calculation type selected. These outputs include the emulsion composition 1505 and the oil phase components in the final beverage 1506.

FIG. 15B is a flowchart illustrating the process of a SAIB wizard in an embodiment of this invention. FIG. 15C is a screen shot of an SAIB wizard. In an embodiment of this invention, the customer clicks on a link corresponding to the SAIB wizard. Clicking on the link results in the generation of a HTTP request directed to the SAIB wizard on the web server 25. Web server 25 receives the request 1510. In response, web server 25 provides the input/output form illustrated in FIG. 15C 1512.

The input/output form shown in FIG. 15C includes a drop-down control 1550, which allows the customer to choose between (1) formulating to a desired oil phase specific gravity; or (2) calculating an oil phase specific gravity from existing ratios of oil and weighting agents 1514. The input parameter section of the form 1552 displays input fields according to the selection in drop-down control 1550.

For example, in one embodiment of this invention, if the customer chooses to formulate, the following input parameters 1552 are available: Desired specific gravity of oil phase 1553, Name of SAIB product 1554, Name of additional Weighting Agent 1555, Name of Flavoring Oil 1556, Specific gravity of Flavoring Oil 1557, Percent Emulsion desired in beverage (not shown), Desired dilution ratio (Emulsion to Beverage) (not shown), Parts of [Weighting Agent] (not shown), Parts of [SAIB product] (not shown), and Percent Flavoring Oil to be used (not shown). If the customer chooses to calculate, the following input parameters 1552 are available: Name of additional Weighting Agent (not shown), Name of Flavoring Oil (not shown), Specific gravity of Flavoring Oil (not shown), Percent Emulsion desired in beverage (not shown), Desired dilution ratio (Emulsion to Beverage) (not shown), Percent Flavoring Oil in emulsion to be used (not shown), Percent SAIB-FG in emulsion formulation (not shown), and Enter Percent Weighting Agent in emulsion formulation (not shown).

Referring again to FIG. 15B, the customer chooses to formulate or calculate and web server 25 receives the choice 1514. The customer is presented with the appropriate input parameters 1552. After the customer enters the parameters 1552, the customer clicks a “Calculate” button (not shown). If the customer chooses to formulate, web server 25 receives the desired specific gravity of oil phase 1516, the name of the SAIB product, weighting agent and/or flavoring oil 1518, the specific gravity of the flavoring oil 1520, the percent emulsion and dilution ration 1522, the parts of the weighting agent and of the SAIB product 1524 and the percent of flavoring oil 1526. Web server 25 performs a calculation and provides the customer with output 1540. For calculation purposes, the SAIB is based on the Pearson Square Method for Calculation of Beverages Formulations. The customer can calculate syrup composition and beverage dilution.

If the customer chooses to calculate, web server 25 receives the name of the SAIB product, weighting agent and/or flavoring oil 1528, the specific gravity of the flavoring oil 1530 the percent emulsion and dilution ration 1532, the percent of flavoring oil 1534, the percent SAIB-FG in the emulsion 1536, and the percent of the weighting agent in the emulsion 1538. Web server 25 performs the calculation and provides output 1540. Web server 25 may repeat the input and calculation process multiple times 1542 before the process ends 1544.

The outputs provided by web server 25 in an embodiment of this invention may Include intermediate values 1558. Intermediate values include dilution ration 1559, the specific gravity of the weighing agent 1560, the specific gravity of SAIB product 1561, the specific gravity of SAIB in the SAIB product 1562, the percent of SAIB in the SAIB product 1563, the specific gravity of the weigting agent(s) 1564, and the ration of the weighting agents to oil 1565.

In another embodiment of this invention, outputs include the calculated oil phase composition, prepared oil phase, and the prepared emulsion. The outputs may also include the percent composition of emulsion and PPM oil phase components in final beverage. These outputs may be displayed as part of the input/output from shown in FIG. 15C or may be included in a Composition and Preparation Summary report (not shown). Additional input parameters may be received as well, including, for example, weight of the emulsion to make, the DSS desired, the type of emulsifier to use, the desired emulsifier, preservative, and acidulant concentrations.

In an embodiment of this invention, the wizard provides a facility to print the output values. The wizard also provides a facility to download the results in a spreadsheet format. The wizard may include help screens, contact us links, and options to display disclaimer, policies, terms, and conditions.

Email Version of Wizards

Embodiments of this invention may include various types of applications to implement a particular wizard. For example, an embodiment may include an email version of a wizard. An email wizard collects information from the customer and transmits that information to an email server (not shown) in the internal network 45.

FIG. 16 is a flow chart illustrating the process of an email version of a wizard in an embodiment of this invention. In the embodiment shown, the customer accesses an HTML page on the customer's computer 5 and sends a request to web server 25 for the email version of a wizard. Web server 25 receives the request 1605 and determines whether or not the customer is a registered customer 1610. If the customer has previously registered, the email wizard automatically retrieves preference and contact information from SQL Server 35 and continues the process illustrated in FIG. 16. If the customer has not previously registered, the form receives registration information from the customer 1615.

In an email version of a wizard, once web server 25 has received or retrieved customer registration information, web server 25 provides the customer with an HTML form that serves as a structured email template 1620. The HTML form includes various controls corresponding to information, which is relevant to the specific wizard. The customer enters the various parameters and submits the form to web server 25. Web server 25 receives the input parameters 1625 and processes them in accordance with the wizard.

Processing of the input parameters may include both automated and manual processes. For example, the email may be directed to a technical support representative who is responsible to responding to requests related to a particular wizard. Another wizard may handle the email in a completely automated manner. Once the processing, which may be automated, manual, or both, is complete 1630, web server 25, or another computer, transmits the results to the customer 1635. The transmission of the results may occur via return email, fax, or other transmission media as specified by the customer.

Solvent Reformulation

In an embodiment of the present invention, a solvent reformulation wizard assists a customer formulator in analyzing present solvent blends, reformulating existing solvent systems and/or developing new solvent blends for their products. The wizard finds the optimum and lowest cost solvent blend that meets the utilizements of the formulator.

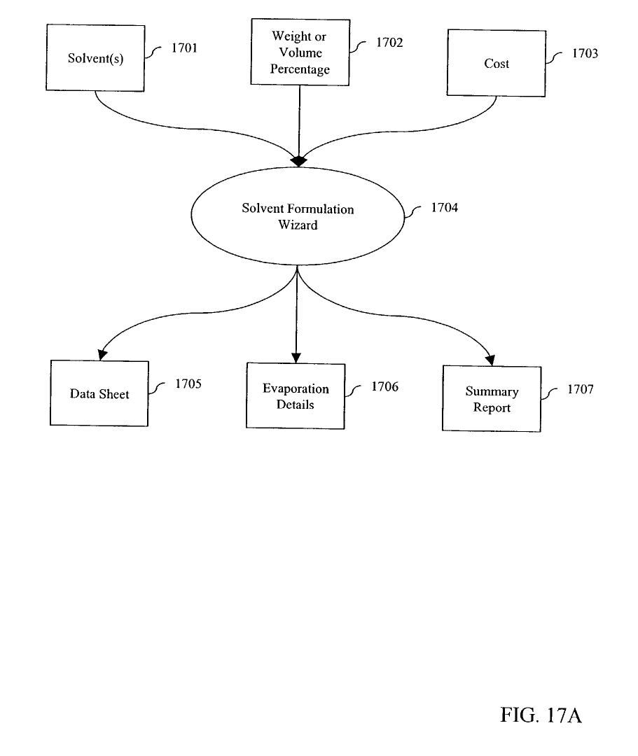

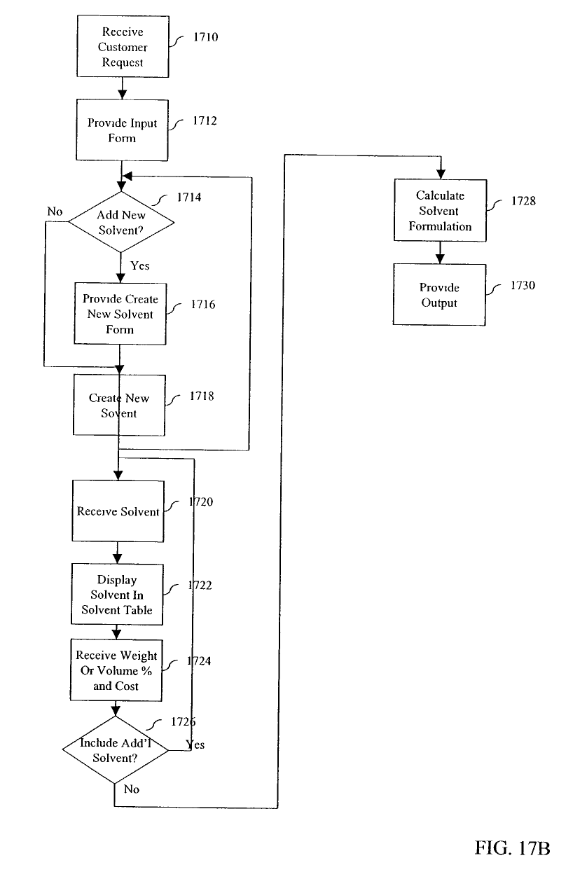

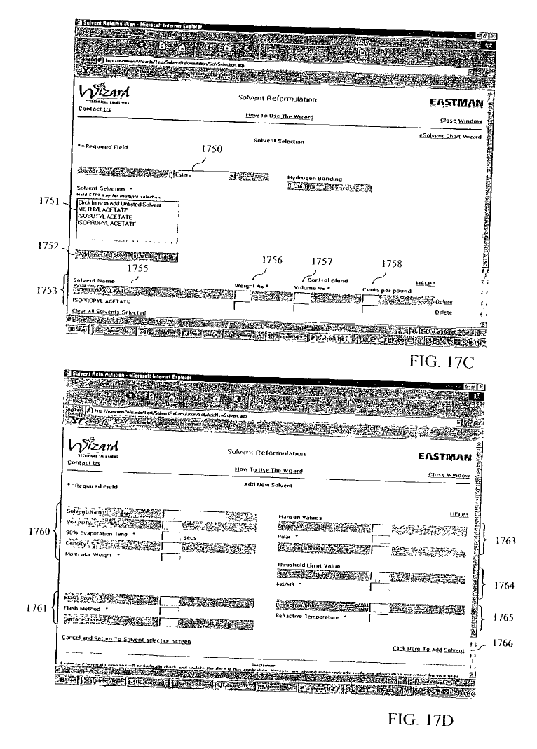

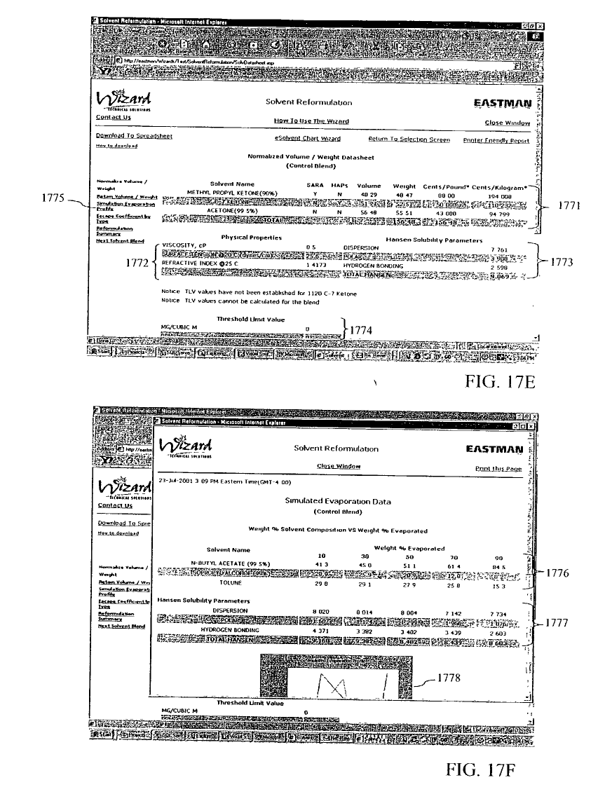

FIG. 17A is a block diagram illustrating the inputs and outputs of a solvent reformulation wizard in an embodiment of this invention. A formulator specifies a solvent or solvents 1701. The formulator also enters the weight or volume percentage of the solvent in the blend 1702. The formulator also specifies the cost of the solvent or solvents 1703. The solvent formulation wizard calculation algorithm 1704 uses these input parameters to generate a set of outputs. The outputs include a solvent data sheet 1705, evaporation details 1706, and a summary report 1707.

FIG. 17B is a flowchart illustrating a process in a solvent reformulation wizard in an embodiment of this invention. FIGS. 17C-F are screen shots of the input and output forms in a solvent reformulation wizard. In an embodiment of this invention, the customer clicks on a link corresponding to the solvent reformulation wizard. Clicking on the link results in the generation of a HTTP request directed to the solvent reformulation wizard on the web server 25. Web server 25 receives the request 1710. In response, web server 25 provides the input/output form illustrated in FIG. 15C 1712.

The customer describes a blend by listing solvents in the blend. In the embodiment shown in FIG. 17C, the customer begins by selecting a solvent group 1750. If a solvent does not exist in the list of solvents 1751 for a solvent group 1750, the customer can choose to create a new solvent 1714. If the customer chooses to add a new solvent, clicks the “Click here to add Unlisted Solvent” entry in the solvent list 1751. In response, web server 25 provides the customer with the Create New Solvent form illustrated in FIG. 17D 1716.

The customer enters all of the necessary parameters and submits the form to web server 25. In the embodiment shown, the customer enters basic properties of the solvent, including the solvent name, viscosity, evaporation time (90%), density, and molecular weight 1760. The customer also enters the solvent flash point, flash method, and surface tension 1761. The customer enters Hansen 1763 and threshold limit values 1764. The Hansen values 1763 include dispersion, polar, and hydrogen bonding. The threshold limit values 1764 include parts per million (PPM) and milligrams per cubic meter (MG/M3). In addition, the customer enters the refractive index and temperature 1765. Once the customer has entered values for the fields shown in FIG. 17D, the customer clicks a “Click Here to Add Solvent” link 1766. Web server 25 receives the variables from the HTML form and executes the code necessary to create the new solvent 1718. The customer can repeat steps 1714 through 1718 until all necessary solvents have been added to the solvent list 1751.

Once the solvent list 1751 includes all of the solvents necessary for the customer to describe a blend, the customer highlights the appropriate solvent or solvents in the solvent list 1751 and clicks the “Add Selected Solvent” button 1752. Clicking the button 1752 causes the application to receive the solvent 1720 and to recreate the solvent table 1753 with the additional solvent 1722. In the screen shot illustrated in FIG. 17C, the customer has added two solvents 1755 to the blend displayed in the solvent table 1754. The customer next enters either the weight 1756 or volume percentage 1757 and cost 1758 for the solvent 1724. The customer continues the process of adding additional solvents 1726 until the blend is accurately reflected. Generally the total number of solvents in the blend does not exceed 20. In an embodiment of this invention, the customer may create multiple blends for comparison purposes, including a control blend.

Once the customer has entered a blend, the reformulation wizard calculates the solvent formulation properties 1728 and provides output 1730, such as the output illustrated in FIGS. 17E and 17F. FIG. 17E is a screen shot illustrating a Normalized Weight/Volume Datasheet, which includes detailed information regarding the blend entered by the customer. In the embodiment shown, the data sheet includes a solvent list 1771 with information specific to each solvent, including volume, weight, and cost. The datasheet also includes the physical properties 1772, Hansen solubility parameters 1773, and threshold limit values 1774 for the blend. In addition, the datasheet includes links to various other reports and datasheets, including a link to a Simulation Evaporation Provide 1775.

When a customer clicks on the Simulation Evaporation Profile link 1775, the Simulation Evaporation Datasheet screen shown in FIG. 17F is displayed. The datasheet includes tabular and graphical evaporation information regarding the blend entered by the customer. The tabular data includes weight percent evaporated 1776 and Hansen solubility parameters 1777. The datasheet also includes a graph of the simulation evaporation profile 1778.

In an embodiment of the this invention, the customer selection solvents and determines parameters of the blend by utilizing detailed information such as a normalized blend report simulated evaporation profile in tabular and graphical form, and escape coefficients, as well as summarized reports. Reports may include information for all blends entered by a customer so that the customer can perform comparisons among the blends.

In determining the parameters of a blend section in an embodiment of this invention, the customer performs manipulations like changing the weight or volume percentages or concentrations and changing the price of solvents. The customer may also normalize the blend based on weight or volume concentration and view and print the data sheet.

The wizard includes help screens, contact us links, and options to display disclaimer, policies, terms, and conditions.

Coextrusion Wizard

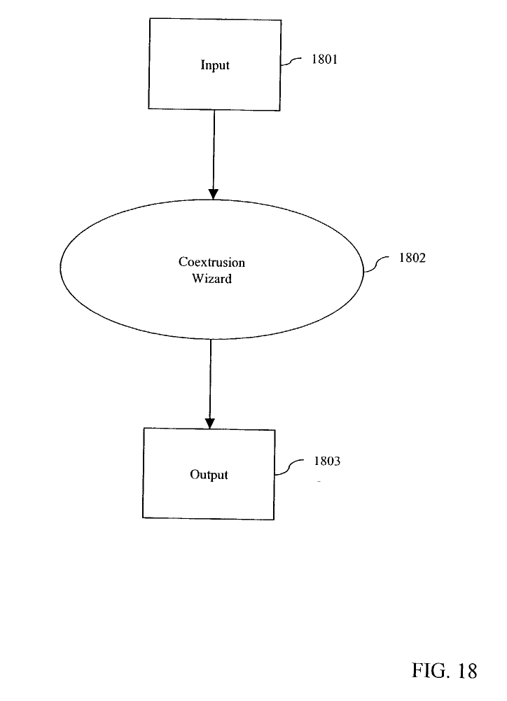

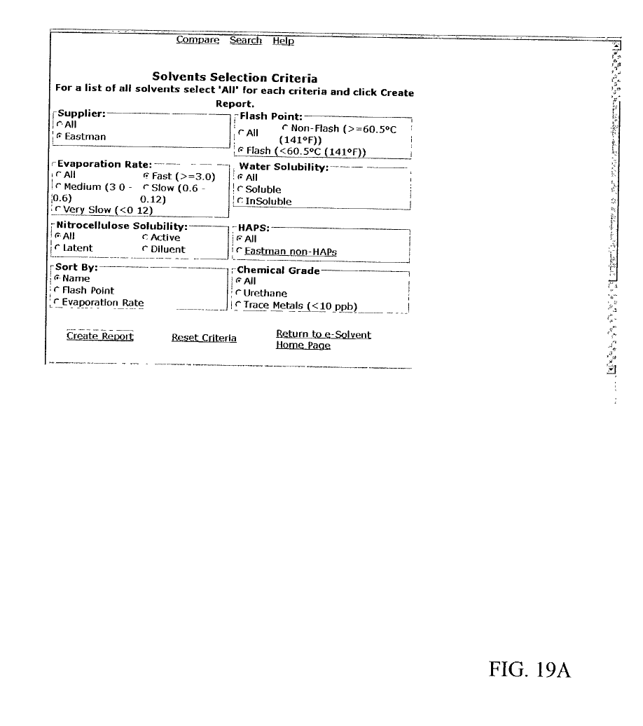

An embodiment of this invention includes a coextrusion wizard. A coextrusion wizard assists a customer in the development of coextruded structures with good material distribution and minimal flow defects. FIG. 18 is a block diagram illustrating a coextrusion wizard in an embodiment of this invention. The wizard accepts inputs 1801, performs calculations in the wizard algorithm 1802, and provides outputs 1803. A customer specifies the number of layers, the desired resins, their structure percentages and melt temperatures, and the wizard calculates and presents a graphic representation of how the proposed material is distributed in a coextruded structure.

e-Solvents Chart®

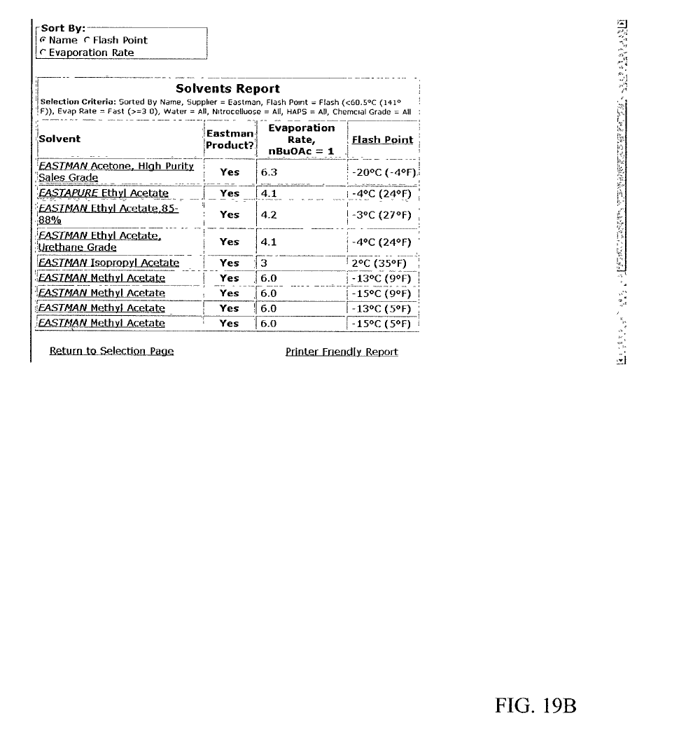

In an embodiment of this invention, an e-Solvents Chart® program provides pertinent technical and regulatory information for solvents, including their compatibility with specific resins. The e-Solvents Chart® program provides physical and engineering properties for solvents and allows a customer to compare the attributes of one or more solvents and resins and obtain a resin solubility chart for various resins. The e-Solvents Chart® includes resin solubility for many resins and physical and engineering properties for a large number of solvents. A range of criteria is offered in searching for solvents, and the results can be easily printed if so desired. FIGS. 19A and 19B are screenshots of an e-Solvents Chart® in an embodiment of this invention.

In an embodiment of this invention, the e-Solvent Chart(® includes a solvents section. The solvents selection provides the customer with a variety of available search criteria. The customer enters search criteria and the e-Solvent Chart® produces a “Solvents Report.” The report may be sorted by various solvent properties, including, for example, Solvent Name, Evaporation Rate, and/or Flash Point.

The e-Solvent Chart® may also include a properties section. The properties section displays either all properties for a particular solvent or to view all solvents for a particular property. The chart may also include a resin solubility section, allowing the customer produce a “Resin Solubility Report” for all solvents based on a specified resin. The report may be sorted by various resin and solvent properties, including, for example, Solvent Name, Viscosity, and/or Evaporation Rate.

In another embodiment of this invention, the e-Solvents Chart® includes a solvent compare section, which displays a “Solvents Comparison Report” listing all properties for multiple solvents. The chart may also include a resin compare section, to display a “Resins Comparison Report” listing all solvents for multiple resins.

In various embodiments of this invention, the e-Solvents Chart® includes additional utilities to assist the customer in utilizing the chart. For example, in one embodiment, the e-Solvents Chart® includes a search utility. The search utility enables a customer to search for solvents based on a selected property and/or a given range of values or an exact value for the property. The customer can also view all properties for a particular solvent by searching with a known CAS number. The e-Solvents Chart® may also include a help section, including general information regarding terms utilized in the chart, further explanation of properties, and other areas of interest such as; a listing of Resin Suppliers and a Coatings Dictionary

Coolant Flow-rate Calculator Wizard

The Coolant Flow-Rate Calculator Wizard calculates the minimum water flow rate needed to achieve turbulent flow. Mold temperature can influence the overall cycle, shrinkage, warpage, crystallinity, and other characteristics of a molded part. Amorphous Eastman polymers utilize colder molds than some other plastics, therefore proper attention to cooling is critical. After the mold is designed and constructed, one may insure that adequate turbulent flow is provided for the cooling channels. Turbulent coolant flow ensures optimum heat transfer as it allows more of the coolant to be exposed to the core and cavity channels. This wizard was developed to assist users in determining what minimum water flow rate is necessary for various cooling channel configurations.

In this wizard, the user can choose from the following three cooling component types channel, baffles, or bubblers. Channel type cooling components are conventional drilled cool it, channels, baffle type cooling components are standard blade type baffles that are typically utilized in an array to cool relatively large cores, and bubbler type cooling components are standard bubblers that are typically utilized to cool tall standing core details. The wizard allows a user to select one of these three cooling component types and then select a particular diameter drill size for that component via a pull-down list. The wizard then calculates the minimum water flow rate needed to achieve turbulent flow and displays the data to the user in tabular form.

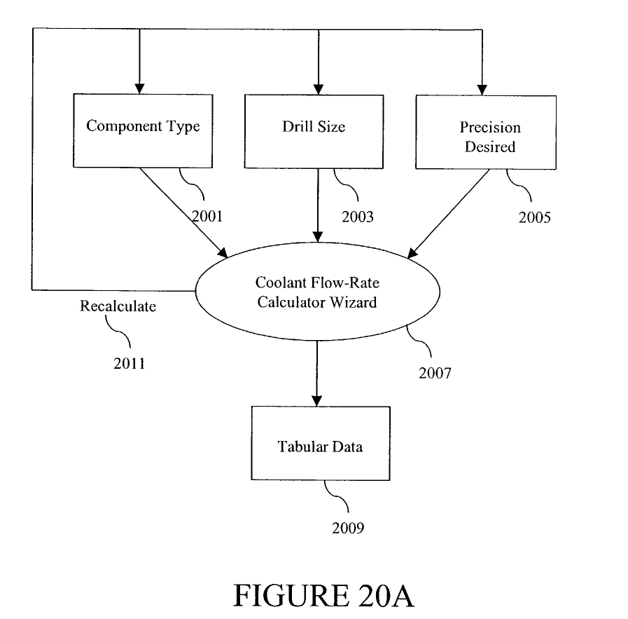

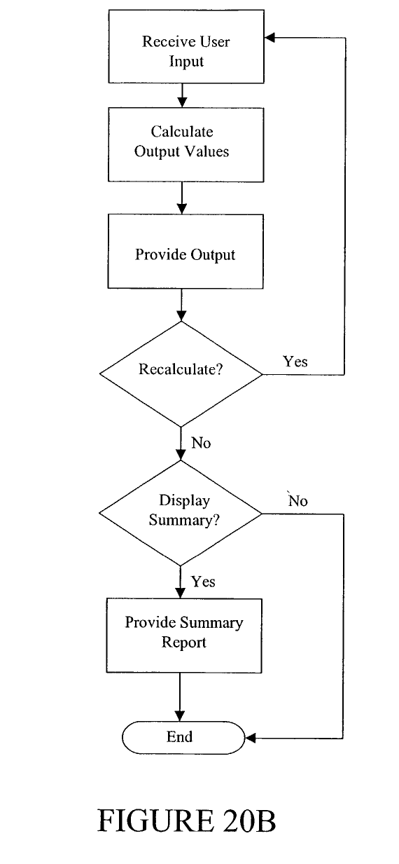

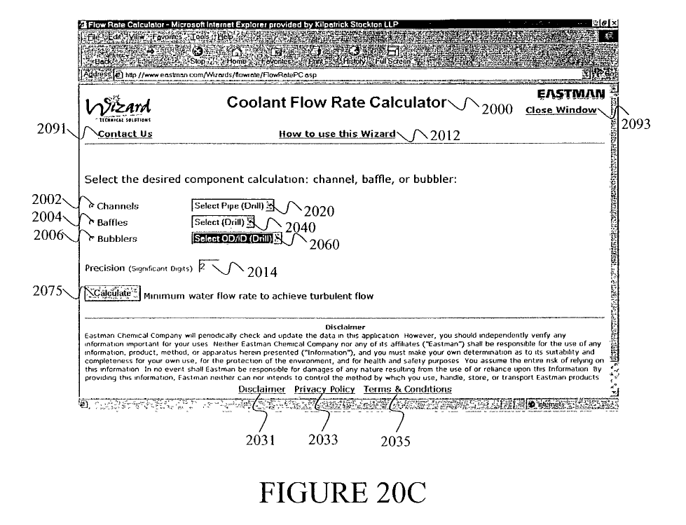

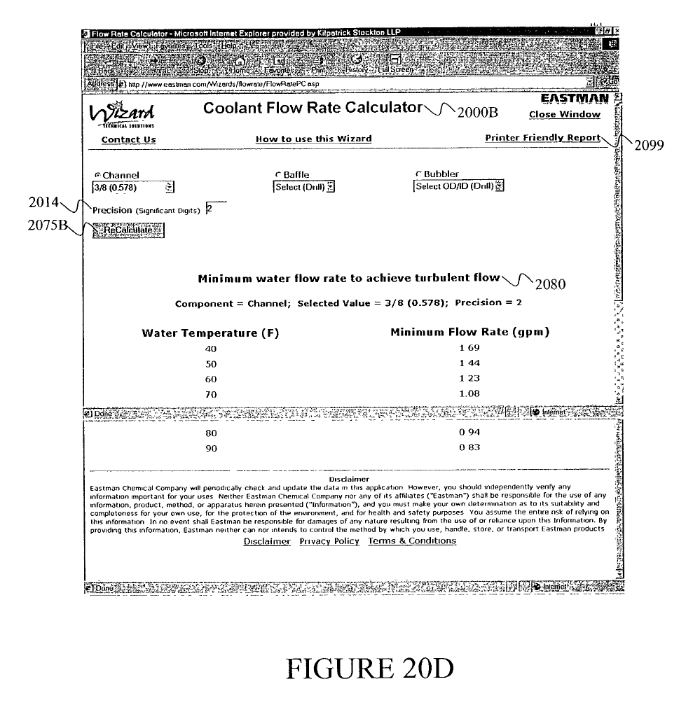

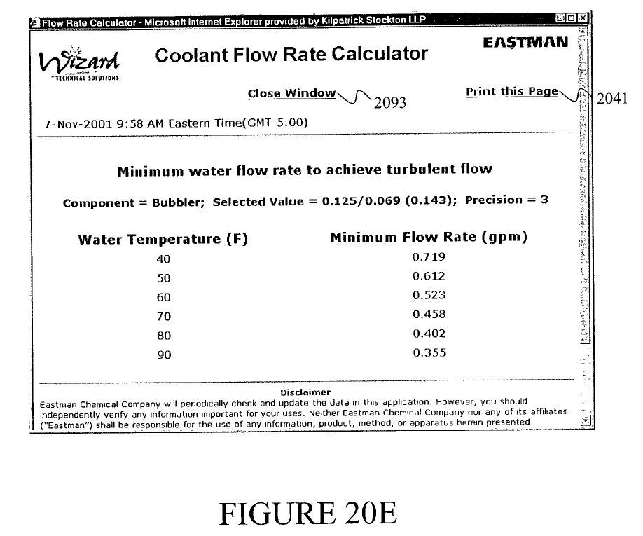

FIG. 20A is a block diagram illustrating the inputs and outputs of the Coolant Flow-Rate Calculator Wizard. In one embodiment of this wizard, a user inputs the component type 2001, drill size 2003, and precision desired 2005. The wizard then calculates the minimum water flow rate that is needed to achieve turbulent flow 2007 and outputs this information in the form of tabular data 2009. The user is given the opportunity to change any input and have the wizard recalculate 2011 the minimum water flow rate that is needed to achieve turbulent flow for the new input.

FIG. 20B is a flow diagram illustrating the process carried out by one embodiment of the Coolant Flow-Rate Calculator Wizard. Now with reference to FIGS. 20C-20E, if a user is visiting this wizard for the first time, they may click on the “How To Use The Wizard” button 2012 and the system will display detailed instructions about this wizard. Also, at any time, a user can contact the website host by clicking on the “Contact Us” button 2091, or close the current window by clicking on the “Close Window” button 2093.

To begin the coolant flow rate calculation, at the Coolant Flow Rate Calculator page 2000 shown in FIG. 20C, the wizard accepts input from a user regarding the desired component calculation: channels 2002, baffles 2004, or bubblers 2006. Only one of these components may be selected at a time. If channels are selected, the wizard provides a pull-down list 2020 from which a user may select the proper channel diameter drill size, in inches. If baffles are selected, the wizard provides a pull-down list 2040 from which a user may select the proper baffle bore diameter drill size, in inches. If bubblers are selected, the wizard provides a pull-down list 2060 from which a user may select the correct bubbler configuration, in inches. The “OD/ID” referred to in pull-down list 2060 refers to the bubbler tube annular cross section, and “Drill” refers to the actual bubbler bore drilled in the tool steel, all in inches.

Once the user has made their selections, they can simply click on the “Calculate” button 2075 and the wizard will automatically calculate the minimum water flow rate that is needed to achieve turbulent flow in that system. The wizard will then display its calculated values in tabular form 2080 in a new window, as shown in FIG. 20D. The flow rate will be calculated in gallons per minute (gpm) for water temperatures ranging from 40-90° F. in 10-degree increments The default precision 2014 is 2 decimal places, but the user may select another precision if they so desire.

If necessary, a user can click on the “Recalculate” button 2075B after modifying their original inputs to have the wizard calculate the minimum water flow rate that is needed to achieve turbulent flow for another selection. Users may also click on the “Printer Friendly Report” button 2099 and a new window will open and display the input and results in one printable window, as shown in FIG. 20E. A user may then print this consolidated report by clicking on the “Print the Page” button 2041. Once finished, the user may click on the “Close Window” button 2093 to be returned to the Coolant Flow Rate Calculator page 2000B shown in FIG. 20D.

As with the other wizards of the present invention, users can access additional information about the owner's policies by clicking on “Disclaimer” button 2031, “Privacy Policy” button 2033, and “Terms & Conditions” button 2035. When a users clicks on any of these buttons, a new window will appear and display the relevant information.

Although the invention has been described with reference to these preferred embodiments and features, other similar embodiments and features can achieve the same results. Variations and modifications of the present invention will be apparent to one skilled in the art and the present disclosure is intended to cover all such modifications and equivalents.

1. A system for processing input data to generate output data comprising:
an input module operable for accepting input;
a processing module; and
a output module operable for outputting output data to a user,
wherein the output data comprises data relating to a chemical product, function or service.

2. A method for generating output data useful for a specific purpose comprising:
inputting data into a processing module; and
processing the input data to generate output data,
wherein the output data comprises data relating to a chemical product, function or service.

3. A computer-readable medium containing computer-executable instructions for processing data comprising:
computer program code for receiving input data from a user;
computer program code for processing said input data and generating output data;
wherein the output data comprises data relating to a chemical product, function or service.

4. The system of claim 1 for facilitating the calculation of resins for coatings, inks and adhesives applications, said processing module comprising:
a processing module operable for calculating a reactor charge and theoretical resin properties based on the input, wherein the processing module is also operable for generating output data about the reactor charge and the theoretical resin properties; and
said output module comprising a display module operable for displaying the output data to a user.

5. The system of claim 4 wherein the input data comprises at least a raw material selection and certain resin parameters.

6. The system of claim 5 wherein the certain resin parameters comprises at least a plurality of a name of a monomer, a molecular weight of the monomer, a number of acid functional groups on the monomer, a number of hydroxyl functional groups on the monomer, a condensate from the acid, a condensate from the hydroxyl, a weight fraction monomer in the resin, a weight fraction moiety in the monomer and/or a raw material cost.

7. The system of claim 5 wherein said output data comprises a tabular process log of the reactor charge's polymerization.

8. The system of claim 5 wherein said output data comprises a graphical representation of the reactor charge's polymerization.

9. The system of claim 4 wherein the user accesses said system via the Internet.

10. The method of claim 2 for facilitating the calculation of resins for coatings, inks and adhesives applications comprising:
inputting information about a material;
calculating a reactor charge and predicting properties of a resin based on the information; and
displaying the reactor charge and the predicted properties of the resin to the user.

11. The method of claim 10 wherein the information comprises at least a raw material selection and certain resin parameters.

12. The method of claim 11 wherein the certain resin parameters comprises at least a plurality of a name of a monomer, a molecular weight of the monomer, a number of acid functional groups on the monomer, a number of hydroxyl functional groups on the monomer, a condensate from the acid, a condensate from the hydroxyl, a weight fraction monomer in the resin, a weight fraction moiety in the monomer, and/or a raw material cost.

13. The computer-readable medium of claim 3 for facilitating the generation of resins for coatings, inks and adhesives applications comprising:
computer program code for receiving input from a user via the Internet;
computer program code for calculating a reactor charge and predicting properties of a resin based on the input from the user;
computer program code for displaying the reactor charge and the predicted properties of the resin to the user.

14. The system of claim 1 for predicting the standard adhesive properties for a component blend, said processing module comprising:
a processing module operable for calculating standard adhesive properties of at least one component blend based on the input, wherein the processing module is also operable for generating output data about the standard adhesive properties of the at least one component blend; and
said output module comprising a display module operable for displaying the output data to a user.

15. The system of claim 14 wherein said input comprises a formulation of at least one component blend.

16. The system of claim 14 wherein said standard adhesive properties comprise at least one of 180-peel strength, PolyKen tack, rolling ball tack, quick stick, room temperature hold power, and shear adhesive failure temperature.

17. The system of claim 15 wherein said output data comprises tabular data of the standard adhesive properties of the at least one component blend.

18. The system of claim 14 wherein said output data comprises at least one graphical representation of the standard adhesive properties of the at least one component blend.

19. The system of claim 14 wherein the user accesses said system via the Internet.

20. The method of claim 2 for predicting the standard adhesive properties for a component blend comprising:
inputting information about a component blend;
calculating at least one standard adhesive property of the component blend based on the information; and
displaying the at least one standard adhesive property of the component blend to the user.

21. The method of claim 20 wherein the information comprises a formulation of at least one component blend.

22. The computer-readable medium of claim 3 for predicting the standard adhesive properties for a component blend comprising:
computer program code for receiving input from a user via the Internet;
computer program code for calculating at least one standard adhesive property of the component blend based on the input from the user;
computer program code for displaying the at least one standard adhesive property of the component blend to the user.

23. The system of claim 1 for predicting the intrinsic viscosity degradation of a material, said processing module comprising:
a processing module operable for using the input to calculate a predicted intrinsic viscosity of a material after each pass through an extruder, wherein the processing module is also operable for generating output data about the predicted intrinsic viscosity of the material; and
said output module comprising a display module operable for displaying the output data to a user.

24. The system of claim 23 wherein the input comprises at least a virgin resin intrinsic viscosity, a pellet feed temperature, a melt temperature, a virgin resin moisture content, a regrind ratio, and a regrind moisture.

25. The system of claim 23 wherein said output data comprises a graphical representation of at least one of the following: regrind effect; virgin resin intrinsic viscosity effect; melt temperature effect; feed temperature effect; passes graph; regrind moisture effect; and virgin resin moisture effect.

26. The system of claim 23 wherein said output data comprises a tabular representation of the predicted intrinsic viscosity of the material after each pass through the extruder.

27. The system of claim 23 wherein the user accesses said system via the Internet.

28. The method of claim 2 for predicting the intrinsic viscosity degradation of a material comprising:
inputting information about a material;
calculating a predicted intrinsic viscosity of the material after each pass through an extruder based on said information; and
displaying the predicted intrinsic viscosity of the material after each pass through the extruder to the user.

29. The method of claim 28 wherein said information comprises at least a virgin resin intrinsic viscosity, a pellet feed temperature, a melt temperature, a virgin resin moisture content, a regrind ratio, and a regrind moisture.

30. The computer-readable medium of claim 3 for predicting the intrinsic viscosity degradation of a material comprising:
computer program code for receiving input from a user via the Internet;
computer program code for calculating a predicted intrinsic viscosity of a material after each pass through an extruder based on the input from the user;
computer program code for displaying the predicted intrinsic viscosity of the material after each pass through the extruder to the user.

31. The system of claim 1 for estimating the part costs of an injection molded material, said processing module comprising:
a processing module operable for calculating an estimated part cost based on the input, wherein the processing module is also operable for generating output data about the estimated part cost; and
said output module comprising a display module operable for displaying the output data to a user.

32. The system of claim 31 wherein said input comprises at least a part mass, a runner mass, a material cost, a number of cavities, an estimated cycle time, a reject rate, a percent of rejects reground, an equipment cost, an equipment amortization time, a mold cost, a mold amortization time, a number of operating hours per week, a project downtime, a machine cost, a secondary operations cost, an overhead expenses cost, and a miscellaneous expenses cost.

33. The system of claim 32 wherein said output data comprises tabular data of the estimated part cost.

34. The system of claim 31 wherein said output data comprises at least one graphical representation of the estimated part cost.

35. The system of claim 31 wherein the user accesses said system via the Internet.

36. The method claim 2 for estimating the part costs of an injection molded material comprising:
inputting information about a part;
calculating an estimated part cost based on said information; and
displaying the estimated part cost to the user.

37. The method of claim 36 wherein said information comprises at least a part mass, a runner mass, a material cost, a number of cavities, an estimated cycle time, a reject rate, a percent of rejects reground, an equipment cost, an equipment amortization time, a mold cost, a mold amortization time, a number of operating hours per week, a project downtime, a machine cost, a secondary operations cost, an overhead expenses cost, and a miscellaneous expenses cost.

38. The computer-readable medium of claim 3 for estimating the part costs of an injection molded material comprising:
computer program code for receiving input from a user via a website;
computer program code for calculating an estimated part cost of an injection molded material based on the input from the user;
computer program code for displaying the estimated part cost to a user.

39. The system of claim 1 for calculating the melt viscosity of a material, said processing module comprising:
a processing module operable for calculating a melt viscosity of a material based on the input, wherein the processing module is also operable for generating output data about the melt viscosity of the material; and
and said output module comprising a display module operable for displaying the output data to a user.

40. The system of claim 39 wherein said input comprises at least an intrinsic viscosity of the material and at least one temperature.

41. The system of claim 40 wherein said output data comprises tabular data of the melt viscosity of the material.

42. The system of claim 40 wherein said output data comprises at least one graphical representation of the melt viscosity of the material.

43. The system of claim 39 wherein the user accesses said system via the Internet.

44. The method of claim 2 for calculating the melt viscosity of a material comprising:
inputting information about a material;
calculating a melt viscosity of the material based on the information; and
displaying the melt viscosity of the material to the user.

45. The method of claim 44 wherein the information comprises at least an intrinsic viscosity of the material and at least one temperature.

46. The computer-readable medium of claim 3 for calculating the melt viscosity of a material comprising:
computer program code for receiving input from a user via the Internet;
computer program code for calculating a melt viscosity of a material based on the input from the user;
computer program code for displaying the melt viscosity of the material to the user.

47. The system of claim 1 for calculating the theoretical strain that occurs when a snap-fit latch is deflected, said processing module comprising:
a processing module operable for calculating a theoretical strain of a snap-fit latch based on the input, wherein the processing module is also operable for generating output data about the theoretical strain of the snap-fit latch; and
and said output module comprising a display module operable for displaying the output data to a user.

48. The system of claim 47 wherein the input comprises at least a material, a brand, and snap-fit latch dimensions.

49. The system of claim 48 wherein said output data comprises tabular data of the theoretical strain of the snap-fit latch.

50. The system of claim 47 wherein the user accesses said system via the Internet.

51. The method of claim 2 for calculating the theoretical strain that occurs when a snap-fit latch is deflected comprising:
inputting information about a snap-fit latch;
calculating a theoretical strain of the snap-fit latch based on the information; and
displaying the theoretical strain of the snap-fit latch to the user.

52. The method of claim 51 wherein the information comprises at least a material, a brand, and snap-fit latch dimensions.

53. The computer-readable medium of claim 3 for calculating the theoretical strain that occurs when a snap-fit latch is deflected comprising:
computer program code for receiving input from a user via the Internet;
computer program code for calculating the theoretical strain that occurs when a snap-fit latch is deflected based on the input from the user;
computer program code for displaying the theoretical strain of the snap-fit latch to the user.

54. The system of claim 1 for calculating the minimum coolant flow rate that is needed to achieve turbulent flow in a component, said processing module comprising:
a processing module operable for calculating a minimum coolant flow rate based on the input, wherein the processing module is also operable for generating output data about the calculated minimum coolant flow rate; and
and said output module comprising a display module operable for displaying the output data to a user.

55. The system of claim 54 wherein said input comprises at least a component type and a drill size.

56. The system of claim 55 wherein said output data comprises tabular data of the calculated minimum coolant flow rate.

57. The system of claim 54 wherein the user accesses said system via the Internet.

58. The method of claim 2 for calculating the minimum coolant flow rate that is needed to achieve turbulent flow in a component comprising:
inputting information about a component;
calculating a minimum coolant flow rate based on the input; and
displaying the minimum coolant flow rate to the user.

59. The method of claim 58 wherein the information comprises at least a component type and a drill size.

60. The computer-readable medium of claim 3 for calculating the minimum coolant flow rate that is needed to achieve turbulent flow in a component comprising:
computer program code for receiving input from a user via the Internet;
computer program code for calculating a minimum coolant flow rate that is needed to achieve turbulent flow in a component based on the input from the user;
computer program code for displaying the minimum coolant flow rate that is needed to achieve turbulent flow in the component to the user.

61. The system of claim 1 comprising:
an oxygen ingress input;
an oxygen ingress calculation algorithm processing module; and.
an oxygen ingress output display.

62. The system of claim 61, wherein said oxygen ingress input comprises a dimension of a container.

63. The system of claim 62, wherein said container comprises a Polyethylene Terephthalate bottle.

64. The system of claim 61, wherein said oxygen ingress input comprises at least one of a container type, an oxygen transmission detail, an initial container oxygen content, an oxygen exposure limit, and/or a time to reach an oxygen exposure limit.

65. The system of claim 61, wherein oxygen ingress output display comprises at least one of an oxygen ingress for a specified shelf life; a container image; a transmission rate; an oxygen exposure limit; and/or a graph.

66. The method of claim 2 comprising:
accepting an oxygen ingress input;
performing an oxygen ingress calculation with said oxygen ingress input; and
providing an output from said oxygen ingress calculation.

67. The method of claim 66, wherein said oxygen ingress input comprises a dimension of a container.

68. The method of claim 67, wherein said container comprises a Polyethylene Terephthalate bottle.

69. The method of claim 66, wherein said oxygen ingress input comprises at least one of a container type; an oxygen transmission detail; an initial container oxygen content; an oxygen exposure limit; a time to reach an oxygen exposure limit; and/or an oxygen ingress for a specified shelf life.

70. The method of claim 66, wherein said oxygen ingress output comprises at least one of a container image; a transmission rate; an oxygen exposure limit and/or a graph.

71. The system of claim 1 comprising:
an inhibitor recommendation input;
an inhibitor recommendation calculation algorithm processing module; and.
an inhibitor recommendation output display.

71. The system of claim 71, wherein said inhibitor recommendation input comprises at least one of a performance characteristic; an importance rating of said performance characteristic.

72. The system of claim 71, wherein said inhibitor recommendation calculation algorithm comprises a inhibitor rating calculation algorithm.

73. The system of claim 71, wherein said inhibitor recommendation output display comprises at least one of a recommended inhibitor; and
an inhibitor rating, wherein said inhibitor rating demonstrates the degree to which said recommended inhibitor matches said inhibitor recommendation input.

74. The method of claim 2 comprising:
accepting an inhibitor recommendation input;
performing an oxygen ingress calculation with said oxygen ingress input; and
providing an inhibitor recommendation output from said oxygen ingress calculation.

75. The method of claim 74, wherein said inhibitor recommendation input comprises at least one of a performance characteristic and/or an importance rating of said performance characteristic.

76. The method of claim 74, wherein said step of performing an oxygen ingress calculation comprises determining a rating of an inhibitor.

77. The method of claim 74, wherein said inhibitor recommendation output comprises: a recommended inhibitor; and an inhibitor rating, wherein said inhibitor rating demonstrates the degree to which said recommended inhibitor matches said inhibitor recommendation input.

78. The system of claim 1 comprising:
a plasticizer formulation input form; and
a plasticizer formulation transmitter.

79. The system of claim 78, wherein said plasticizer formulation comprises a compound.

80. The system of claim 78, wherein said plasticizer formulation comprises a plastisol.

81. The system of claim 78, further comprising a plasticizer formulation analyzer.

82. The system of claim 79, further comprising a plasticizer formulation optimizer.

83. The system of claim 79, further comprising a plasticizer formulation output.

84. The system of claim 83, wherein said plasticizer formulation output comprises a physical property summary.

85. The system of claim 83, wherein said plasticizer formulation output comprises an optimized plasticizer formulation.

86. The method of claim 2 comprising:
accepting a plasticizer formulation; and
forwarding said plasiticizer formulation input to a technical support group.

87. The method of claim 86, wherein said plasticizer formulation comprises a compound.

88. The method of claim 86, wherein said plasticizer formulation comprises a plastisol.

89. The method of claim 86, further comprising analyzing said plasticizer formulation.

90. The method of claim 89, further comprising optimizing said plasticizer formulation.

91. The method of claim 86, further comprising providing a plasticizer formulation output.

92. The method of claim 91, wherein said plasticizer formulation output comprises a physical property summary.

93. The method of claim 91, wherein said plasticizer formulation output comprises an optimized plasticizer formulation.

94. The system of claim 1 comprising:
accepting an anti-oxidant input;
performing an anti-oxidant calculation with said anti-oxidant input using said processing module; and
providing an output from said anti-oxidant calculation.

95. The system of claim 94, wherein said anti-oxidant input comprises at least one of a food product type; an anti-oxidant solution; a quantity of ingredient in a product; a regulation type and/or a desired anti-oxidant concentration.

96. The system of claim 95, wherein said anti-oxidant output comprises at least one of a total anti-oxidant concentration; an anti-oxidant level in a fat content; an anti-oxidant level in an oil content and/or a citric acid measure.

97. The method of claim 2 comprising:
accepting an anti-oxidant input;
performing an anti-oxidant calculation in said processing module with said anti-oxidant input; and providing an output from said anti-oxidant calculation.

98. The method of claim 97, wherein said anti-oxidant input comprises at least one of a food product type; an anti-oxidant solution; a quantity of ingredient in a product; a regulation type and/or a desired anti-oxidant concentration.

99. The method of claim 98, wherein said anti-oxidant output comprises at least one of a total anti-oxidant concentration; an anti-oxidant level in a fat content; an anti-oxidant level in an oil content and/or a citric acid measure.

100. The system of claim 1 comprising:
a weighting agent calculation input for a weighting agent in a beverage formulation;
a weighting agent calculation algorithm processing module; and
a weighting agent calculation output.

101. The system of claim 100, wherein said weighting agent comprises sucrose acetate isobutyrate (SAIB).

102. The system of claim 100, wherein said weighting agent calculation input comprises at least one of:
a desired specific gravity of oil phase;
a SAIB product;
an additional weighting agent;
a flavoring oil
a specific gravity of said flavoring oil;
a percent emulsion desired in said beverage formulation;
a desired dilution ratio; and
a percent of an ingredient.

103. The system of claim 100, wherein said sweighting agent calculation algorithm processing module comprises a desired oil phase specific gravity formulation calculation algorithm.

104. The system of claim 100, wherein said weighting agent calculation algorithm comprises an oil to weighting agent ratio oil phase specific gravity calculation algorithm.

105. The system of claim 102, wherein said weighting agent calculation output comprises at least one of an emulsion composition; and./or an oil phase component in said beverage formulation.

106. The method of claim 2 comprising:
accepting a weighting agent calculation input for a weighting agent in a beverage formulation;
performing a weighting agent calculation with said weighting agent calculation input; and
providing a weighting agent calculation output.

107. The method of claim 106, wherein said weighting agent comprises sucrose acetate isobutyrate (SAIB).

108. The method of claim 106, wherein said weighting agent calculation input comprises at least one of:
a desired specific gravity of oil phase;
a SAIB product;
an additional weighting agent;
a flavoring oil
a specific gravity of said flavoring oil;
a percent emulsion desired in said beverage formulation;
a desired dilution ratio; and
a percent of an ingredient.

109. The method of claim 106, wherein said step of performing a weighting agent calculation comprises formulating said beverage formulation to a desired oil phase specific gravity.

110. The method of claim 109, wherein said step of performing a weighting agent calculation comprises calculating an oil phase specific gravity from a ratio of an oil to said weighting agent.

111. The method of claim 106, wherein said weighting agent calculation output comprises an emulsion composition and/or an oil phase component in said beverage formulation.

112. The system of claim 1 comprising:
a solvent reformulation input;
a solvent calculation algorithm processing module; and
a solvent reformulation output.

113. The system of claim 112, wherein said solvent reformulation input comprises at least one of:
a solvent;
a percentage of said solvent in a blend; and/or
a cost of said solvent.

114. The system of claim 112, wherein said solvent calculation algorithm processing module comprises a solvent reformulation algorithm.

115. The system of claim 113, wherein said solvent calculation algorithm comprises a solvent formulation analysis algorithm.

116. The system of claim 96, wherein said solvent reformulation output comprises at least one of an optimum solvent blend; a lowest-cost solvent blend; a solvent detail report; an evaporation detail report; and/or a summary report.

117. The method of claim 2 comprising:
accepting a solvent reformulation input;
performing a solvent calculation algorithm with said solvent reformulation input; and
providing a solvent reformulation output.

118. The method of claim 117, wherein said solvent reformulation input comprises at least one of:
a solvent;
a percentage of said solvent in a blend; and
a cost of said solvent.

119. The method of claim 117, wherein said solvent calculation algorithm comprises a solvent reformulation algorithm.

120. The method of claim 119, wherein said solvent calculation algorithm comprises a solvent formulation analysis algorithm.

121. The method of claim 118, wherein said solvent reformulation output comprises at least one of an optimum solvent blend; a lowest-cost solvent blend; a solvent detail report; a evaporation detail report and/or a summary report.
